(19) United States
(12) Patent Application Publication
(10) Pub. No.: US 2019/0130512 A1
(43) Pub. Date: May 2, 2019

(54) SYSTEM AND METHOD FOR PRE- AND POST-HIRING LEADERSHIP DEVELOPMENT

(71) Applicant: Larry Kuhn, Churubusco, IN (US)

(72) Inventor: Larry Kuhn, Churubusco, IN (US)

(21) Appl. No.: 16/166,077

(22) Filed: Oct. 20, 2018

Related U.S. Application Data
(60) Provisional application No. 62/578,311, filed on Oct. 27, 2017.

(51) Int. Cl. G06Q 50/20; H04L 29/06; G06Q 10/06; G06Q 10/10

(52) U.S. Cl. CPC G06Q 50/2057; G06Q 10/1053; G06Q 10/067; H04L 63/083

(57) ABSTRACT

A method for pre-hiring and post-hiring leadership development is performed by computing devices. A Software as a Service (SaaS) delivery model is used in which software is licensed on a subscription basis and is centrally hosted in the Internet Cloud or on a server. Organizational account login types and permissions are assigned corresponding to function. The login types include Super-users or Leads, Supervisors, Employees, and Affiliates. The software guides the login types through a process of leadership development activities, including creating, maintaining, storing, and viewing, on a computer, data that includes positions. The process also assesses the positions using numerical weighting preferences to create corresponding Competency Models and/or Culture Fit Models. The process also assesses candidates using evaluative criteria derived from the Competency Models and/or Culture Fit Models. Individual subscribers may utilize the system to create candidate and/or employee profiles, set self-improvement goals, and receive feedback, depending upon their status.

### BACKGROUND

### Cross-Reference to Related Applications

The present application claims priority to U.S. Provisional No. 62/578,311 filed Oct. 27, 2017, the entire contents of which are incorporated herein by reference.

### Field of Invention

Embodiments of the present invention described herein generally relate to a system and method for pre-hiring and post-hiring leadership development, and more specifically to an online portal system, sometimes referred to herein as the Aspire Platform, that provides human resource professionals, hiring managers, supervisors, and employees access to pre-employment assessment, post-employment assessment, leadership development, and executive coaching products and services.

### SUMMARY

Embodiments of the system and method for pre-hiring and post-hiring leadership development described herein relate to a system and method for providing human resource professionals, hiring managers, supervisors, and employees access to pre-employment assessment, post-employment assessment, leadership development, and executive coaching products and services. Access to the Aspire Platform is available via a unique login and password using a Software as a Service (SaaS) delivery model in which software is licensed on a subscription basis and is centrally hosted either in the Internet Cloud or on a company's server.

### Functional Contexts

### A. Organizational User Administration

The Aspire Platform offers a full range of assessment and coaching deliverables, and may use permission assignments that enable various login types. The system and method may assign organizational account login types corresponding to function. The login types may include Super-users, which may be Human Resources (HR) Directors, Leads, which may be HR Leads, and Supervisors, which may be Hiring Managers, Employees, and Affiliates. Affiliates may sometimes be referred to herein as Prepare to Change (P2C) Affiliates. Permission levels may be assigned to control access to various free or fee-based deliverables available for organizational users. The Aspire Platform may provide access to Affiliates, Super-users and Leads to create candidate and/or Employee profiles, build positions, create and/or maintain position competency models, administer interviews and/or references, view interview and/or reference results, order pre-employment and/or post-employment tests, view testing results, forward test reports, participate with hiring managers and/or selection committees in making hiring decisions, update employment statuses, assign employees to supervisors and teams, create and/or maintain supervisor and/or employee access to the leadership development system, assign coaching engagements, and/or oversee performance management tracking and/or reporting to management. The leadership development system subcomponent of the Aspire Platform may sometimes be referred to herein as Aspire. Lead users may have restricted access and may not be able to view report results.

The Aspire Platform may provide Supervisors access to collaborate on competency model creation, view Candidate analysis reports, collaborate with their Supervisors to create Action Plans with alignment and/or leadership accountabilities, provide status updates on personal accountabilities, collaborate with team members on shared objectives, delegate alignment and/or leadership accountabilities with direct-reports, administer performance management of direct-reports, request surveys to gather continuous performance feedback, schedule and/or facilitate periodic one-on-one check-ins with direct-reports, collaborate with direct-reports to set alignment and/or leadership objectives, provide observational feedback to direct-reports via online surveys and/or responses, request coaching support, and/or document performance management activities. Surveys to gather continuous performance feedback may sometimes be referred to herein as Aspire 360 and/or Aspire Pulse surveys. Online surveys that are used to provide observational feedback to direct-reports may sometimes be referred to herein as Aspire App surveys and/or responses. Aspire App surveys and/or responses may be conducted by way of an application, especially as downloaded by a user to a mobile device.

The Aspire Platform may provide Employees access to collaborate with their Supervisor or Supervisors, create Action Plans with alignment and/or leadership accountabilities, provide status updates on personal accountabilities, collaborate with team members on shared objectives, respond to Aspire 360 or Aspire Pulse survey invitations, participate in periodic one-on-one check-ins with their supervisor or supervisors, and/or utilize coaching resources through the Aspire App or through a portal, which may sometimes be referred to herein as the Aspire Portal.

P2C Affiliates may be Consulting Therapists and/or Executive Coaches who have contracted to support individuals engaged in assessment and leadership development activities. In a pre-employment arena, the Aspire Platform may provide P2C Affiliates access to collaborate with Super-users, Leads, and/or Supervisors to co-create Employee and/or Candidate profiles as well as access competency models. The Aspire Platform may also provide P2C Affiliates the ability to build assessment batteries, set pricing, administer testing, integrate test results, and/or analyze and write assessment reports. The Aspire Platform may further provide the P2C Affiliates the ability to provide interactive report feedback to Super-users, Supervisors, and/or selection committees using encrypted tele-meeting technologies that may be embedded in the Aspire Platform. In a post-employment arena, the Aspire Platform may further provide P2C Affiliates the ability to prepare Coaching assessment reports, respond to requests for leadership coaching requests, and/or schedule and/or host online coaching meetings with Employees using encrypted tele-meeting technologies on the Aspire platform. Additionally, the Aspire Platform may provide P2C Affiliates the ability to interact with Supervisors and Employees to review Aspire 360 or Aspire Pulse feedback, set developmental objectives, deliver coaching interventions via remote connection or the Aspire App, and/or provide feedback to Super-users and/or Supervisors about Employee performance.

### B. Clinical User Administration

The Aspire Platform allows Therapists or Clinicians and Individual Users to access services. Clinical account logins within the Aspire Platform are designed for Therapists or Clinicians and Therapy Clients, who may be individuals engaged in self-development activities, to use permission assignments that enable various login types and activities within the system and method. The Aspire Platform may provide P2C Affiliates who are also Therapists the ability to contract to use and remotely administer a variety of clinical assessments, to interact with Clients during sessions via an encrypted tele-therapy connection, to provide session summaries, collaboratively create treatment goals and Action Plans, to provide psycho-educational resources, to monitor symptom improvement, and/or to track the progress of Clients who elect to use Aspire. The Aspire Platform may further provide for Therapy Clients, who may be individual users that have been invited by P2C Affiliate Therapists, to use online psycho-educational resources. Through the Aspire App, the Aspire Platform may provide for Therapy Clients to connect with their Therapist remotely. The Aspire App may provide a confidential, encrypted tele-therapy connection to receive tele-therapy from their Therapist. The Aspire Platform may provide a way for Therapy Clients to view session summaries, to access psycho-educational resources referenced during the session, to complete homework assignments, to track symptom improvement, and to provide status updates to help their therapist monitor progress as well as prepare for the next session.

### C. Self-Improvement User Administration

The Aspire Platform may allow subscribing individuals to set and achieve self-improvement goals. The Aspire Platform may allow individual users, termed Aspire Free Subscribers, to access Aspire, or the leadership development system, via the web or a free version of the Aspire App. The free version of the Aspire App will permit the Aspire Free Subscribers to build candidate and/or employee profiles, to set basic self-improvement goals, and/or to invite others to provide support and feedback regarding their efforts. The Aspire Platform may further allow individual users, termed Aspire Paid Subscribers, who may have upgraded their status, to have full access to resources. The paid version of the Aspire App may permit Aspire Paid Subscribers to build candidate and/or employee profiles, to launch Aspire 360 to gather perceptions from others, such as family, friends, and/or colleagues, to create Action Plans with personalized self-improvement goals, to invite Followers to provide real-time accountability and/or support feedback, and/or to engage with P2C Affiliates to receive online coaching around their selected developmental objectives.

According to one embodiment of the System and Method for Pre-Hiring and Post-Hiring Leadership Development, a method for pre-hiring and post-hiring leadership development performed by one or more computing devices includes several steps. The first step is providing a Software as a Service (SaaS) delivery model in which software is licensed on a subscription basis and is centrally hosted at least one of in the Internet Cloud and on a server. The second step is controlling access to at least one free or fee-based deliverable. The third step is assigning at least one organizational account login type corresponding to function, including at least one permission assignment, wherein the at least one organizational account login type includes Super-users or Leads, Supervisors, Employees, and Affiliates. The fourth step is using the software to guide the at least one organizational account login type, according to function and permission assignment, through a process of pre-hiring and post-hiring leadership development activities. The process of pre-hiring and post-hiring leadership development activities includes creating, maintaining, storing, and viewing, in a computer-readable medium, data that includes positions. The process of pre-hiring and post-hiring leadership development activities further includes assessing the positions using numerical weighting preferences to create, maintain, store, and view in the computer-readable medium data that includes corresponding Competency Models and/or Culture Fit Models. The process of pre-hiring and post-hiring leadership development activities further includes assessing candidates using evaluative criteria derived from the Competency Models and/or Culture Fit Models.

According to another embodiment of the System and Method for Pre-Hiring and Post-Hiring Leadership Development, one or more non-transitory computer-readable media store instructions which, when executed on one or more computing devices, cause the one or more computing devices to perform several steps. The first step is controlling access to at least one free or fee-based deliverable. The second step is assignment of at least one organizational account login type corresponding to function, including at least one permission assignment, wherein the at least one organizational account login type includes Super-users or Leads, Supervisors, Employees, and Affiliates. The third step is guiding the at least one organizational account login type, according to function and permission assignment, through a process of pre-hiring and post-hiring leadership development activities. The process of pre-hiring and post-hiring leadership development activities includes creating, maintaining, storing, and viewing, in a computer-readable medium, data that includes positions. The process of pre-hiring and post-hiring leadership development activities further includes assessing the positions using numerical weighting preferences to create, maintain, store, and view in the computer-readable medium data that includes corresponding Competency Models and/or Culture Fit Models. The process of pre-hiring and post-hiring leadership development activities further includes assessing candidates using evaluative criteria derived from the Competency Models and/or Culture Fit Models.

### DESCRIPTION OF THE DRAWINGS

The above-mentioned and other features of embodiments of the system and method for pre-hiring and post-hiring leadership development that provides human resource professionals, hiring managers, supervisors, and employees access to pre-employment assessment, post-employment assessment, leadership development, and executive coaching products and services, and the manner of their working, will become more apparent and will be better understood by reference to the following description of embodiments of the system and method for pre-hiring and post-hiring leadership development taken in conjunction with the accompanying drawings, wherein:

FIG. 1 is a graphical representation of an embodiment of an algorithm used in the system and method for pre-hiring and post-hiring leadership development, as described herein;

FIGS. 2 and 3 are screenshots of embodiments of a position creation window of the system and method for pre-hiring and post-hiring leadership development, as described herein;

FIG. 4 is a screenshot of an embodiment of a task preferences window of the system and method for pre-hiring and post-hiring leadership development, as described herein;

FIG. 5 is a screenshot of an embodiment of a knowledge preferences window of the system and method for pre-hiring and post-hiring leadership development, as described herein;

FIG. 6 is a screenshot of an embodiment of a task preferences window of the system and method for pre-hiring and post-hiring leadership development, as described herein;

FIG. 7 is a screenshot of an embodiment of a position creation window of the system and method for pre-hiring and post-hiring leadership development, as described herein;

FIGS. 8A and 8B are screenshots of embodiments of a new interview creation window of the system and method for pre-hiring and post-hiring leadership development, as described herein;

FIG. 8C is a screenshot of an embodiment of an interviewer invitation window of the system and method for pre-hiring and post-hiring leadership development, as described herein;

FIG. 9 is a screenshot of an embodiment of an interview rating form window of the system and method for pre-hiring and post-hiring leadership development, as described herein;

FIG. 10 is a screenshot of an embodiment of a report window of the system and method for pre-hiring and post-hiring leadership development, as described herein;

FIGS. 11A and 11B are screenshots of embodiments of a new candidate assessment window of the system and method for pre-hiring and post-hiring leadership development, as described herein;

FIG. 11C is a screenshot of an embodiment of an order finalization window of the system and method for pre-hiring and post-hiring leadership development, as described herein;

FIG. 11D is a screenshot of an embodiment of a test administration link creation window of the system and method for pre-hiring and post-hiring leadership development, as described herein;

FIG. 12 is a screenshot of an embodiment of an assessment order production project window of the system and method for pre-hiring and post-hiring leadership development, as described herein;

FIG. 13 is a screenshot of an embodiment of a report parameter validation window of the system and method for pre-hiring and post-hiring leadership development, as described herein;

FIG. 14 is a screenshot of an embodiment of a test result data upload window of the system and method for pre-hiring and post-hiring leadership development, as described herein;

FIG. 15 is a screenshot of an embodiment of a test result review and interpretive narrative creation window of the system and method for pre-hiring and post-hiring leadership development, as described herein;

FIG. 16 is a graphical representation of an embodiment of a congruence model of the system and method for pre-hiring and post-hiring leadership development, as described herein;

FIGS. 17A and 17B are screenshots of embodiments of an alignment analysis window of the system and method for pre-hiring and post-hiring leadership development, as described herein;

FIG. 18 is a screenshot of an embodiment of a competency fit analysis window of the system and method for pre-hiring and post-hiring leadership development, as described herein;

FIG. 19 is a screenshot of an embodiment of a Competency Model produced by the system and method for pre-hiring and post-hiring leadership development, as described herein;

FIG. 20 is a screenshot of an embodiment of an alignment summary window of the system and method for pre-hiring and post-hiring leadership development, as described herein;

FIG. 21 is a screenshot of an embodiment of a weighted decision algorithm window of the system and method for pre-hiring and post-hiring leadership development, as described herein;

FIGS. 22A and 22B are screenshots of an embodiment of a source data “drill-in” window of the system and method for pre-hiring and post-hiring leadership development, as described herein;

FIGS. 23A and 23B are screenshots of an embodiment of a panel interview score “drill-in” window of the system and method for pre-hiring and post-hiring leadership development, as described herein;

FIG. 24 is a screenshot of an embodiment of a behavioral observation score “drill-in” window of the system and method for pre-hiring and post-hiring leadership development, as described herein;

FIGS. 25A and 25B are screenshots of embodiments of a reference audit data “drill-in” window of the system and method for pre-hiring and post-hiring leadership development, as described herein;

FIG. 26 is a screenshot of an embodiment of a subjective estimates window of the system and method for pre-hiring and post-hiring leadership development, as described herein;

FIG. 27 is a screenshot of an embodiment of an Aspire Leader Alignment Platform of the system and method for pre-hiring and post-hiring leadership development, as described herein;

FIG. 28 is a screenshot of an embodiment of a sitemap overview of the system and method for pre-hiring and post-hiring leadership development, as described herein;

FIGS. 29A, 29B, and 29C are screenshots of an embodiment of widgets of the system and method for pre-hiring and post-hiring leadership development, as described herein;

FIG. 30 is a screenshot of an embodiment of a MyTeam Chart Widget of the system and method for pre-hiring and post-hiring leadership development, as described herein;

FIG. 31 is a screenshot of an embodiment of a Cascading Alignment of the system and method for pre-hiring and post-hiring leadership development, as described herein;

FIG. 32 is a screenshot of an embodiment of a My Accountabilities Page of the system and method for pre-hiring and post-hiring leadership development, as described herein;

FIG. 33 is a screenshot of an embodiment of a New Alignment Objectives page of the system and method for pre-hiring and post-hiring leadership development, as described herein;

FIG. 34 is a screenshot of an embodiment of an Aspire 360 WorkSkill Selector tool of the system and method for pre-hiring and post-hiring leadership development, as described herein;

FIG. 35 is a screenshot of an embodiment of an Aspire 360 Character Strength Selector tool of the system and method for pre-hiring and post-hiring leadership development, as described herein;

FIG. 36 is a screenshot of an embodiment of a participant perspective selection tool of the system and method for pre-hiring and post-hiring leadership development, as described herein;

FIG. 37 is a screenshot of an embodiment of a method for pre-hiring and post-hiring leadership development, as described herein;

FIG. 38 is a screenshot of an embodiment of a norming slider scoring mechanism of the system and method for pre-hiring and post-hiring leadership development, as described herein;

FIG. 39 is a screenshot of an embodiment of a Multi-Rater Development Survey of the system and method for pre-hiring and post-hiring leadership development, as described herein;

FIG. 40 is a screenshot of an embodiment of an effectiveness improvement tool of the system and method for pre-hiring and post-hiring leadership development, as described herein;

FIG. 41 is a screenshot of an embodiment of a Pulse Survey of the system and method for pre-hiring and post-hiring leadership development, as described herein;

FIG. 42 is a screenshot of an embodiment of a Graphical Analysis Tool of the system and method for pre-hiring and post-hiring leadership development, as described herein;

FIG. 43 is a screenshot of an embodiment of a Direct-Reports My Accountabilities page of the system and method for pre-hiring and post-hiring leadership development, as described herein;

FIG. 44 is a screenshot of an embodiment of a My Collaborations widget of the system and method for pre-hiring and post-hiring leadership development, as described herein;

FIG. 45 is a screenshot of an embodiment of an Aspire 360 Item Filter of the system and method for pre-hiring and post-hiring leadership development, as described herein;

FIG. 46 is a screenshot of an embodiment of a My Coaching Panel, as described herein;

FIG. 47 is a screenshot of an embodiment of an Aspire Coaching Activities Panel, as described herein; and

FIG. 48 is a screenshot of an embodiment of a Coaching Feedback Summary, as described herein.

Corresponding reference numbers indicate corresponding parts throughout the several views. The exemplifications set out herein illustrate embodiments of the system and method for pre-hiring and post-hiring leadership development, and such exemplifications are not to be construed as limiting the scope of the claims in any manner.

### DETAILED DESCRIPTION

### Unique Algorithms of Aspire's Pre-Employment Functions

### A. Competency Modeling Process for Organizational Users

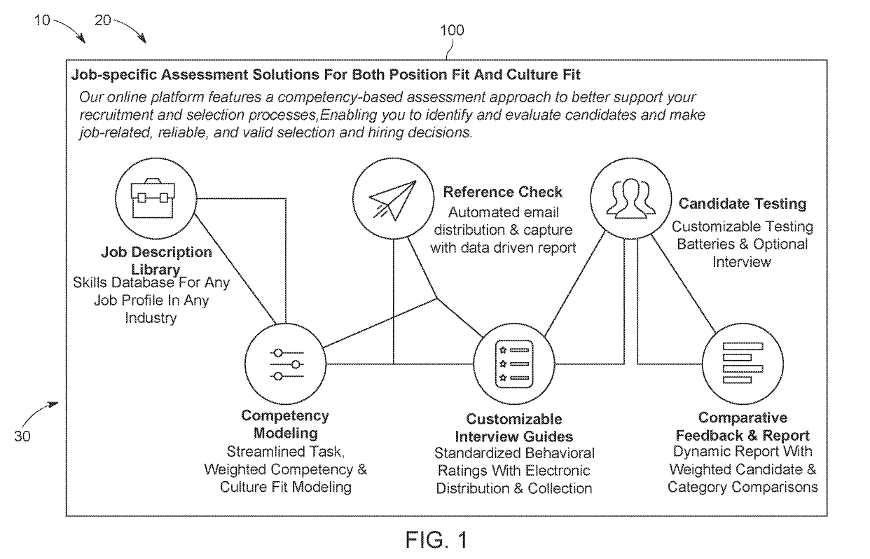

Turning now to FIG. 1, a graphical representation of an embodiment of an algorithm (400) used in the system and method (10, 20) for pre-hiring and post-hiring leadership development shows that the system and method (10, 20) guides Super-users and/or Leads or Users through a step-by-step process (30) to create positions and corresponding Competency Models (CMs) within the Aspire platform (100). Prior to assessing candidates, the system and method (10, 20) helps clients first assess the position for which the candidate is going to be hired. The system and method (10, 20) directs Users to create positions, to design initial position competency models, to electronically invite Subject Matter Experts (SMEs) to weigh in with their preferences, and to finalize the CM prior to assessing the first Candidate.

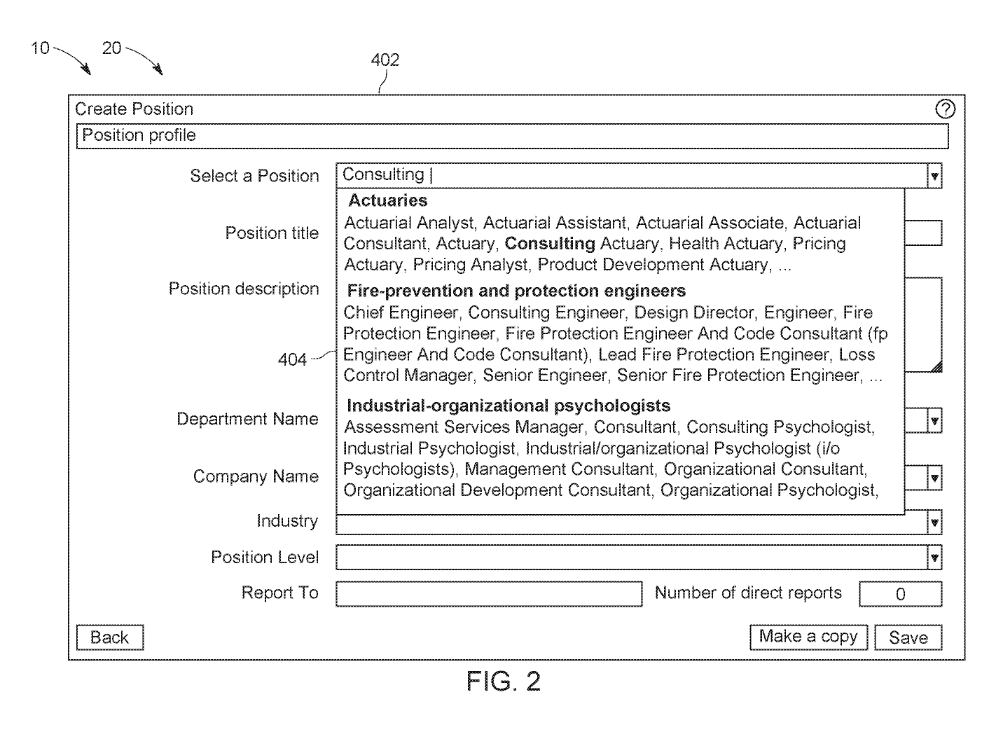

As shown in the position creation window (402) in FIG. 2, when Users of the system and method (10, 20) select Create Position, they are prompted to choose from a list of positions (404) acquired from an external database (not shown). In a non-limiting example, the external database from which the list of positions (404) is acquired may be http://www.ONET.org, a resource provided by the US Department of Labor. The system and method (10, 20) periodically downloads Job data from this external database and stores it in a Job Description Library (not shown). The Job data may include Job Essential Functions (or Tasks), Knowledge, Skills, Abilities, and/or Work Activities, as non-limiting examples. When a User starts to type the new position title into the system, the system and method (10, 20) displays similar position titles (404), and the User is prompted to select a position that best matches the new position. When a position is selected from the list (404), the system and method (10, 20) translates frequency and relevancy descriptive details from the external database into preference weightings, providing the User with a rational basis for initial numerical weighting preferences. Using this data as a template, the system and method (10, 20) allows the User and a P2C Affiliate to collaboratively analyze the current job description, organizing Essential Tasks into clusters that may mirror Essential Functions on the information populated from the Job Description Library. The system and method (10, 20) may allow the User to access, view, and edit the newly created job information as they continue to create the position. In this way, details, along with preference weightings concerning thousands of jobs, populate the descriptive information that will help Users to create a CM for the position.

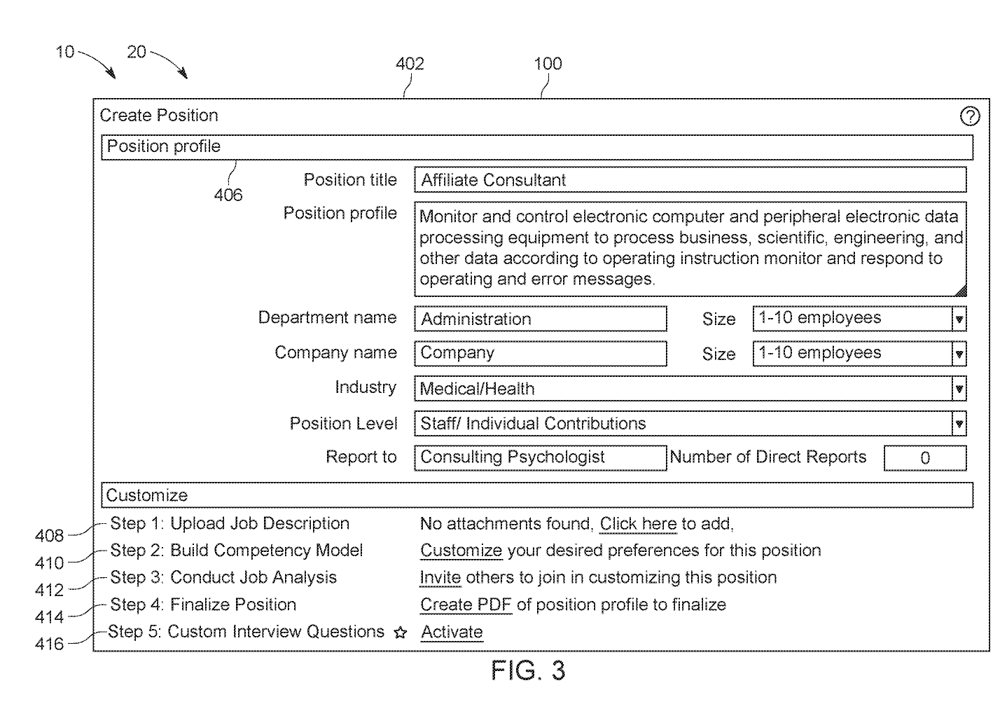

As shown in the position creation window (402) in FIG. 3, once additional job information is completed on the Position Profile (406), the system and method (10, 20) prompts the User to Create Position. In Step 1 of Creating a Position (408) the system and method (10, 20) asks the organization to upload a job description. This document typically lists a Job Summary, Minimum Requirements, Essential Functions, and Specific Performance Expectations for selected candidates who may be hired. In Step 2 of Creating a Position (410) the system and method (10, 20) asks the User to build a Competency Model (CM). A CM within the framework of the system and method (10, 20) lists weighted factors that become the evaluative criteria or target against which a candidate's suitability is measured. In this way, the Aspire Platform (100) of the system and method (10, 20) enables hiring managers and HR personnel to custom-design CM's to calculate the level of Competency Fit between specified job requirements and a candidate's skills, knowledge, and aptitudes. The CM of the system and method (10, 20) also facilitates the accurate assessment of Culture Fit by exploring alignment factors relevant to preferred personality characteristics and values within the work environment, and a Candidate's self-reported personality traits and value-drivers (644) (not shown in FIG. 3).

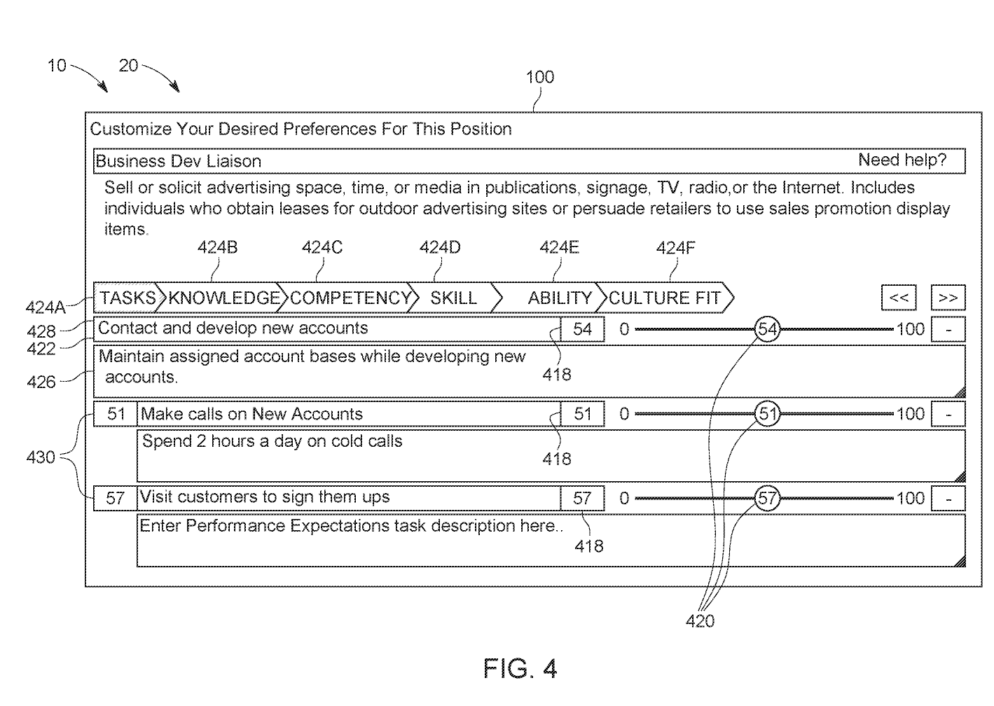

As shown in FIG. 4, within the Aspire platform (100) of the system and method (10, 20), numerical user preferences (418) are registered and saved when the User activates slider mechanisms (420). The User can view any category of job specifications (422) by moving across the various domain tabs (424), which may for non-limiting example include Essential Functions (424A), Knowledge (424B), Competency (424C), Skill (424D), Ability (424E), and/or Culture Fit (424F). The User can also edit any of the fields within these domain tabs (424) to customize the task descriptions (426) and weights of assigned importance or frequency, describing the position/successful candidate requirements in greater detail. The system and method (10, 20) provides additional customization to Users who would like to describe Tasks in a more granular way. Tasks can be further delineated by Parent task levels (428) and Performance Expectations task levels (430). If this feature is activated, the User can parse Essential Tasks into sub-tasks and move the slider mechanisms (420) to reflect varying levels of importance or use frequency within that Performance Expectations task (430). Whenever a Performance Expectations task slider mechanism is adjusted to reflect the User preference, the value of the Parent task slider mechanism is adjusted to reflect an average of all Performance Expectations task slider mechanism values.

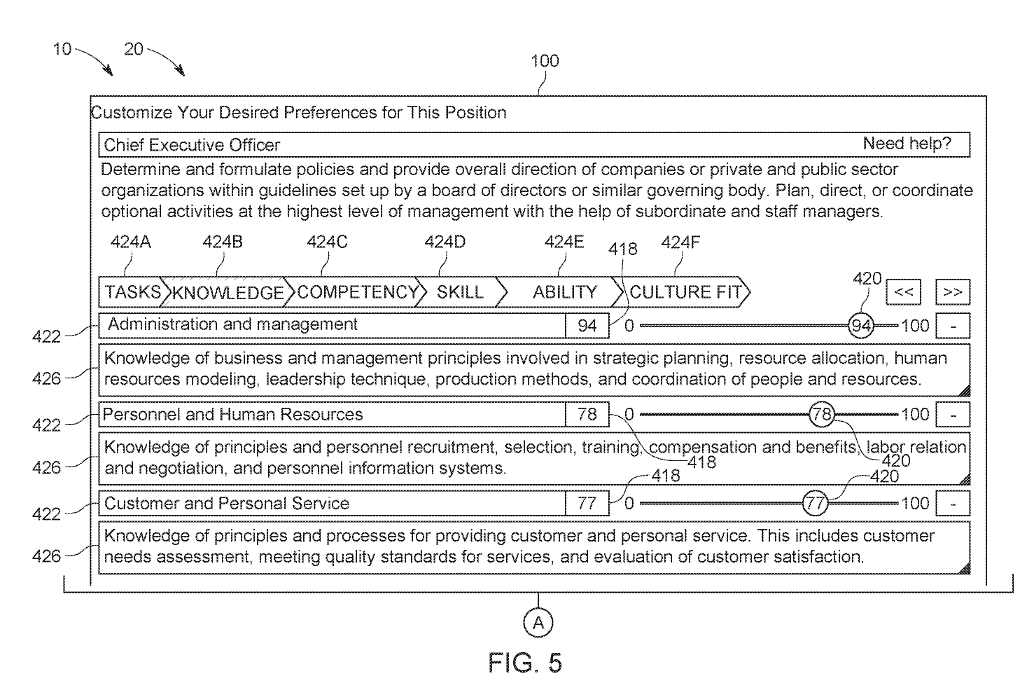

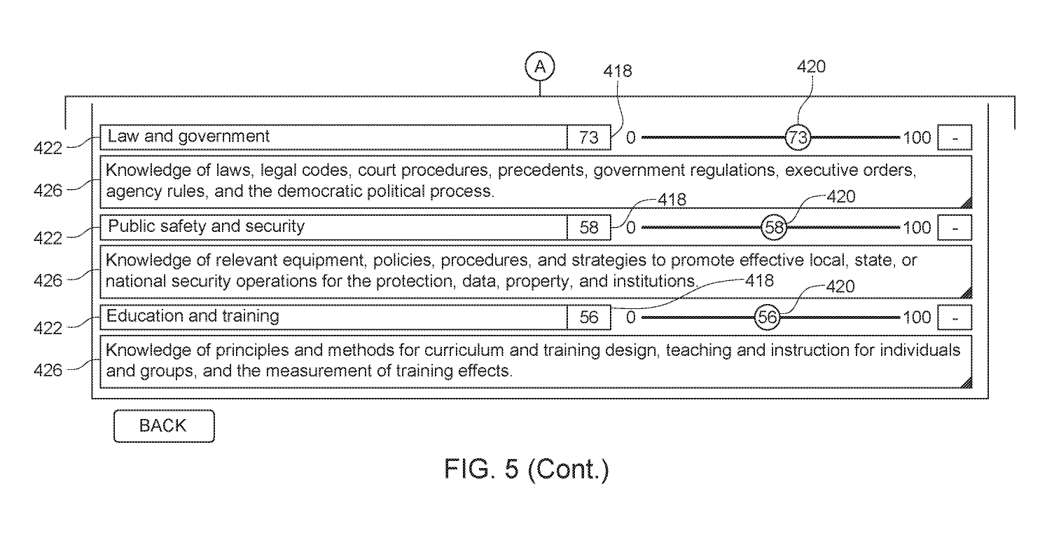

As shown in FIG. 5, the system and method (10, 20) allows the User to explore and edit other suggested job criteria under the Knowledge domain tab (424B), the Skill domain tab (424D), and the Ability domain tab (424E). For non-limiting example, the Knowledge domain tab (424B) may include:
a. Administration and Management, or knowledge of business and management principles involved in strategic planning resource allocation, human resources modeling, leadership technique, production methods, and coordination of people and resources;
b. Personnel and Human Resources, or knowledge of principles and procedures for personnel recruitment, selection, training, compensation and benefits, labor relations and negotiation, and personnel information systems;
c. Customer and Personal Service, or knowledge of principles and processes for providing customer and personal services, including customer needs assessment, meeting quality standards for services, and evaluation of customer satisfaction;
d. Law and Government, or Knowledge of laws, legal codes, court procedures, precedents, government regulations, executive orders, agency rules, and the democratic political process;
e. Public Safety and Security, or Knowledge of relevant equipment, policies, procedures, and strategies to promote effective local, state, or national security operations for the protection of people, data, property, and institutions; and/or
f. Education and Training, or Knowledge of principles and methods for curriculum and training design, teaching and instruction for individuals and groups, and the measurement of training effects.

Similarly, and in the same format, the Skill domain tab (424D) may include:
a. Judgment and Decision Making, or considering the relative costs and benefits of potential actions to choose the most appropriate one;
b. Complex Problem Solving, or Identifying complex problems and reviewing related information to develop and evaluate options and implement solutions;
c. Critical Thinking, or Using logic and reasoning to identify the strengths and weaknesses of alternative solutions, conclusions or approaches to problems; and/or
d. Social Perceptiveness, or Being aware of others' reactions and understanding why they react as they do.

Similarly, and in the same format, the Ability domain tab (424E) may include:
a. Oral Comprehension, or the ability to listen to and understand information and ideas presented through spoken words and sentences;
b. Oral Expression, or the ability to communicate information and ideas in speaking so others will understand;
c. Written Comprehension, or the ability to read and understand information and ideas presented in writing;
d. Deductive Reasoning, or the ability to apply general rules to specific problems to produce answers that make sense;
e. Written Expression, or the ability to communicate information and ideas in writing so others will understand; and/or
f. Inductive Reasoning, or the ability to combine pieces of information to form general rules or conclusions (includes finding a relationship among seemingly unrelated events).

The system and method (10, 20) directs Users to pay special attention to the Essential Functions domain tab (424A), the Competency domain tab (424C), and the Culture Fit domain tab (424F). The Aspire Platform (100) utilizes Job specifications (422) and numerical user preferences (418) on these tabs in assessment analysis activities, as well as in performance management and development initiatives. Within the CM for the designated position, the Aspire Platform (100) Competency domain tab (424C) allows Users to translate Work Activities from the external database into one of twenty Competencies. The system and method (10, 20) maps these competencies to testing instruments. When a Candidate achieves elevated scores on scales mapped to unique Competencies, that Candidate's competency score also becomes elevated. The Candidate's Overall Competency score is a weighted average of all selected competencies in the CM, based on weighted preferences indicated when the CM is finalized in step 4 of creating a position (414). The Competency Mapping Algorithm will be discussed hereinafter.

The Culture Fit domain tab (424F) of the system and method (10, 20) allows users to describe the specific personality characteristics (432) and value drivers (434) that they believe would enable a prospective employee to be a good fit to the team or organizational culture. The system and method (10, 20) sets individual categories to match specific scales on tests used to assess these domains. Throughout all CM activities, P2C Affiliates guide Users in the use of the CM tool, preventing careless or intentional skewing of numerical user preferences. The Culture Fit domain tab (424F) may therefore include:
a. Warmth, or outgoing, attentive, easy-going, participating;
b. Abstract Reasoning, or bright, fast learning, high scholastic capacity;
c. Emotional Stability, or adaptive, mature, faces reality calmly, resilient;
d. Dominance, or forceful, aggressive, competitive, stubborn; and/or
e. Social Boldness, or venturesome, thick-skinned, uninhibited.

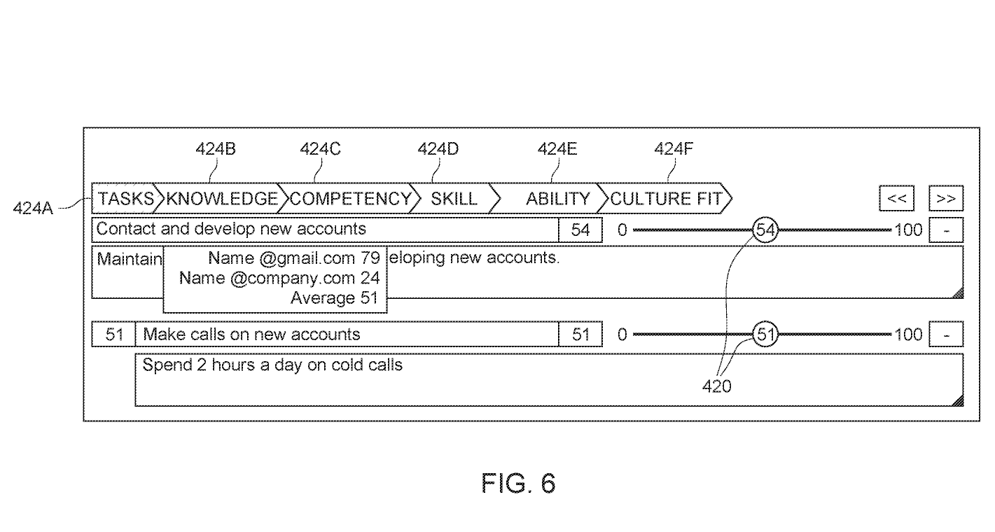

Step 3 of creating a position (412) asks the user to conduct a Job Analysis of Essential Functions by inviting SMEs who are familiar with the position to provide preferences on the Job Essential Functions domain, the Competency domain, and the Culture Fit domain. Because Skills, Knowledge, and Abilities are embedded within the Competency domain of the system and method (10, 20), they are included in the CM for information purposes only and not used to perform subsequent calculations during assessment analyses. SMEs are invited via email, wherein the SME's are given specific instructions on how to move the slider mechanisms (420) to register their SME numerical preferences (436) (not shown). When all SMEs have completed registering their SME numerical preferences (436), the User can see their individual weightings and move their slider mechanisms (420) to the desired level, as shown in FIG. 6. Once all the slider mechanisms (420) on various domain tabs (424) have been moved to the desired levels, then the User can proceed to Step 4 of creating a position (414). The system and method (10, 20) then sends the User a copy of the completed Competency Model (438). The Competency Model (438) may include specific competencies such as Job Details Competency (438A), Essential Functions Competency (438B), Knowledge Competency (438C), General Competency (438D), Skills Competency (438E), Traits Competency (438F), and/or Values Competency (438G), as non-limiting examples.

An exemplary Competency Model (438) may, therefore, include the following information:

Job Details (438A)

| Job Title | Chief of Staff |
|---|---|
| Position Description | The Chief of Staff reports to the Chief Executive |
| | Officer (CEO) and supports the CEO by working |
| | effectively with internal and external stakeholders, |
| | including management, the Board of Directors and |
| | community partners to meet the goals of the |
| | organization. The Chief of Staff will provide |
| | oversight and guidance on projects of the highest |
| | importance to ensure results that are satisfactory |
| | to the CEO. The person in this position must |
| | act with the utmost confidentiality, and must |
| | be highly resourceful, flexible, and |
| | self-motivated to proactively manage |
| | tasks on behalf of the CEO. |
| Department Name | Administration |
| Department Size | 1-10 |
| Organization Name | CHOC |
| Organization Size | 1-10 |
| Industry | Medical/Health |
| Job Level | Executive/(CEO, President, COO, CFO, VP) |
| Reports To | CEO |
| #No of Direct Reports | 0 |

Essential Functions (438B)

| Name | Description | Weight |
|---|---|---|
| Meetings | Assist the CEO in preparation and facilitation of key | 75 |
| | meetings by completing preparatory work, creating an agenda, | |
| | and being accountable for ensuring that the meeting | |
| | objectives are realistic and appropriate | |
| | Meet with senior executives and others in advance of meetings | |
| | to ensure that the CEO's time is leveraged most effectively in | |
| | meetings | |
| | Attend meetings on behalf of the CEO, capture major take- | |
| | aways, meetings and report back key information. Work | |
| | with the executive team to ensure follow-up. | |
| | Work with the CEO's executive assistant to schedule | |
| | appropriately and ensure timely communication | |
| | to participants and Board committees | |
| | Assist the CEO with executing the strategic direction of the | |
| | Board of Directors thoughtful planning of the Board agenda | |
| | and coordination of presentations from the executive team | |
| | Prepare background information, as needed, on meeting | |
| | participants. | |
| Projects | Support the CEO and the organization's senior leaders in | 73 |
| | carrying out key organization functions and advancing | |
| | identified initiatives by leading process and logistics | |
| | management with coordination of agendas, coordination of key | |
| | decisions and action items, and identification of any potential | |
| | roadblocks or issues Create milestones and track progress to | |
| | ensure the commitments are completely timely | |
| | Offer resources where necessary to ensure completion of | |
| | projects which are high priority to the CEO | |
| | Ensure alignment among stakeholders and executives, and | |
| | inform the CEO when alignment is absent. Recommend | |
| | mitigation approaches where appropriate | |
| | Independently manage or lead projects, as assigned | |
| | by the CEO, in support of strategic objectives, | |
| | with a focus on initiatives that are more discrete | |
| | and temporal in nature within the organization. | |
| Communication | Draft materials, communication, and speaking points for | 72 |
| | the CEO, as requested. Researches issues (fact check) as | |
| | needed to ensure that communications from the CEO | |
| | are accurate and poignant | |
| | Track upcoming events for the CEO and prepare, as | |
| | appropriate, background information and pertinent notes | |
| | As requested, represent the CEO at events outside of the | |
| | organization | |
| | Communicate the CEO's position, as directed, in meetings to | |
| | help drive her priorities. Prepare follow-up correspondence for | |
| | internal and external meetings, as directed by the CEO | |
| | Support Board of Directors communications and process | |
| | management, as directed by the CEO | |
| | Facilitate the sharing of information between the enterprise's | |
| | various structures and leadership groups. | |
| Issue | Assist the CEO and the organization's senior leaders with | 62 |
| Identification | identifying critical path items, maintaining consistent | |
| | focus on the enterprise's highest priorities, synthesizing | |
| | information to facilitate decision making, and | |
| | managing the associated processes, logistics, and | |
| | communications on such matters | |
| | Be sufficiently knowledgeable in the operations of the | |
| | enterprise to help troubleshoot issues which may arise | |
| | Proactively identify issues and risks that could impact the | |
| | successful execution of the CEO's commitments. Recommend | |
| | mitigation approaches and troubleshoot as needed | |
| | Confidentially engage in investigation and analysis of | |
| | issues without alerting others | |
| | Provide guidance and advice to the CEO and other | |
| | executives as requested. | |
| Meeting | Assist the CEO in preparation and facilitation | 85 |
| Preparation | of key meetings by completing preparatory work, | |
| and | creating an agenda, and being accountable for | |
| Planning | ensuring that the meeting objectives are realistic | |
| | and appropriate | |
| | Meet with senior executives and others in advance of | |
| | meetings to ensure that the CEO's time is leveraged | |
| | most effectively in meetings | |
| | Work with the CEO's executive assistant to schedule | |
| | appropriately and ensure timely communication to | |
| | participants and Board committees | |
| | Assist the CEO with executing the strategic direction of the | |
| | Board of Directors thoughtful planning of the Board agenda | |
| | and coordination of presentations from the executive team | |
| | Prepare background information, as needed, on meeting | |
| | participants. | |
| Meeting | Attend meetings on behalf of the CEO, capture major | 65 |
| Attendance | take-aways, and report back key information. | |
| | Work with the executive team to ensure follow-up. | |
| Coordination | Support the CEO and the organization's senior leaders | 75 |
| | in carrying out key organization functions and | |
| | advancing identified initiatives by leading process | |
| | and logistics management with coordination of agendas, | |
| | coordination of key decisions and action items, and | |
| | identification of any potential roadblocks or issues | |
| Resourcing | Offer resources where necessary to ensure completion of | 70 |
| | projects which are high priority to the CEO | |
| Tracking | Create milestones and track progress to ensure the | 75 |
| and | commitments are completely timely | |
| Reporting | Ensure alignment among stakeholders and executives, | |
| Results | and inform the CEO when alignment is absent. | |
| | Recommend mitigation approaches where appropriate | |
| Internal | Draft materials, communication, and speaking | 85 |
| Communication | points for the CEO, as requested. Researches issues | |
| | (fact check) as needed to ensure that communications | |
| | from the CEO are accurate and poignant | |
| | Track upcoming events for the CEO and prepare, as | |
| | appropriate, background information and pertinent notes | |
| | Communicate the CEO's position, as directed, in meetings | |
| | to help drive her priorities. Prepare follow-up correspondence | |
| | for internal meetings, as directed by the CEO | |
| | Support Board of Directors communications and process | |
| | management, as directed by the CEO | |
| | Facilitate the sharing of information between the enterprise's | |
| | various structures and leadership groups. | |
| External | As requested, represent the CEO at events outside of the | 60 |
| Communication | organization | |
| | Communicate the CEO's position, as directed, in meetings | |
| | to help drive her priorities. Prepare follow-up correspondence | |
| | for external meetings, as directed by the CEO | |
| Managing | Assist the CEO and the organization's senior leaders with | 65 |
| Information | identifying critical path items, maintaining consistent | |
| | focus on the enterprise's highest priorities, synthesizing | |
| | information to facilitate decision making, | |
| | and managing the associated processes, logistics, | |
| | and communications on such matters | |
| | Provide guidance and advice to the CEO and other | |
| | executives as requested. | |
| Trouble- | Proactively identify issues and risks that could impact the | 60 |
| shooting | successful execution of the CEO's commitments. Recommend | |
| | mitigation approaches and troubleshoot as needed | |
| | Confidentially engage in investigation and analysis of issues | |
| | without alerting others | |

Knowledge (438C)

| Name | Description | Weight |
|---|---|---|
| Clerical | Knowledge of administrative and clerical procedures and | 81 |
| | systems such as word processing, managing files and | |
| | records, stenography and transcription, designing forms, | |
| | and other office procedures and terminology. | |
| Customer and | Knowledge of principles and processes for providing | 79 |
| Personal | customer and personal services. This includes customer | |
| Service | needs assessment, meeting quality standards for services, | |
| | and evaluation of customer satisfaction. | |
| English | Knowledge of the structure and content of the English | 78 |
| Language | language including the meaning and spelling of words, | |
| | rules of composition, and grammar. | |
| Administration | Knowledge of business and management principles | 72 |
| and | involved in strategic planning, resource allocation, human | |
| Management | resources modeling, leadership technique, production | |
| | methods, and coordination of people and resources. | |
| Personnel | Knowledge of principles and procedures for personnel | 65 |
| and | recruitment, selection, training, compensation | |
| Human | and benefits, labor relations and negotiation, and | |
| Resources | personnel information systems. | |
| Computers | Knowledge of circuit boards, processors, chips, | 64 |
| and | electronic equipment, and computer hardware and | |
| Electronics | software, including applications and programming. | |
| Economics | Knowledge of economic and accounting principles | 64 |
| and | and practices, the financial markets, banking and the | |
| Accounting | analysis and reporting of financial data. | |
| Mathematics | Knowledge of arithmetic, algebra, geometry, calculus, | 61 |
| | statistics, and their applications. | |
| Sales | Knowledge of principles and methods for showing, | 52 |
| and | promoting, and selling products or services. This includes | |
| Marketing | marketing strategy and tactics, product demonstration, | |
| | sales techniques, and sales control systems. | |
| Telecommunications | Knowledge of transmission, broadcasting, switching, | 46 |
| | control, and operation of telecommunications systems. | |

Competency (438D)

| Name | Description | Weight |
|---|---|---|
| Clear | Clear oral communicators speak clearly, fluently, respectfully, | 50 |
| Oral | and professionally with clients, peers, and staff members. This | |
| Communication | competency involves the ability to explain complicated issues | |
| | and procedures simply and accurately. Whether presenting in | |
| | meetings, conversing face-to-face, or communicating on the | |
| | telephone, someone with this competency uses proper | |
| | grammar and diction; verbal communications never reflect | |
| | impatience, frustration or annoyance. Clear oral | |
| | communicators present arguments that are articulate and | |
| | logically structured, speak confidently to a range of situations, | |
| | and adapt their style and pace to needs of the audience. | |
| | Strong oral communicators also they make use of | |
| | active listening skills, tune in to audience | |
| | reactions, solicit feedback, exhibit curiosity, and respond | |
| | without reactivity. | |
| Clear | This competency involves an ability to write in an expressive | 50 |
| Written | and engaging style while avoiding the use of overly technical | |
| Communication | language. Written information is presented clearly and | |
| | succinctly. Individuals with Clear Written Communication are | |
| | able to effectively structure information in order to present | |
| | logical and convincing arguments that address the objectives, | |
| | context, and needs of their readers. | |
| Reliability | This competency encompasses punctuality, conscientiousness, | 50 |
| | and adherence or compliance to policies, rules, procedures, | |
| | and legal regulations (e.g., health and safety, security, | |
| | data protection, etc.) within the organization. An individual | |
| | with this competency attends meetings on time, follows | |
| | instructions without unnecessarily challenging authority, | |
| | possesses a strong work ethic, and follows through on | |
| | assigned tasks. He or she rarely misses appointments or fails | |
| | to carry out assigned responsibilities, informing others | |
| | in advance when unable to deliver expected outcomes. | |
| Drive | Results Individuals who possess a Drive for Excellence | 50 |
| for | maintain exceptional compliance and productivity | |
| Excellent | standards in their own work as well as from others. This | |
| | competency is reflected in the willingness to: a) accept | |
| | or enthusiastically embrace difficult goals, b) be evaluated | |
| | for the quality of individual's, teams, or organization's | |
| | output, or c) to monitor the performance and output of others. | |
| | Someone with this competency values achievement | |
| | and accuracy, setting an example of high quality | |
| | standards within the business. | |
| Integrity | Individuals with integrity and respect for others uphold a high | 50 |
| and | standard of fairness and ethics in everyday words and actions. | |
| Respect | They are committed to telling the truth, keeping their | |
| for | promises, standing up for what is right, and acting consistently | |
| Others | with their principles, values, and beliefs. They have a sense | |
| | of social responsibility and treat others from different | |
| | backgrounds and cultures with respect. This competency | |
| | enables someone to solicit and appreciate differing | |
| | perceptions and opinions. He or she will express concern | |
| | for the common good, promote equal opportunities, build | |
| | diverse teams, encourage community and environmental | |
| | responsibility, promote individual responsibility, | |
| | empower others, and commit to others' development. | |
| Analytical | This competency is concerned with applying an analytical | 50 |
| Problem | approach to solving problems. A person with this competency | |
| Solving | is able to look beyond surface issues, understand the historical | |
| | context of a problem, and gather numerical and verbal | |
| | information from multiple sources. This competency enables a | |
| | person to work effectively with complicated, conflicting or | |
| | ambiguous information because he or she knows how to break | |
| | information into component parts, shift to identify patterns and | |
| | relationships, question hidden assumptions, formulate working | |
| | hypotheses, and develop alternative solutions in a timely | |
| | manner. Individuals with this competency also derive | |
| | satisfaction from helping others to solve problems. | |
| Cooperative | Cooperative Teamwork is concerned with the capacity | 50 |
| Teamwork | to build positive, trusting, respectful, and supportive | |
| | working relationships, collaborating with others toward | |
| | a common goal. Someone with this competency | |
| | listens to and adapts to others' different work styles. | |
| | He or she consults proactively with others and is not | |
| | only willing to challenge others, but also recognizes their | |
| | contributions and accepts their challenges as a way of | |
| | getting the best results for the team. Support is provided on | |
| | the practical and emotional level; active interest in others' | |
| | opinions, ideas and wellbeing is conveyed. Cooperative | |
| | Teamwork seeksto balance the strengths and weaknesses of | |
| | the team. Team members are challenged to create and | |
| | develop the best solutions through shared commitment | |
| | to the team and its goals. | |
| Planning | This competency includes prioritizing activities and | 50 |
| and | assignments, setting and clarifying objectives, leveraging | |
| Organization | resources, and establishing courses of actions for the self and | |
| | others to ensure that work is completed effectively and | |
| | efficiently. An individual with this competency is orderly and | |
| | systematic in his or her approach. Plans and projects are | |
| | prepared well in advance. He or she is productive and efficient | |
| | with their time management and sets realistic milestones and | |
| | timelines for tasks and projects. Additionally, he or she will | |
| | monitor progress against identified objectives, anticipates the | |
| | risks and consequences of decisions and actions, and prepares | |
| | strategies to deal with potential problems and changes. | |
| Decision- | Decision-making involves making quick, clear, and effective | 50 |
| Making | decisions under time pressure. Competent decision makers take | |
| | initiative, consider a range of viewpoints, make calculated | |
| | risks, and exhibit resilience when a tough decision may | |
| | go against the popular vote. Someone with this competency is | |
| | able to balance the risks and benefits of various options and | |
| | take responsibility for the outcomes of the decision and its | |
| | impact. Effective decision-makers project confidence | |
| | to sell others on the advantages of the decision. | |
| Influencing | Influential people demonstrate confidence in their position. | 50 |
| | Rather than relying on power and control strategies to advance | |
| | their agendas, they effectively persuade, convince, and | |
| | motivate others with logical and emotional appeals, often | |
| | inspiring commitment and accountability throughout the | |
| | organization. This competency enables an individual to side- | |
| | step power struggles to win cooperation and support. Rather | |
| | than becoming adversarial, an influencer is able to address key | |
| | concerns, use positive change language, promote the new ideas | |
| | (of their own or others), find common ground, gain agreement, | |
| | and lead others to decide to adopt new opinions, positions, or | |
| | behaviors. Influencers can balance the need for an immediate | |
| | win with the requirement for long-term successful | |
| | relationships. Influential people also make use of personal and | |
| | professional networks to increase their opportunities to | |
| | influence and are politically astute. | |
| Initiative | Initiative involves generating activity to achieve. | 50 |
| | An individualwith this competency proactively | |
| | seeks challenging targets for themselves and | |
| | their team or department. A person with | |
| | initiative tolerates risk, overcomes pressures to conform, and | |
| | chooses to act without needing to be motivated by others. He | |
| | or she identifies problems and often implements plans to | |
| | eliminate unnecessary actions and procedures, seeking answers | |
| | to questions that enable solving a problem or completing a | |
| | task, anticipating potential problems or difficult situation, and | |
| | developing alternatives. An individual with initiative creates | |
| | contingency plans when initial approaches fail, proposing | |
| | innovative strategies for improving procedures or processes. | |
| Coping | This competency is the process by which an individual | 50 |
| with | consciously attempts to manage both internal and external | |
| Pressure | stressors. Someone with this competency exhibits a | |
| | positive attitude in the face of criticism and failure | |
| | or during stressful situations. He or she is able to manage | |
| | negative emotions while also remaining present and focused | |
| | on challenging tasks or conflicts. Coping with Pressure | |
| | permits an individual to take a solution-focused | |
| | approach and to effectively mediate and | |
| | resolve conflicts between others that might not otherwise | |
| | involve him or her. | |

Skills (438E)

| Name | Description | Weight |
|---|---|---|
| Speaking | Talking to others to convey | 75 |
| | information effectively. | |
| Active | Giving full attention to what other | 72 |
| Listening | people are saying, taking time to | |
| | understand the points being made, asking | |
| | questions as appropriate, and | |
| | not interrupting at inappropriate times. | |
| Coordination | Adjusting actions in relation to others' actions. | 69 |
| Reading | Understanding written sentences and | 66 |
| Comprehension | paragraphs in work related documents. | |
| Time | Managing one's own time and the time | 66 |
| Management | of others. | |
| Writing | Communicating effectively in writing as | 66 |
| | appropriate for the needs of the audience. | |
| Critical | Using logic and reasoning to identify the | 63 |
| Thinking | strengths and weaknesses of alternative | |
| | solutions, conclusions or approaches to | |
| | problems. | |
| Negotiation | Bringing others together and trying to | 63 |
| | reconcile differences. | |
| Judgment and | Considering the relative costs and benefits | 60 |
| Decision | of potential actions | |
| Making | to choose the most appropriate one. | |
| Management of | Motivating, developing, and directing | 60 |
| Personnel | people as they work, | |
| Resources | identifying the best people for the job. | |
| Social | Being aware of others' reactions and | 60 |
| Perceptiveness | understanding why they react as they do. | |
| Monitoring | Monitoring/Assessing performance | |
| | of yourself, other individuals, | |
| | or organizations to make | 56 |
| | improvements or take corrective action. | |

Traits (438F)

| Name | Description | Weight |
|---|---|---|
| Warmth | Outgoing, attentive, easy-going, participating | 70 |
| Abstract | Bright, fast learning, high scholastic capacity | 91 |
| Reasoning | | |
| Emotional | Adaptive, mature, faces reality calmly, resilient | 91 |
| Stability | | |
| Dominance | Forceful, aggressive, competitive, stubborn | 47 |
| Liveliness | Animated, spontaneous, enthusiastic, expressive | 62 |
| Rule-Conscious | Dutiful, conforming, rule-bound, inflexible | 56 |
| Social Boldness | Venturesome, thick-skinned, uninhibited | 68 |
| Sensitivity | Sentimental, tender-minded, intuitive, sensitive | 58 |
| Vigilance | Suspicious, skeptical, wary, distrustful, cautious | 39 |
| Abstractedness | Imaginative, innovative, absent-minded, | 73 |
| | impractical | |
| Privateness | Discreet, non-disclosing, polished, diplomatic | 72 |
| Apprehension | Self-doubting, worried, insecure | 16 |
| Openness to | Experimenting, liberal, analytical, critical, | 86 |
| Change | flexible | |
| Self-Reliance | Solitary, independent, individualistic, | 82 |
| | self-sufficient | |
| Perfectionistic | Organized, self-disciplined, precise, | 81 |
| | detailed controlled | |
| Tension | Tense, driven, high energy, impatient, urgent | 68 |

Values (438G)

| Name | Description | Weight |
|---|---|---|
| Artistic | Creative, cultured experimenting, imaginative, | 84 |
| | intuitive | |
| Collabora- | Social, spontaneous, interactive, frequent contact | 74 |
| tive | | |
| Altruism | Sympathetic, advocates for justice, fairness, | 76 |
| | idealism | |
| Work- | Serious about work, attentive to financial details, | 80 |
| minded | profit | |
| Play | Expressive, changeable, dynamic, | 68 |
| | entertaining, impulsive | |
| Achieve- | Ambitious, strategic, aspiring, success-oriented | 84 |
| ment | | |
| Recognition | Values attention, affirmation, acknowledgement | 61 |
| Intellect | Analytical, curious, scientific, technologist, | 87 |
| | innovative | |
| Certainty | Values security, risk-free environments, | 30 |
| | dislikes change | |
| Tradition | Procedural, common-sense, conservative, practical | 57 |

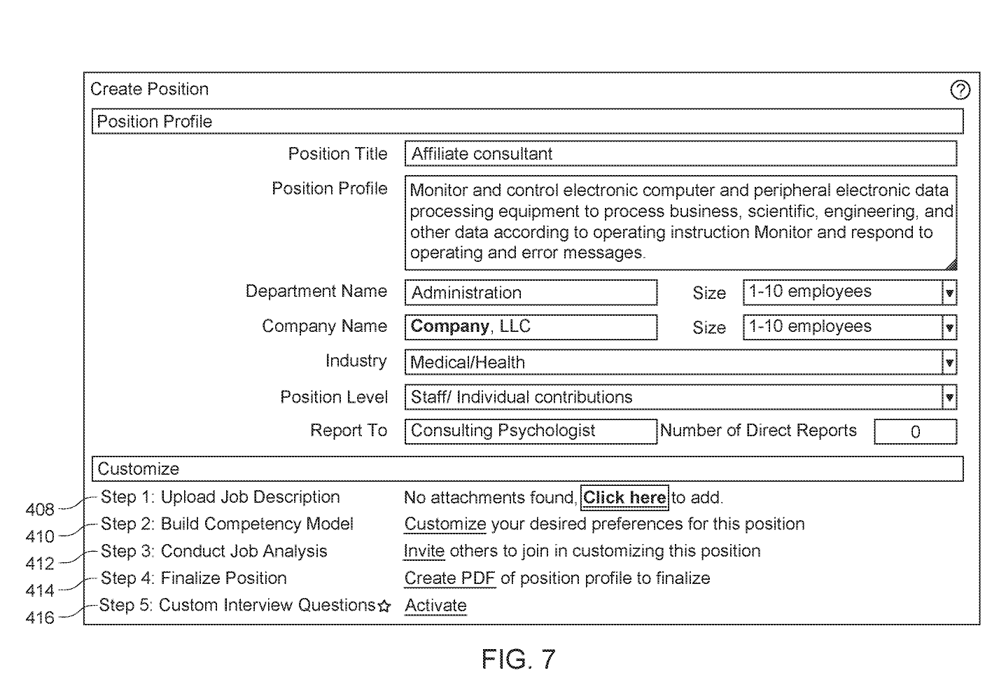

As shown in FIG. 7, Step 5 of creating a position (416) provides the User with the opportunity to designate unique interview questions that would be asked of all Candidates for the designated position during the pre-selection interview process.

### B. Electronic Interviews for Organizational Users

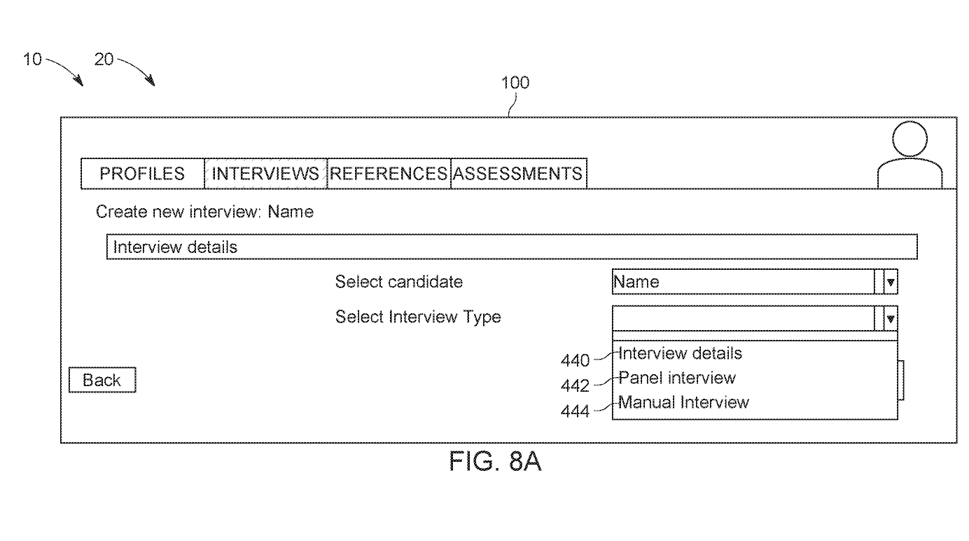

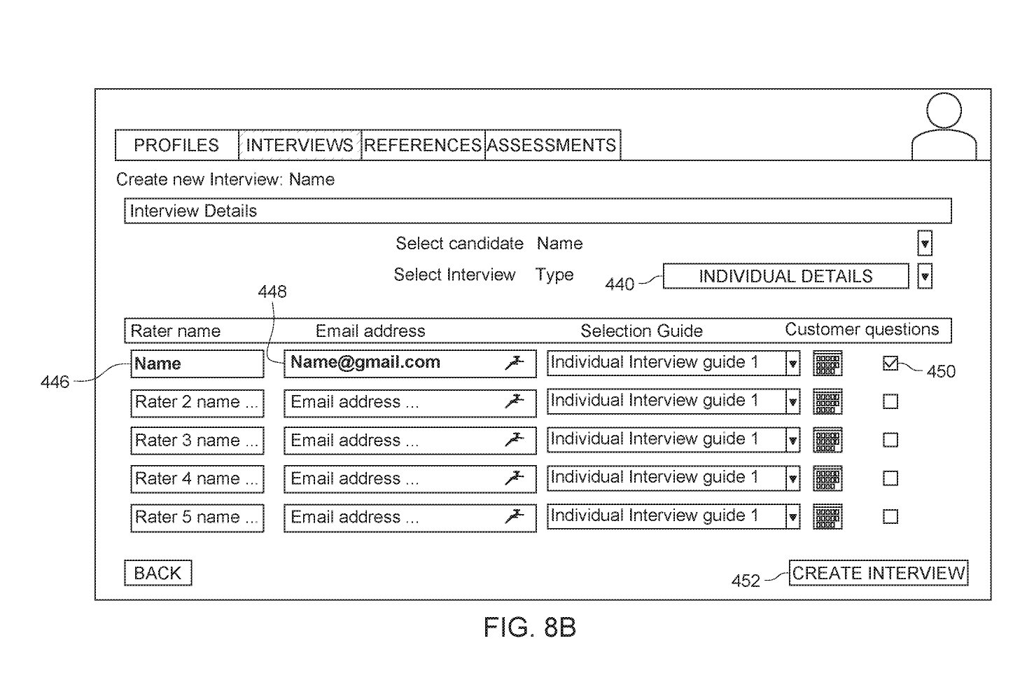

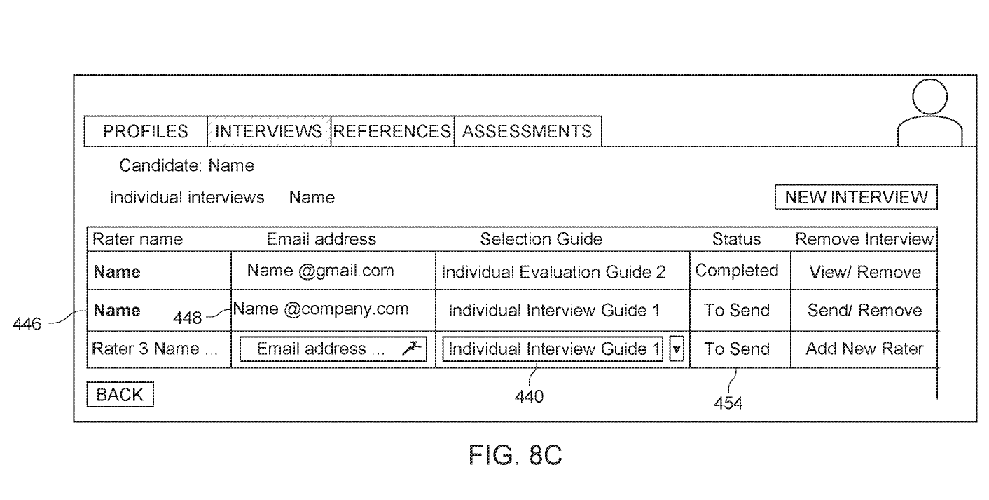

The selection process using the system and method (10, 20) may involve Applicant or Candidate interviews. As shown in FIG. 8A, the Aspire platform (100) may enable Human Resource Users, Super-users and/or Leads to design and use Individual Interview Guides (440) or Panel Interview Guides (442) to facilitate and administer Candidate interviews. Interview Guides within the system and method (10, 20) may be custom-designed either using questions from a compiled Interview Question library or from questions the User has utilized in the past. With this tool, the User can distribute different interview questions to various interviewers who meet with the same Candidate during the selection process. The User can also distribute the same set of Panel Interview questions using the Aspire platform (100) to a group of individuals who will meet with the Candidate in a Panel setting. Finally, the User can use the Manual Interview (444) to upload interview sheets that have already been completed. As shown in FIG. 8B, the User types in the Interviewer Name (446) and email address (448), selects the desired pre-designed Interview Guide, in this case the Individual interview guide (440), indicates if Custom Questions (450) from the CM should be included, and selects Create Interview (452) to create each interview event. When all interviewers have been entered, the User can send invitations to the Interviewers and monitor results. As shown in FIG. 8C, the User can also return to this location to check on the Status (454) of completed interviews.

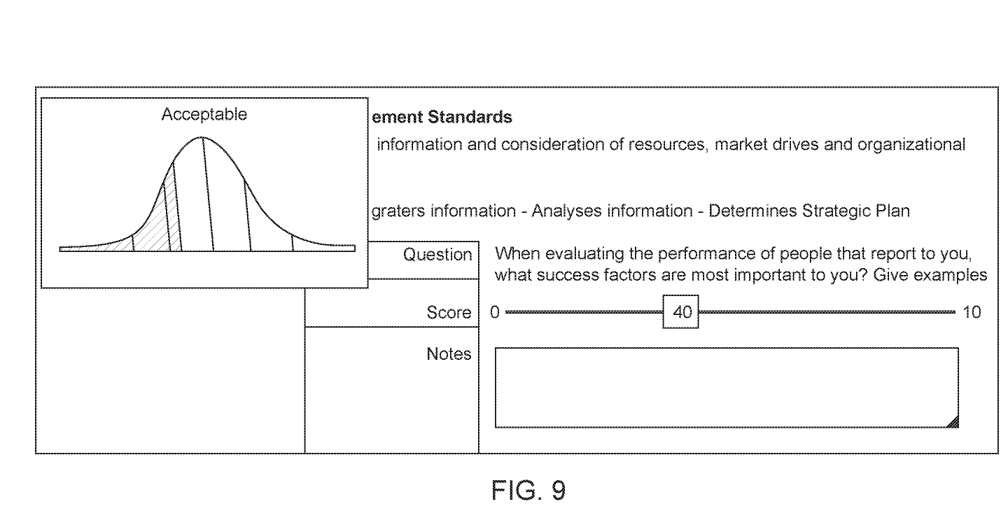

According to the system and method (10, 20), Interviewers receive electronic invitations to complete the interviews. The Interviewers can print out an Interview Rating Form or may interview the Candidate while entering the ratings directly into the Aspire platform (100). As shown in FIG. 9, the Interview Rating Form (456) is used to gather perceptions from Interviewers, and uses an Interview Rating Form slider mechanism (458). Rather than relying on a basic rating system, the Interview Rating Form (456) displays an interactive dynamic normal bell-shaped curve (460) with an Interview Rating Form narrative (462) that explains where the rater is scoring the Candidate response, compared to other Candidates. In this way, the system and method (10, 20) reduces the risk for common Central, Leniency, or Severity Tendency rating errors. Raters can also enter notes in an Interview Rating Form note field (464). Once the Interview has been completed, the Interviewer's ratings may be electronically transmitted to a Human Resource department. If any of the Central, Leniency, or Severity Tendency rating errors are detected, the Interviewer is notified and given the opportunity to correct their ratings prior to submitting their scores. The HR User can view the responses on the Aspire platform (100). The interview responses may also be held in a database (not shown), compiled with other interviews scores, and/or made available for review from a Decision Algorithm display, which may be part of a Candidate Analysis Report, discussed hereinafter.

### C. Electronic Reference 360s for Organizational Users

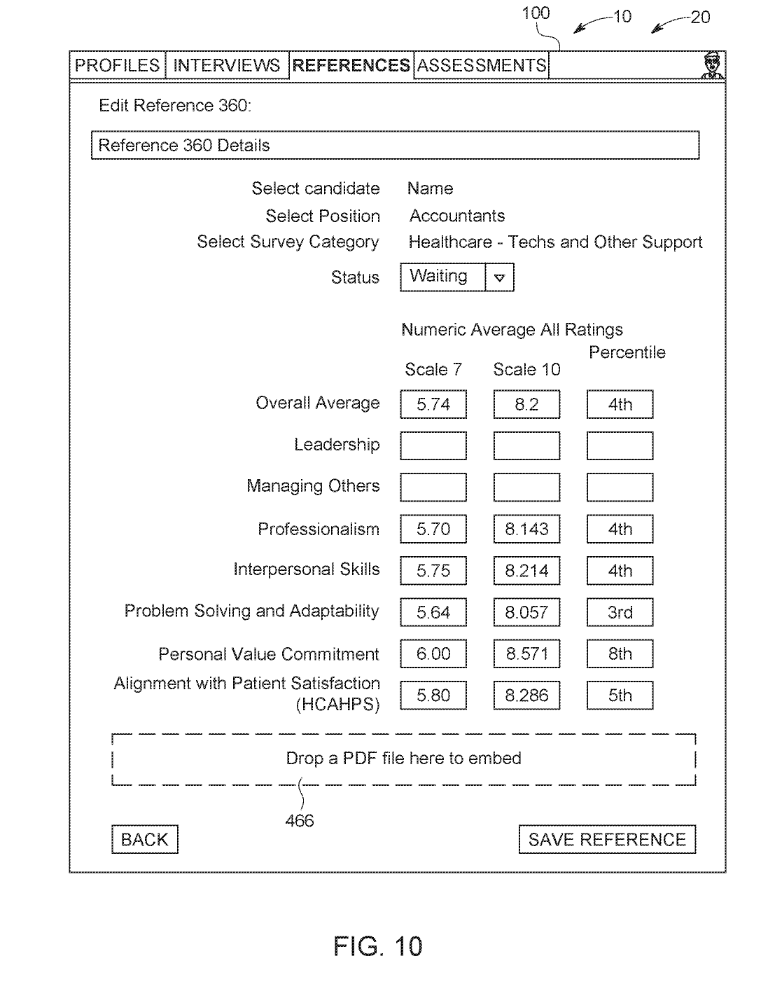

Embodiments of the system and method (10, 20) may provide for electronically embedding data analysis reports prepared by external sources, such as contracted entities. As a non-limiting example, an organization may contract with a second organization to analyze job-related performance criteria ratings. Users may request electronic references through the Aspire platform (100), as shown in FIG. 10. According to the system and method (10, 20), the Candidate then receives an email requesting reference contact information, including 2 former managers. The Candidate may then release past employers from liability. The Aspire platform (100) then sends Raters invitations to rate the Candidate on job-related performance criteria. If the organization has contracted with a second organization to analyze job-related performance criteria ratings, that second organization may then analyze the data from multiple job-related performance criteria ratings and provide the first organization with a report showing the Candidate's scores. The system and method therefore provides an embed field (466) that incorporates drag-and-drop upload technology to electronically recognize and/or embed the second organization's report into the Candidate database file. Similar drag-and-drop upload technology, electronic recognition, and embedding may be used to archive the Interviews referenced in FIGS. 8A, 8B, and 8C, and make them available for viewing from within the Decision Algorithm section of the Candidate Analysis Report, discussed hereinafter.

### D. Unique Approach to Assessment

Embodiments of the system and method (10, 20) provide access for Users to customize test batteries to assess only domains that are relevant to the selection decision. Test batteries according to the system and method (10, 20) are designed to enable P2C Affiliates and Users to draw valid inferences about factors that predict performance. Working together with a P2C Affiliate, Users customize and create assessment batteries within the system and method (10, 20) to assess Candidates across category domains associated with competency model criteria. Several Candidate assessment features may characterize embodiments of the system and method (10, 20).

A first Candidate assessment feature that may characterize an embodiment of the system and method (10, 20) is Multiple Tests. An assessment battery according to this embodiment may consists of a selected collection of robust tests from various publishers. The system and method (10, 20) therefore provides for the use of Multiple Tests to cross-validate findings. The online portal system or Aspire Platform (100) may allow a user to choose from in excess of four hundred tests. The system and method (10, 20) may further designate a subset of the tests as Featured Instruments. The Aspire Platform (100) may further map various scales on tests designated as Featured Instruments to CM criteria, which may further be included in customized test batteries.

A second Candidate assessment feature that may characterize an embodiment of the system and method (10, 20) is Integrated Summaries. Rather than providing a “canned” interpretation of test result reports, an embodiment of the system and method (10, 20) may include training P2C Affiliates to interpret and integrate findings. Reports may therefore include an Integrated Summary section wherein each instrument's test findings are cohesively interpreted and explained within the context of an employment position's essential functions. This embodiment of the system and method (10, 20) leverages the value of multiple instrument cross-validation.

A third Candidate assessment feature that may characterize an embodiment of the system and method (10, 20) is Dynamic Comparative Graph Reporting. Instead of providing static reports that run the risk of being seen by unauthorized personnel, the Aspire Platform (100) may publish all assessment reports via a secure electronic link. As a result, only individuals who are authorized to view the tests receive links. The Aspire Platform (100) may allow Users to limit the amount of time that invited viewers have access to the reports. Embodiments of the system and method (10, 20) using online links also enable the reports to display comparative data via dynamic graphs. The Aspire Platform (100) may allow Selection committee members or hiring managers to compare test results to organizational norms, industry norms, position norms, and/or present or past candidates, using drop-down selectors on various graphs, if the Selection committee members or hiring managers are so authorized. Permissions to view assessment data according to the system and method (10, 20) may be collaboratively managed by HR Super-Users and P2C Affiliates.

A fourth Candidate assessment feature that may characterize an embodiment of the system and method (10, 20) is Fit Analysis. Pre-employment assessment vendors frequently provide hire or do not hire recommendations, using “cut score” algorithms that have been statistically derived from lengthy and costly validation studies of current employees. This method of validation prevents companies from using pre-employment tests if there are too few people in that position, if it is a new position, or if there is not sufficient time or money to conduct initial validation studies. In contrast, embodiments of the present system and method (10, 20) may not make hiring recommendations. Selection reports produced by embodiments of the present system and method (10, 20) may instead identify differences or similarities between CM-driven selection preference criteria and test performance scores. Accordingly, the Integrated Summary section of the Candidate Analysis Report may inform Users and selection committees about their Candidate's Position Fit, for non-limiting example Essential Functions and Competency Alignment, as well as Culture Fit, for non-limiting example Personality and Value Alignment. This Candidate assessment feature allows clients to make informed decisions, based on a Candidate's strengths, such as where the Candidate is well aligned with CM preferences, and the Candidate's challenges, such as where they are misaligned with CM preferences.

A fifth Candidate assessment feature that may characterize an embodiment of the system and method (10, 20) is a Weighted Decision Algorithm Method. Rather than making hiring recommendations based on test performance alone, this embodiment of the system and method (10, 20) may incorporate data gathered from multiple sources. The Decision Algorithm section of the Candidate Analysis Report may permit Selection Committee members to assign desired weights to various data sources. For non-limiting example, Individual Interviews, Panel Interviews, Behavioral Observations, and/or Assessment Results may each be assigned varying weights. According to this embodiment, the Aspire Platform (100) may allow additional weight to be assigned to Subjective criteria, such as anticipated fit with the current team or future team. Each of these weightings then informs the weighted average calculation of the Candidate's final score. The final score of competing Candidates can then be consistently compared, using this embodiment of the system and method (10, 20), thereby reducing bias. The embodiment of the system and method (10, 20) utilizing the Weighted Decision Algorithm may also archive and document access to each Candidate's calculations as well as the results of their hiring decisions.

### E. Test Administration

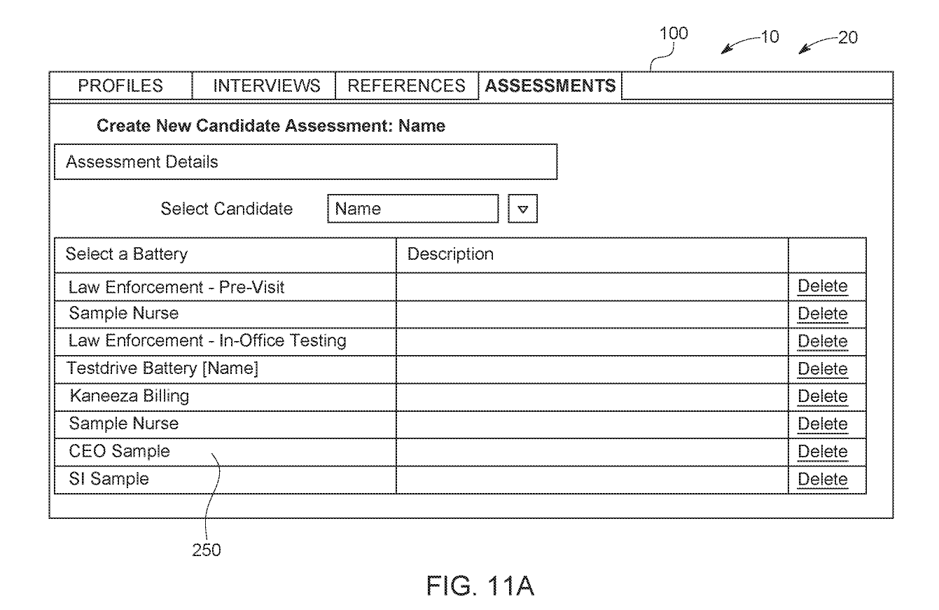

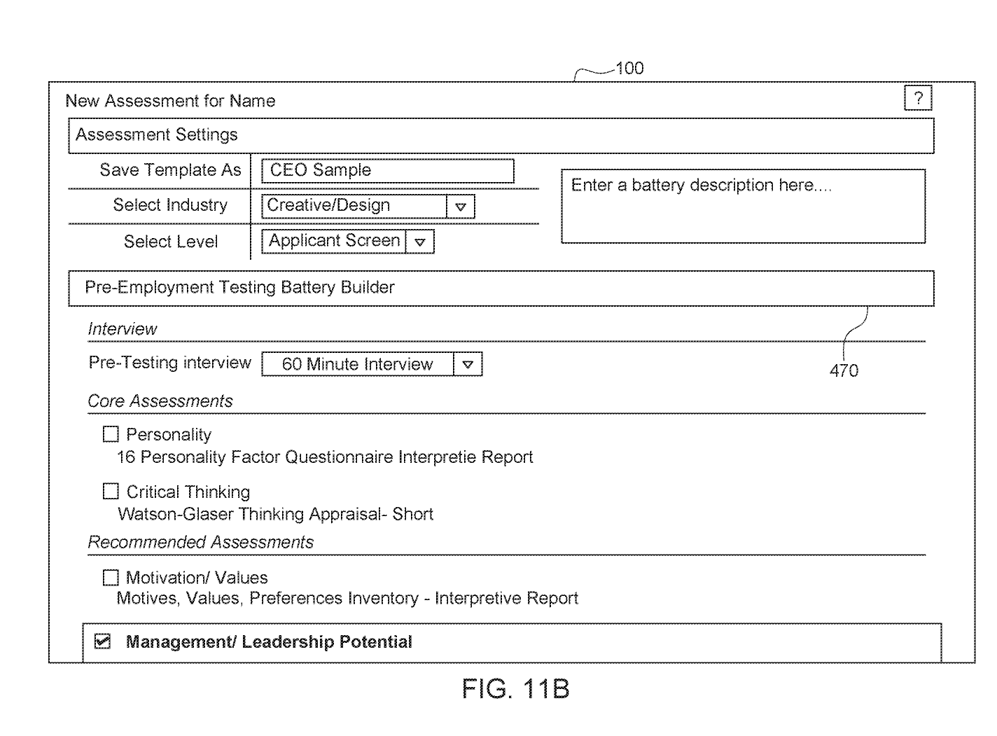

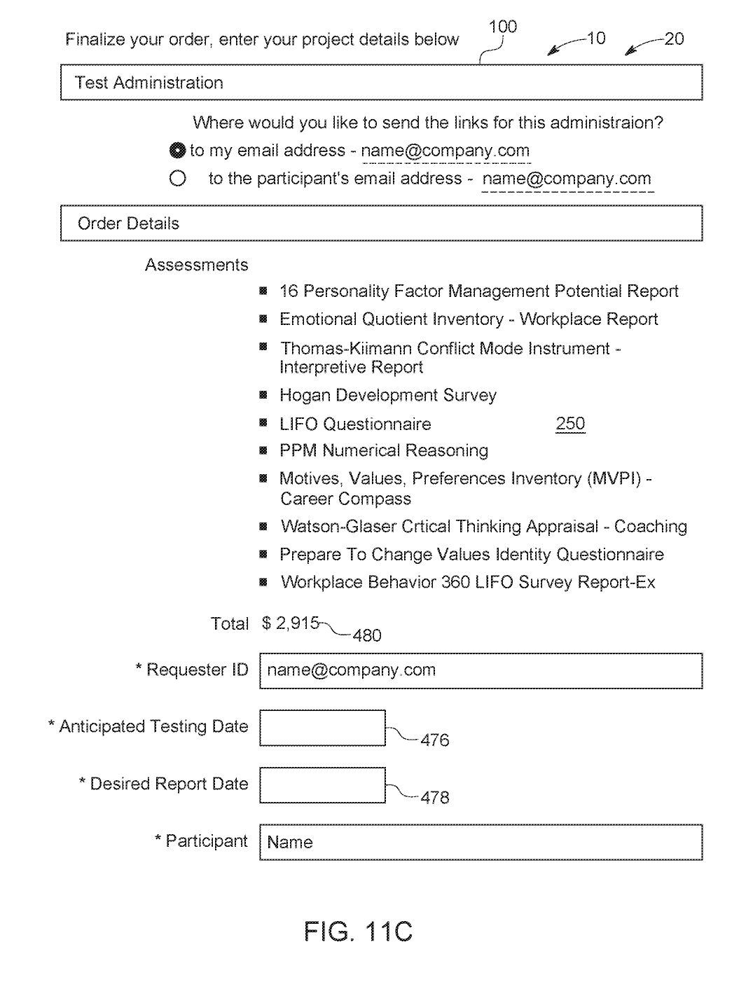

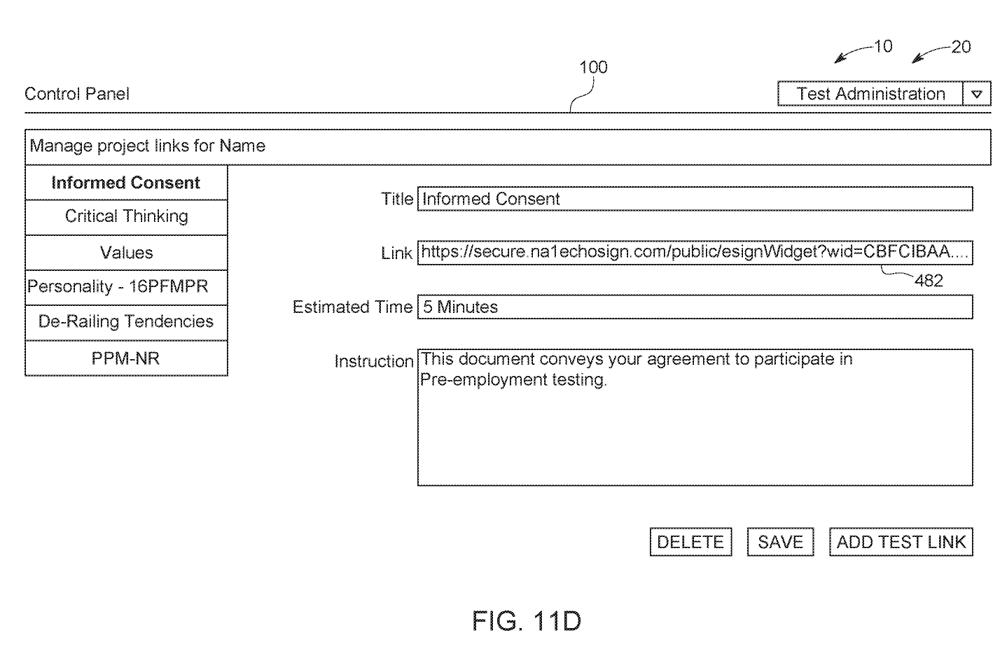

Similar to the way that the Aspire Platform (100) enables Human Resource Users, Super-users, and/or Leads to administer and manage interviews and Electronic Reference 360s, as discussed infra, when an HR User is ready to move forward with testing, the HR User logs in to the Aspire Platform (100) to initiate testing activities. As shown in FIG. 11A, the HR User is prompted to select the Candidate to test and presented with a screen to select or create saved assessment batteries (250). As shown in FIG. 11B, if the HR User selects to create an assessment battery, he or she is presented with the Pre-Employment Battery Builder (470), which features a list of report options (472) along with Featured and/or Recommended tests (474). Embodiments of the Aspire Platform (100) may provide Informational videos about each Featured test that can be viewed at this point. Embodiments of the Aspire Platform (100) may allow Users to request P2C Affiliate interviews of the Candidate, select varying report lengths with different detail levels, mark turn-around time, and/or choose feedback preferences. Users may further be able to request a Candidate Feedback Report. When all report preferences are selected, using the Pre-Employment Battery Builder (470), the price may be adjusted to reflect the preferences and the User may be given the opportunity to continue placing the order.

As shown in FIG. 11C, Users have the option of receiving the test link themselves or having the link sent directly to the Candidate. When Users enter the Anticipated Testing date (476), a Desired Report Date (478) may be calculated based on the number of assessment batteries (250) selected. If the User wants the reports sooner, the price (480) may be adjusted to allow for rush fees. Embodiments of the system and method (10, 20) may allow the User to pay for the service with a credit card, prepaid credits, eCheck, or pre-arranged direct billing to the company. Once the order has been placed, the designated P2C Affiliate receives a notification from the Aspire Platform (100) and fulfills the order. Within the Aspire platform (100), P2C Affiliates manage test inventories where pre-paid test links are stored to be used during order fulfillment. When the P2C Affiliate receives an order request, they log into the Aspire platform (100) to Create and Send test administration links.

When the P2C Affiliate sends test notification links to the Participant or Candidate, the designated recipient receives an email with instructions for taking the test using a password protected login (484) (not shown) to the Aspire Platform (100). As shown in FIG. 11D, when the Participant enters their User ID and Password, they are presented with a link to an Informed Consent to Testing (482) as well individual links to other the tests in the assessment battery (250). The Participant then moves through the assessment battery sequence within the Aspire Platform (100) of the system and method (10, 20). As each test is completed, the test publisher forwards the test results in Portable Document Format, or similar, form to the Aspire Platform (100). When all testing is completed, the P2C Affiliate can begin to prepare the report.

### F. Assessment Report Preparation—Production and Integration Processes

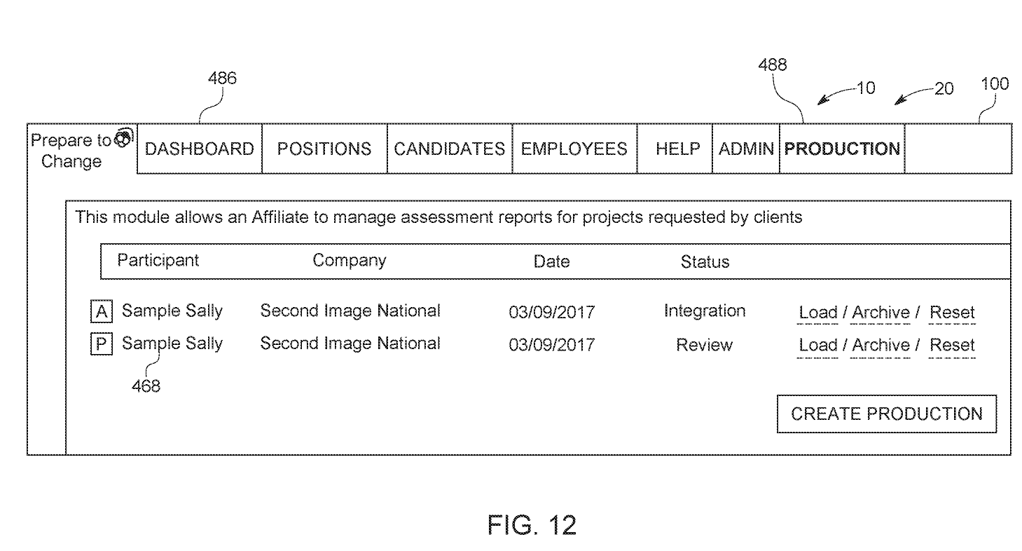

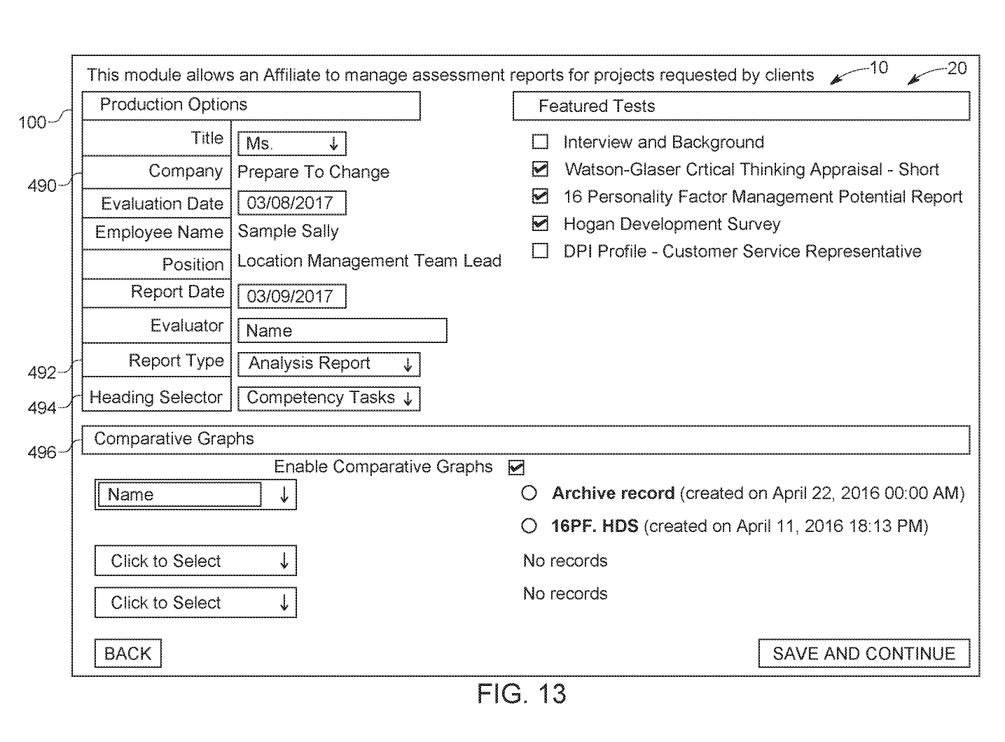

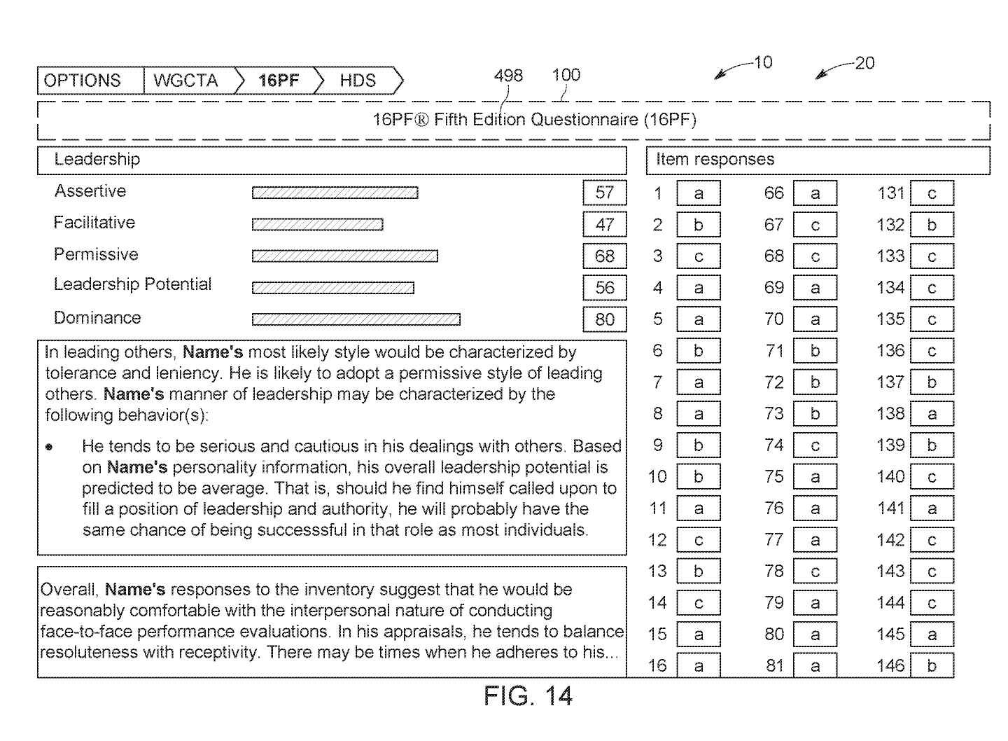

According to the system and method (10, 20), P2C Affiliates may prepare assessment reports for HR Users and selection committees using the Aspire Platform (100). As shown in FIG. 12, the Login Menu (486) provides access to a Production Tab (488) that allows the P2C Affiliates to create Production Projects for assessment orders. To create and manage a production project, the P2C Affiliate selects the Participant (468) from received orders and validates the report parameters. At this point, as shown in FIG. 13, the Affiliate can adjust report options (490) to reflect changes in the Report Type (492), such as different headings (494) in the Integration Section, or can enable additional services, such as Enabling Comparative Graphs (496). As the P2C Affiliate advances through the Production process, according to one or more embodiments of the system and method (10, 20), they may be presented with screens that enable them to upload test result data reports using drag-and-drop upload, electronic recognition, and embedding technology, as shown in FIG. 14. In FIG. 14, a drag-and-drop upload field (498) is provided for this purpose. In this way, the Aspire Platform (100) may collect needed data from the various reports, eliminating the risk of keying errors. Data may also be collected and archived for statistical purposes.

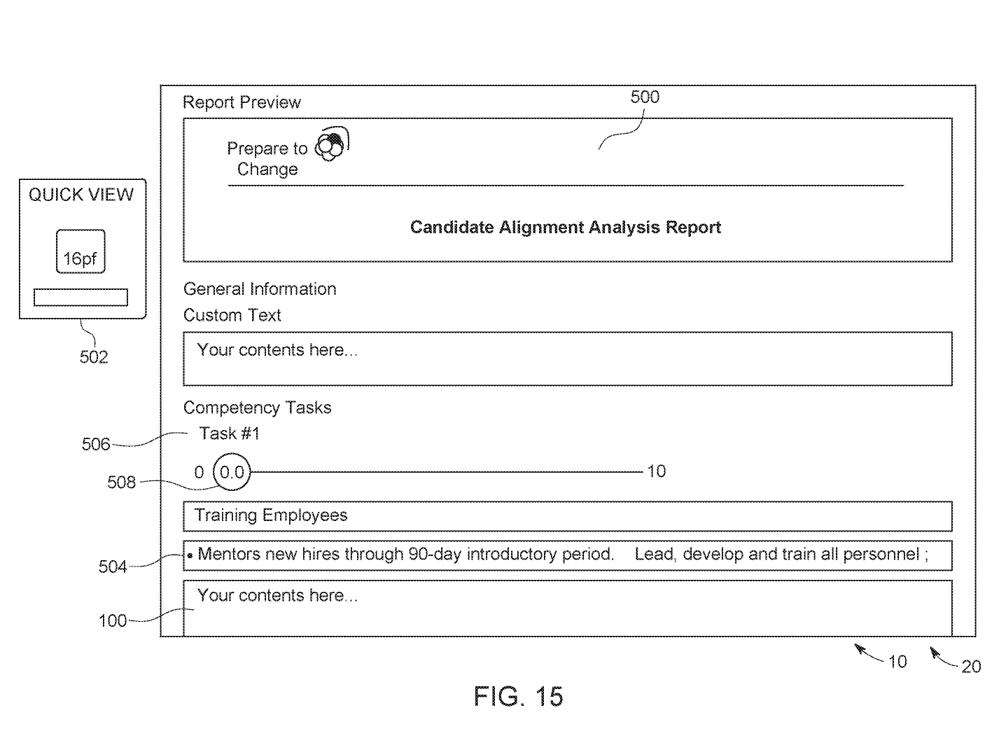

Once all the test data is collected, the P2C Affiliate advances the report to the Integration phase. In this stage of the system and method (10, 20), as shown in FIG. 15, a Report Preview (500) appears at the top of the screen, Quick View (502) makes test data available for reference, and integration sections, organized by pre-determined headings appear. The P2C Affiliate may use the Aspire Platform (100) to review the test results and creates an interpretive narrative (504). Interpretive narratives (504) appear in the Integrated Summary (506) section of the report, often organized under Competency Fit Analysis headings that flow through from the CM for that position. Taking all test data into account as well as Competency and Culture Alignment score calculations that appear in the Report Preview, the P2C Affiliate may adjust the Integrated Summary slider mechanism (508) to reflect his or her assessment of the Candidate's Alignment/Fit with the Essential Functions or Competencies delineated in the CM. According to the system and method (10, 20) the report is now nearing completion and is moved to Review stage. In certain embodiments of the system and method (10, 20), one of the P2C psychologists may review the report and/or a further Quality Control review may take place prior to Finalizing and Publishing the report.

### G. Alignment Analyses Calculations and Graphs

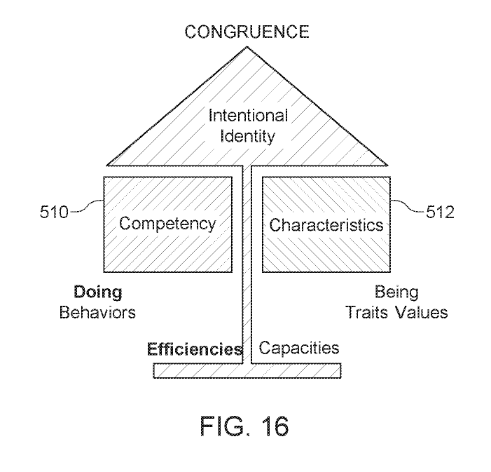

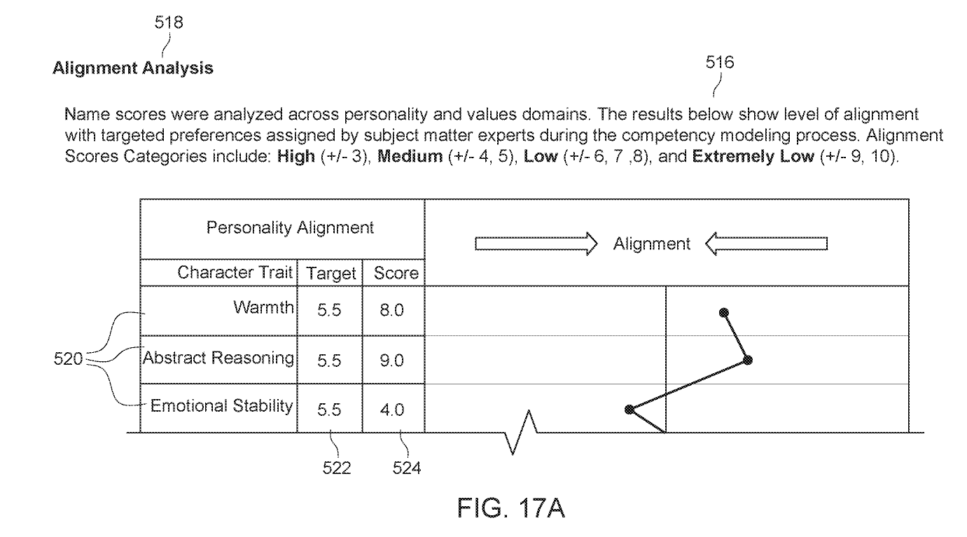

As mentioned previously, the Aspire Platform (100) calculates the degree to which a Candidate fits or is aligned with the criteria for the position identified in the CM process. As shown in FIG. 16, alignment criteria on the CM falls into the categories that include Position Criteria (510), which may include Competency and Essential Function Analysis, and Culture Criteria (512), which may include Personality and Values Analysis. This reflects the system and method's model of Congruence (514) that may guide leader assessment and development activities.

### Culture Alignment—Personality Alignment

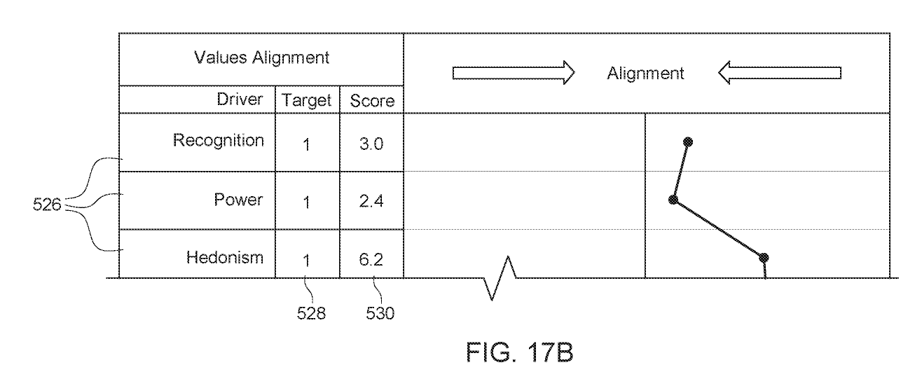

As shown in FIG. 17A, in the Alignment Analysis section (518) of the Candidate Analysis Report (516), the Target scores (522), which may be trait levels identified and finalized during the CM creation, are shown for various personality scales (520), using 16PF Primary Factors. Next to the Target score (522), the Candidate's actual Score (524) is displayed. To arrive at the level of fit for personality factors, the absolute value of the difference between the Target score (522) and actual Score (524) is calculated and plotted on the graph for each personality factor (520). An overall Personality Alignment score is calculated using a weighted average, based on weights assigned to the corresponding traits established in the Culture Fit section of the CM.

### Culture Alignment—Values Alignment

In a similar way, the corresponding Value target scores (528) and Value actual scores (530) are shown, using Value scales (526) from the Hogan Motives Values Preferences Inventory (MVPI), as shown in FIG. 17B. The Value target score (528) is the weight assigned to that value in the Culture Fit section of the CM. The Candidate's Value actual Score (530) on the corresponding MVPI scale is displayed. The absolute value of the difference between the Value target score (528) and the Value actual score (530) is calculated and plotted on the graph for each value scale (526). An overall Values Alignment score is calculated using a weighted average, based on weights assigned to the corresponding traits established in the Culture Fit section of the CM.

### Competency Fit Analysis

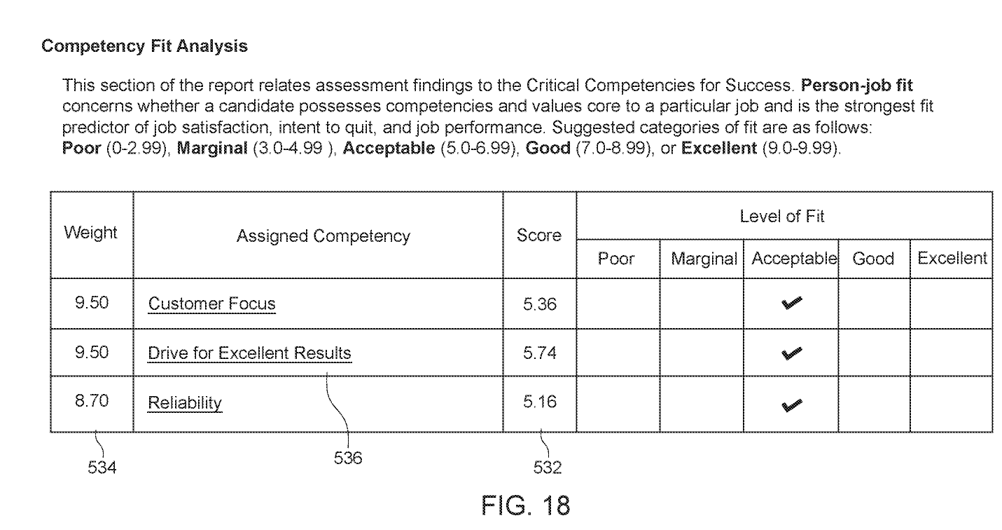

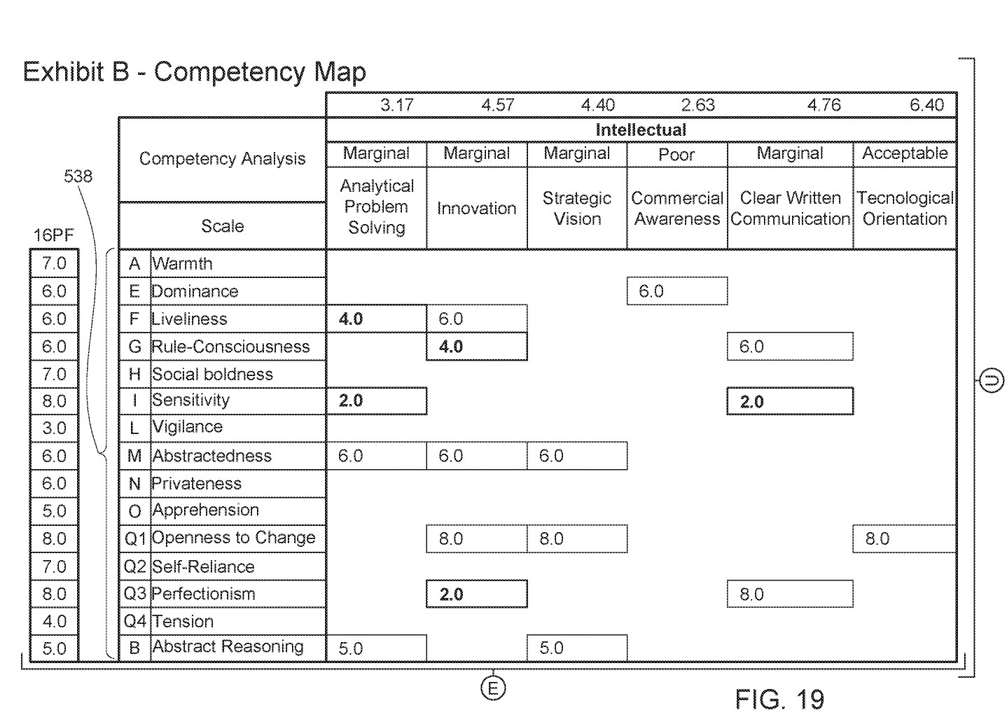

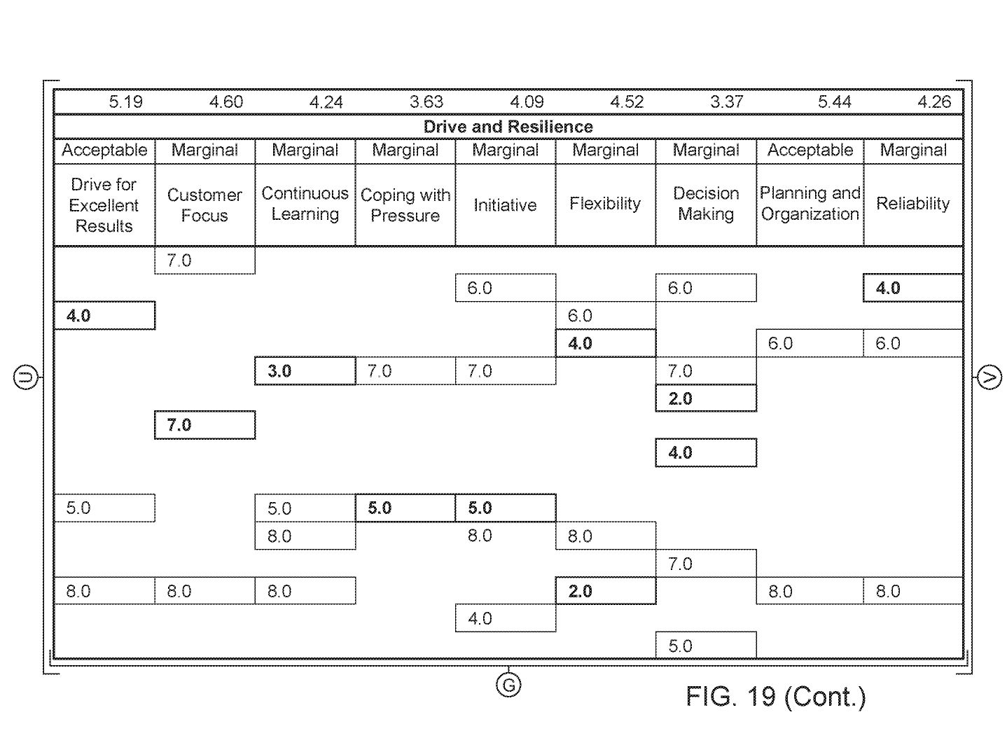

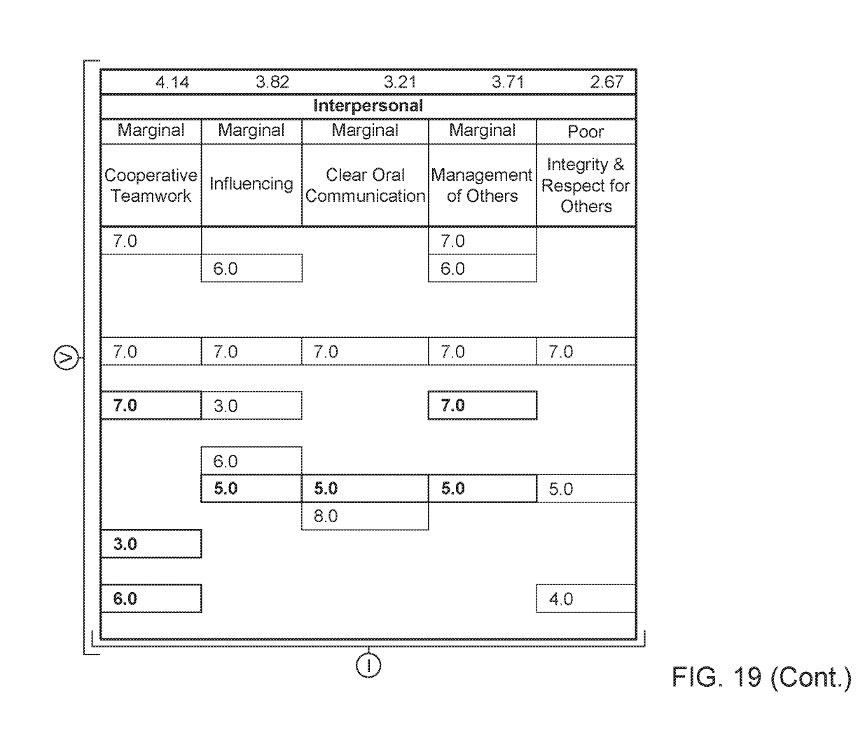

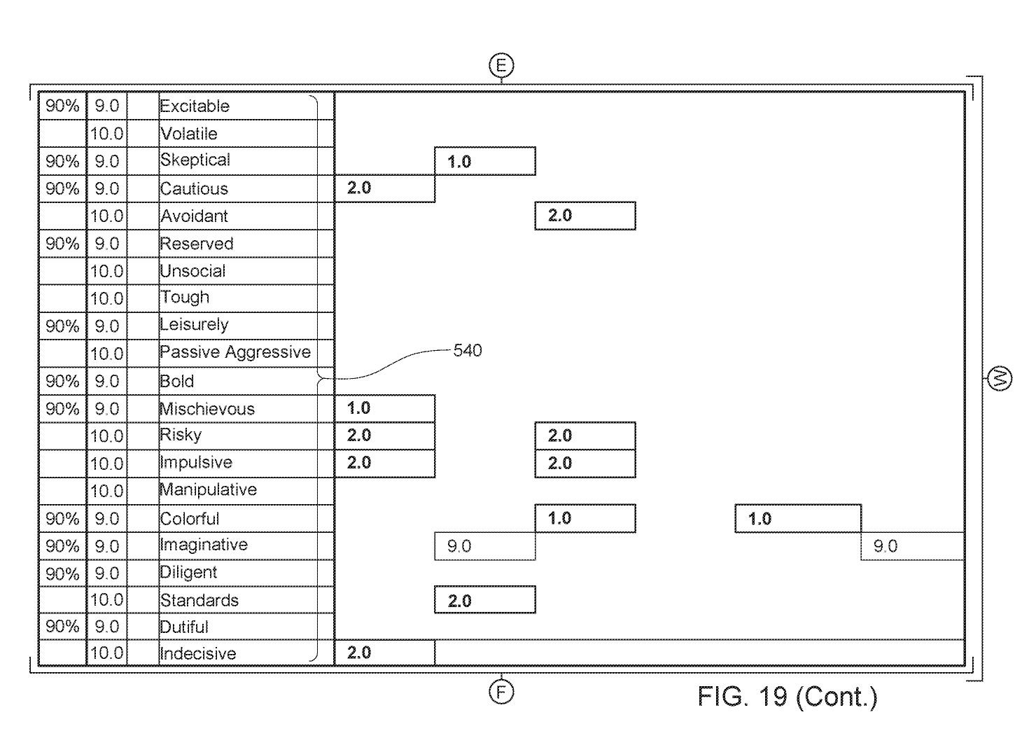

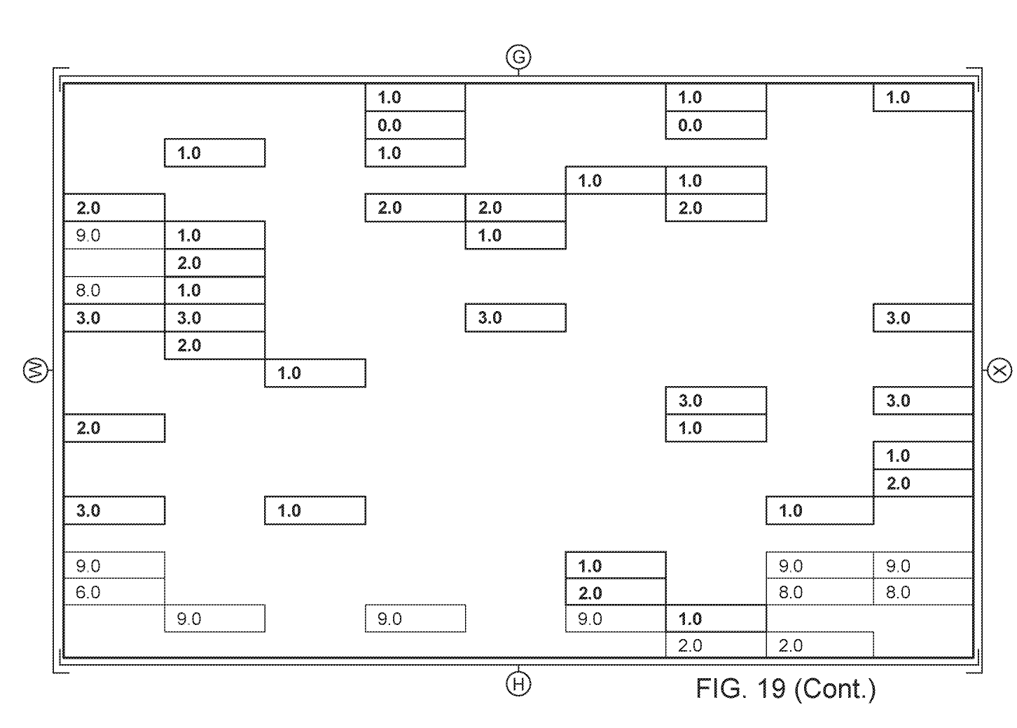

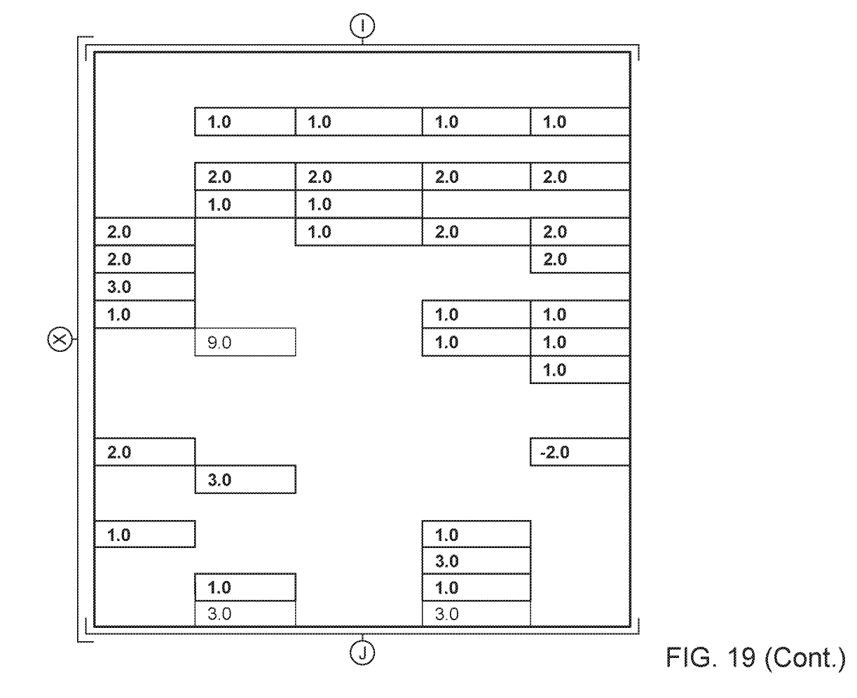

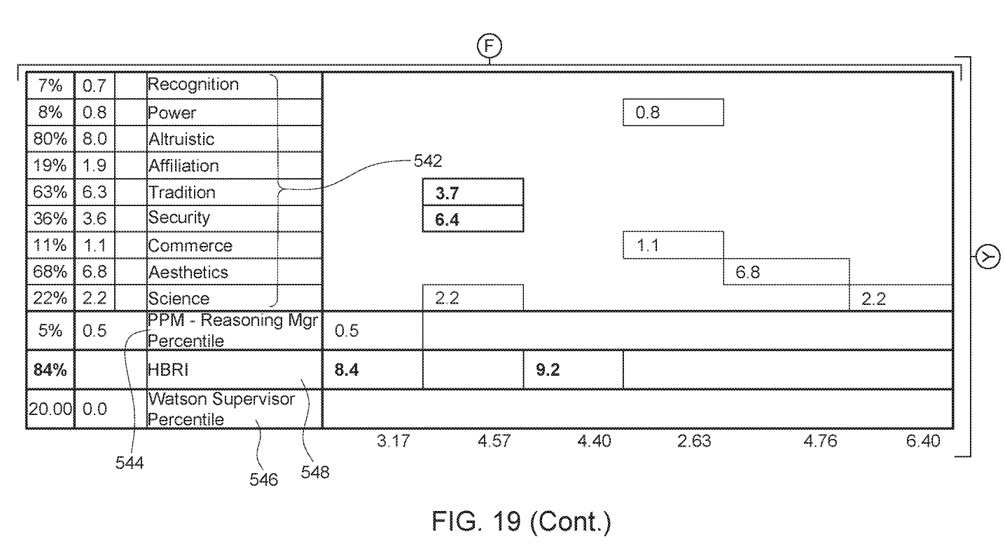

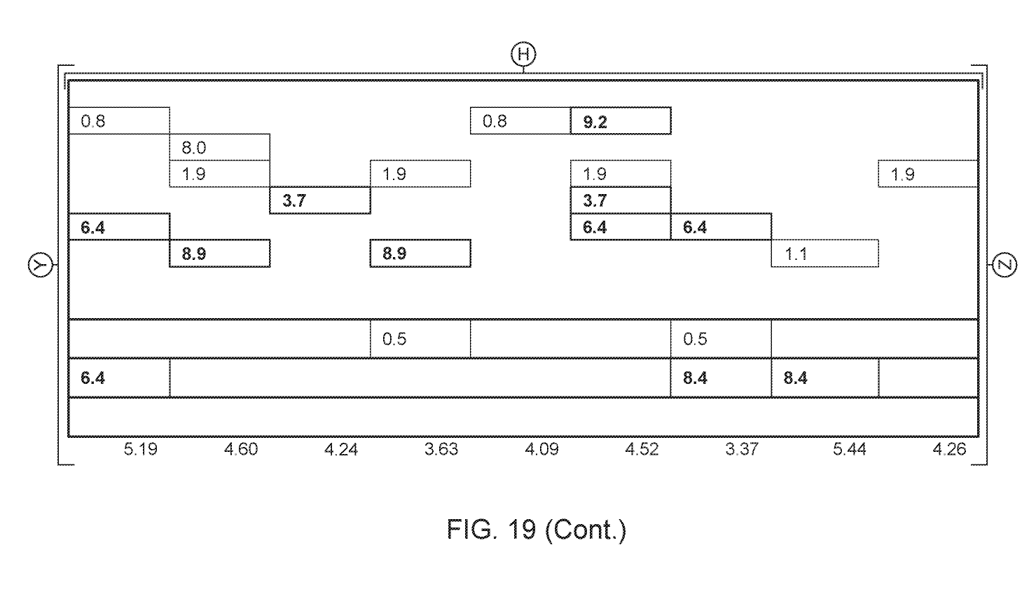

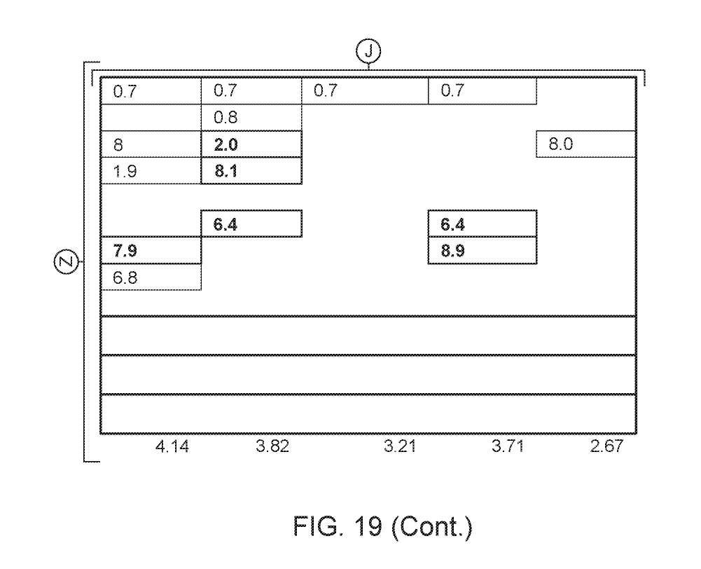

As shown in FIG. 18, in the Alignment Analysis section (518) of the Candidate Analysis Report (516), the Candidate Competency scores (532) are displayed, along with the weights (534) assigned to each competency (536) in the Competency section of the position's CM. To calculate a Candidate's overall Competency Fit, the Candidate's score for each competency is calculated using the map shown in FIG. 19. Scores from the 16PF (538) include Warmth, Dominance, Liveliness, Rule-Consciousness, Social Boldness, Sensitivity, Vigilance, Abstractedness, Privateness, Apprehension, Openness to Change, Self-Reliance, Perfectionism, Tension, and Abstract Reasoning, and are assigned with varying weights, contributing positively or negatively to any given competency. Similarly, scores from the Hogan Developmental Scale (HDS) (540) include Excitable, Volatile, Skeptical, Cautious, Avoidant, Reserved, Unsocial, Tough, Leisurely, Passive Aggressive, Bold, Mischievous, Risky, Impulsive, Manipulative, Colorful, Imaginative, Diligent, Standards, Dutiful, and Indecisive, and are assigned with varying weights, contributing positively or negatively to any given competency. In a similar way, scores from the MVPI (542) include Recognition, Power, Altruistic, Affiliation, Tradition, Security, Commerce, Aesthetics, and Science, and are assigned with varying weights, contributing positively or negatively to any given competency. Also scores from the PPM-Numerical Reasoning (544), Hogan Business Reasoning Index (546), and Watson-Glasser Critical Thinking Appraisal (548) each may contribute toward various competencies as indicated. Once all scores are registered, the average of all scores is calculated, influenced positively or negatively by contributing scale scores in that competency's column.

### Alignment Summary

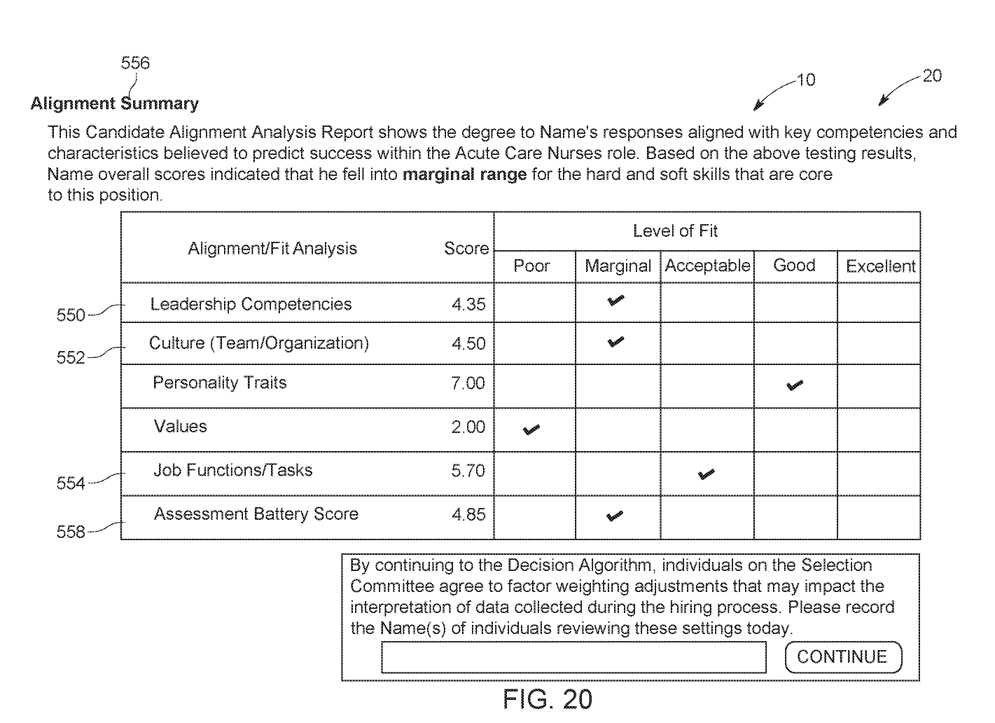

As shown in FIG. 20, at least one embodiment of the system and method (10, 20) calculates an overall Leadership Competency alignment score (550) using a weighted average of all competency scores, based on weights assigned to the corresponding competencies established in the Competency section of the CM. The system and method (10, 20) may also calculate an overall Culture (Team/Organization) alignment score (552) using a weighted average of all Personality and Values scores, based on weights assigned to the corresponding Personality Trait and Values preferences in the Culture section of the CM. The system and method (10, 20) may also calculate an overall Essential Functions alignment score (554) using a weighted average of Task scores, based on weights assigned to the corresponding Task preferences in the Tasks section of the CM. A summary of these weighted averages is presented, along with a mean average of all these weighted averages in the Alignment Summary (556). This mean average becomes the Assessment Battery Score (558). Any person who is viewing the Candidate Analysis Report via online link may record their name/names and press Continue to view the Decision Algorithm.

### H. The Weighted Decision Algorithm

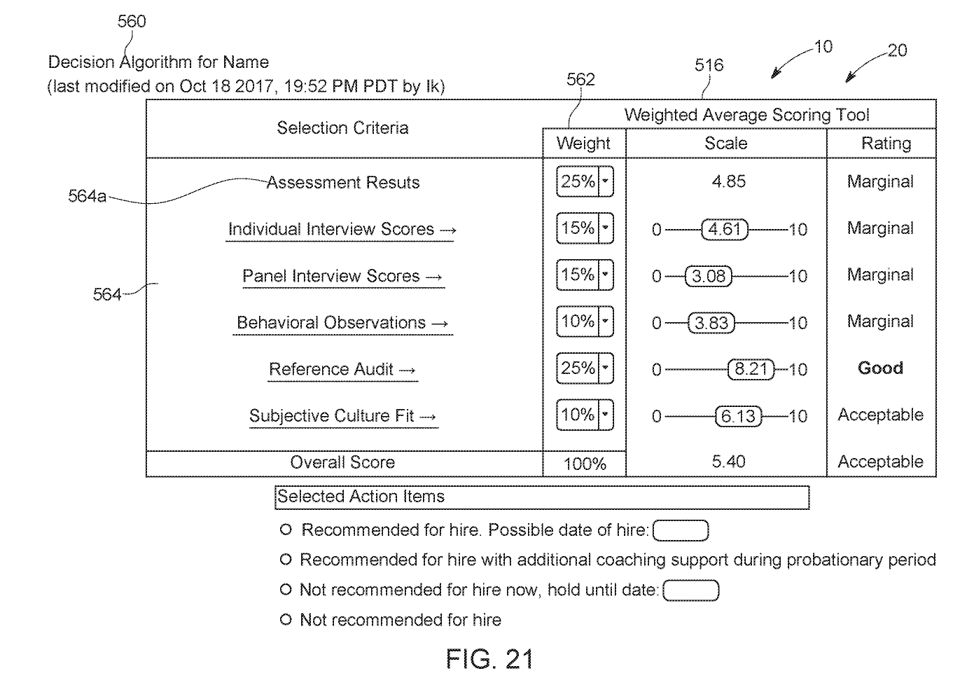

As shown in FIG. 21, the final section of the Candidate Analysis Report (516) in at least one embodiment of the system and method (10, 20) includes the Weighted Decision Algorithm (560). In this section, the Selection Committee can determine how much weight (562) they want to give to various sources of data (564) that will inform the hiring decision. In the example shown, the Selection Committee assigned a weight of 25% to the Assessment results (564A). The score of 4.85 flowed through from the Assessment Battery Score (558). The Weighted Decision Algorithm (560) of the system and method (10, 20) effectively limits the extent that any one source of data (564) can skew the final results, and allows the Selection Committee to access and control data that otherwise might increase embedded bias in the final decision. Lacking this data, Selection Committees would otherwise rely on possibly biased impressions of the Candidate. To increase their awareness of potential bias in the decision, a link to a Hiring Decision Biases chart, is provided to all individuals who view the Weighted Decision Algorithm (560), An exemplary Hiring Decision Biases chart may include the following information:

Hiring Decisions: Beware of Different Types of Psychological Bias!
The difference between reality and perception is that people make decisions based on
perception, not reality. This is particularly true when making hiring decisions. Reasoned
Judgments involve common sense, are clear thinking, rule-governed, objective, and measured. In
contrast, Intuitive Impressions are often rapid, automatic, effortless, rigid, and emotionally
reactive. Intuitive impressions often involve cognitive bias, the tendency to make decisions or act
in an illogical way that leads to missed opportunities and poor decision-making outcomes.

| Bias | Description | Example |
|---|---|---|
| Stereotype Bias | Basing decisions on “snap- | Hiring an Asian candidate for a math- |
| | judgment” stereotypes across | heavy position, believing individual will |
| | groups about people's | excel in that role; selecting a male over |
| | competencies based on their | a female for leadership position, even |
| | ethnicity, gender, or other | after learning that there is no outcome |
| | dominant characteristic. | differences between genders. |
| Confirmation Bias | Looking for or listening only to | Becoming too heavily invested in a |
| | information that supports existing | hypothesis and looking for ways to |
| | beliefs, rejecting data that go | prove it, an interviewer forms a distinct |
| | against those beliefs. | opinion about a candidate based on a |
| | | piece of information such as their GPA |
| | | or college they attended. |
| Availability/ | Overestimating the importance of | Inadvertently manipulating or |
| Effective | information that is most readily | interpreting test results, judging |
| Heuristic | available to us, interpreting results | someone's job suitability by easily |
| Bias | based on the availability of certain | obtained factors such as visible tattoos, |
| | data. | personal body weight, or interview |
| | | scores alone. |
| Expectation | Gravitating toward people who | Allowing a candidate's good qualities or |
| Anchor/Halo | reflect ourselves, we | at least the strengths we approve of, to |
| Effect/Priming | subconsciously associate one | blur our perception of their |
| | positive trait to a sequence of | weaknesses, generalizing their |
| | future traits or everything else | strengths to other areas; hiring |
| | about that person, overlooking | someone with whom we identify or |
| | their flaws. | who seems similar to a previously |
| | | successful candidate, not the job. |
| Anchoring Bias/ | Becoming over-reliant on the first | Responding to pressure to make a |
| Primacy Effect/ | piece of information offered to | quick decision, the hiring committee |
| Conservatism | establish a range of reasonable | uses the first candidate as a yardstick |
| Bias | possibilities in each person's | by which to measure future candidates. |
| | mind;; believing prior evidence | |
| | more than new evidence. | |
| Recency | The tendency to weigh the latest | Tending to remember the strengths of |
| Effect | information more heavily than | the candidate most recently |
| | older data. | interviewed rather than the first |
| | | several candidates. |
| Overconfidence | Placing too much faith in one's | Taking greater risks in future hiring |
| Bias | own knowledge and opinions, | decisions based on success of past |
| | over- valuing one's own | hires. |
| | experience. | |
| Gambler's | Seeing patterns in random events | Drawing the conclusion that after |
| Fallacy | or expecting past events to | having interviewed 5 candidates, the |
| | influence the future, assuming the | next candidate is bound to be better. |
| | chances of a given outcome are | |
| | greater because it is long over-due. | |
| Fundamental | The tendency to explain the | Concluding that a team's failure to |
| Attribution | failures or successes of others | meet the goal was due to the leader |
| Error | based on their character or | being an introvert. |
| | disposition, rather than the | |
| | situation. | |
| Actor- | The tendency to attribute one's | Harshly judging the actions of others, |
| Observed | own failures to external causes, | but letting oneself off the hook for the |
| Bias | and personal successes to internal | same behavior. |
| | causes. | |
| Bandwagon | The probability of one person | One member of the selection |
| Effect/ | adopting a belief increases based | committee becomes influenced to |
| Conformity | on the number of people who | conform, abandoning his or her |
| Bias | hold that belief. | concerns to adopt the conclusions of |
| | | others. |
| Choice- | When choosing something, a | When a candidate is selected, the |
| supportive | person tends to feel positive | hiring manager tends to continue to |
| Bias/Post- | about it, even if the choice has | think the new employee is awesome, |
| purchase | flaws, even to the point of | even ifs/he performs poorly once in a |
| Rationalization | inflating the value after the fact. | while. |
| Decoy Effect | Making a specific change in | Simply increasing the candidate pool |
| | preference between two choices | often shifts the most favored status to |
| | after being presented with a third | the candidate with more moderate |
| | choice. | “safer” scores. |
| Hindsight/ | The mind arranges historical facts | Judging the effectiveness of a hiring |
| Outcome | in ways that make past events feel | decision based on subsequent |
| bias | a lot less uncertain, and a lot more | outcomes rather than the merit of |
| | predictable. | exactly how that decision was made in |
| | | the moment. |
| Affect | The tendency to allow our | An interviewer feels emotionally |
| Heuristic | personal feelings or needs to filter | attracted or repulsed to a candidate, |
| | our interpretation of the world. | intuition is permitted to override |
| | | evidence to the contrary and the |
| | | process is altered. |
| Self-enhancing | The tendency to share our | An interviewer wanting a candidate to |
| Transmission | successes more than our failures, | be successful that s/he fails to ask |
| Bias | positive impression management. | critical questions that might reveal that |
| | | candidate's flaws. |
| Negativity/ | The tendency to perceive threats | A hiring manager concluding that |
| Optimism | more than opportunities in a given | candidates lie and discounts their |
| Skew | situation. | strengths even in the face of strong |
| | | evidence; or a supervisor rates all of |
| | | her subordinates higher in the hopes |
| | | this will encourage them to live up to |
| | | their potential. |

| | | |
|---|---|---|
| | Intuition | Reasoning |
| Perception | System 1 | System 2 |

| | | |
|---|---|---|
| Process | Fast | Slow |
| | Parallel | Serial |
| | Automatic | Controlled |
| | Effortless | Effortful |
| | Associative | Rule-governed |
| | Slow-Learning | Flexible |
| | Emotional | Neutral |

| | | |
|---|---|---|
| Content | Percepts | Conceptual representations |
| | Current stimulation | Past, Present, and Future |
| | Stimulus-bound | Can be evoked by language |

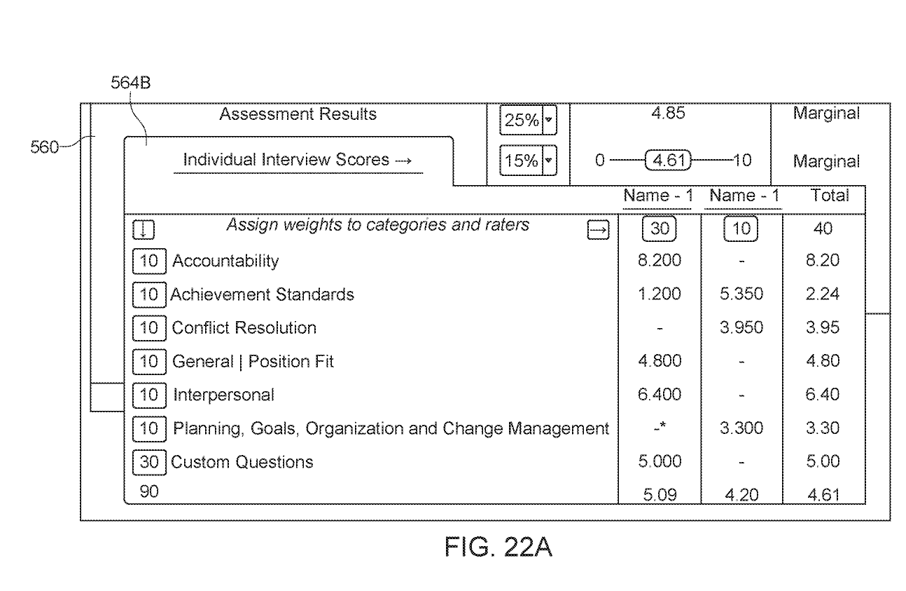

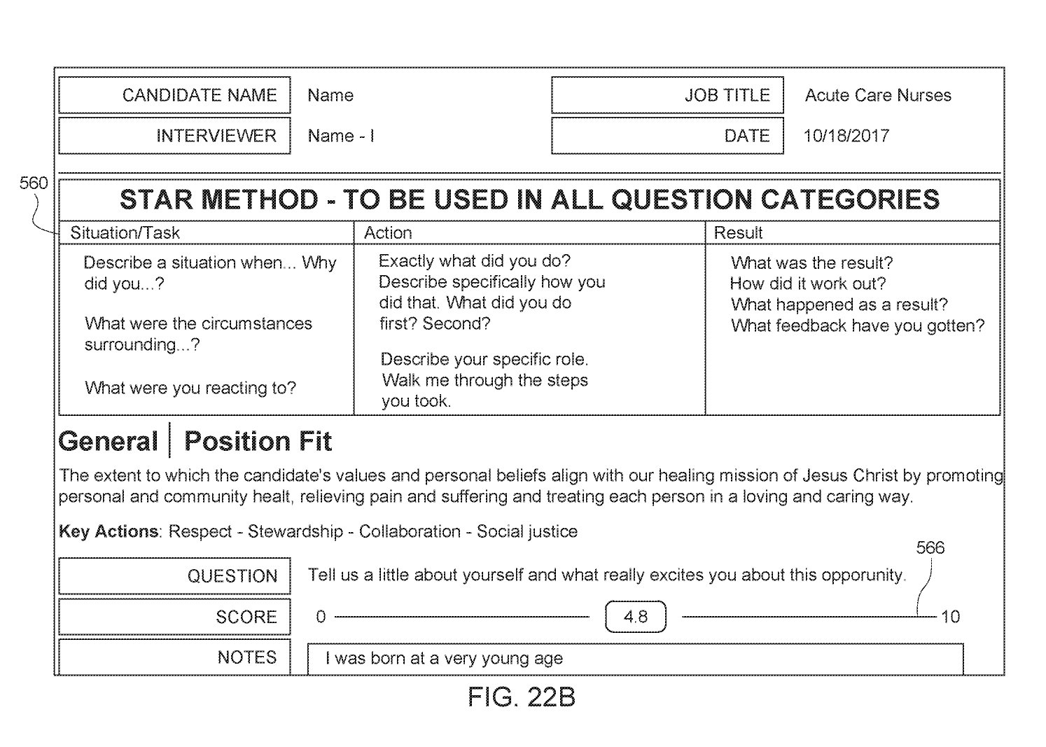

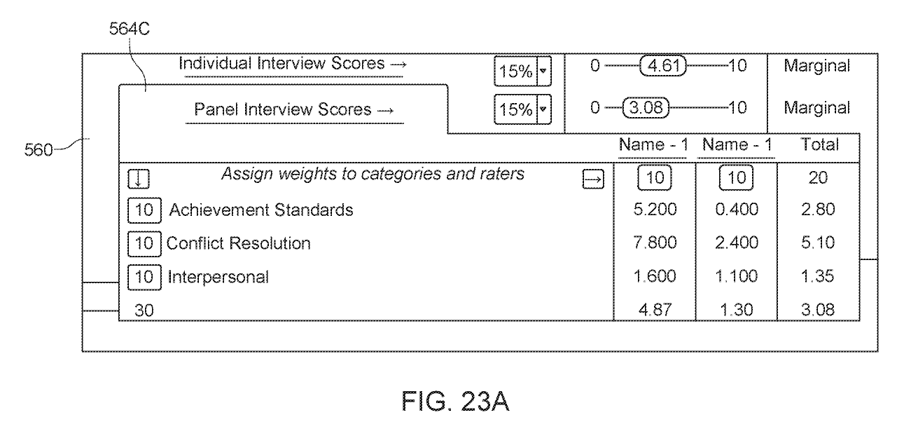

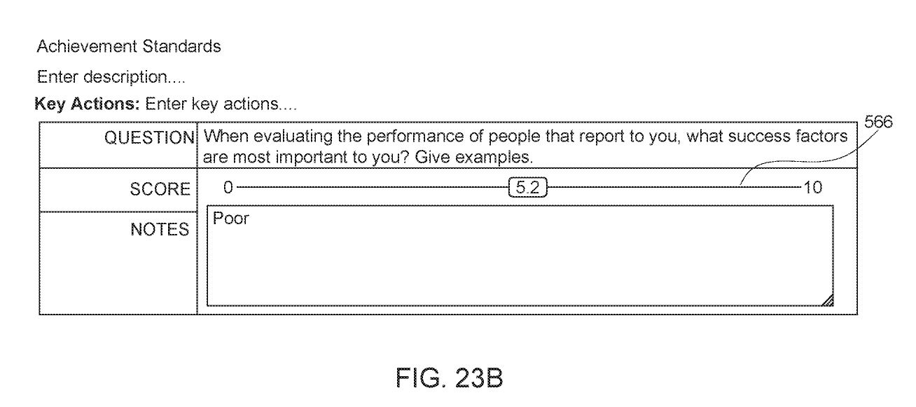

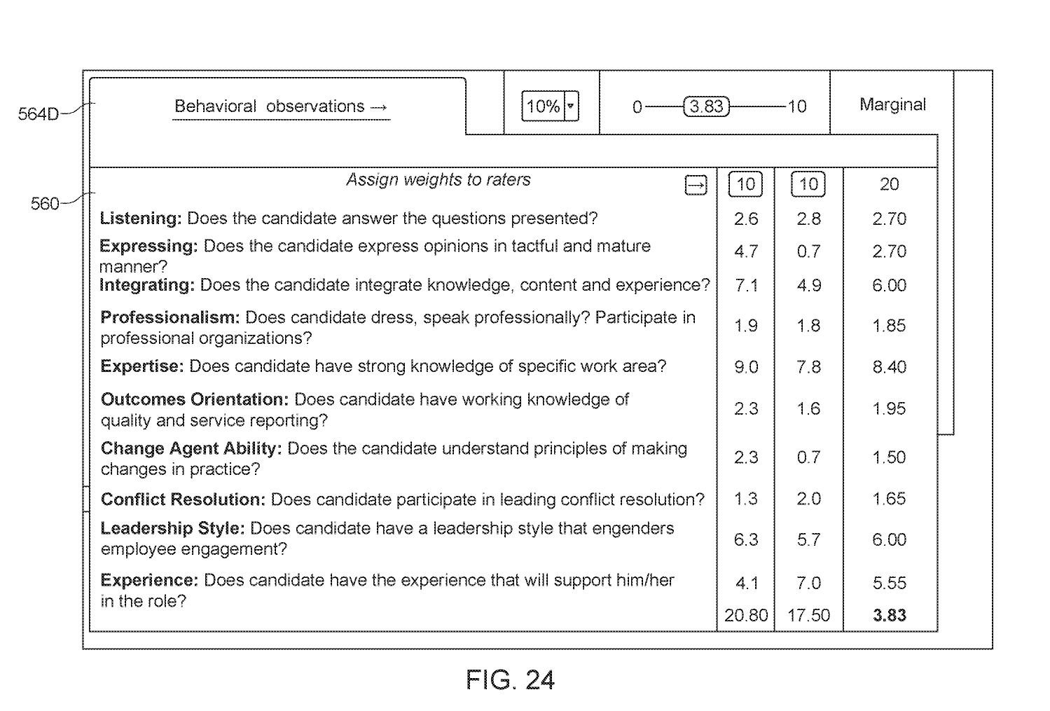

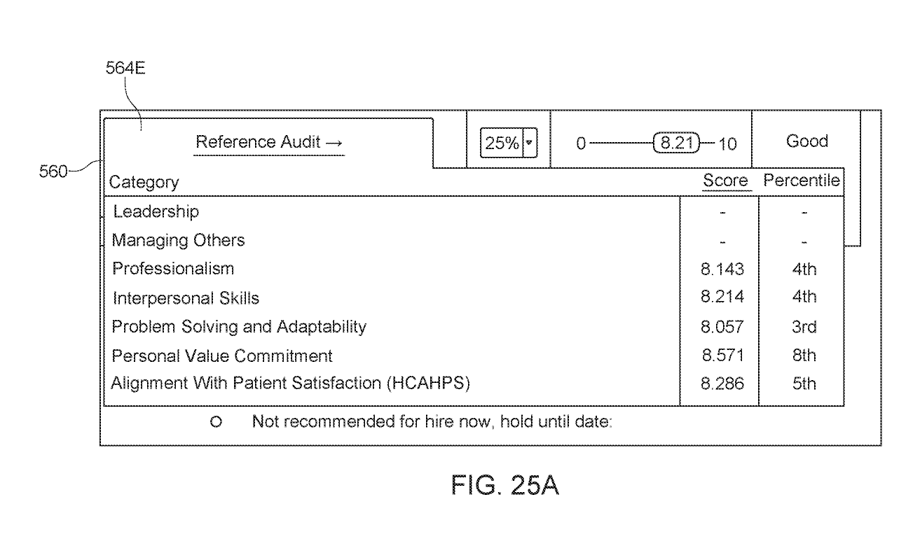

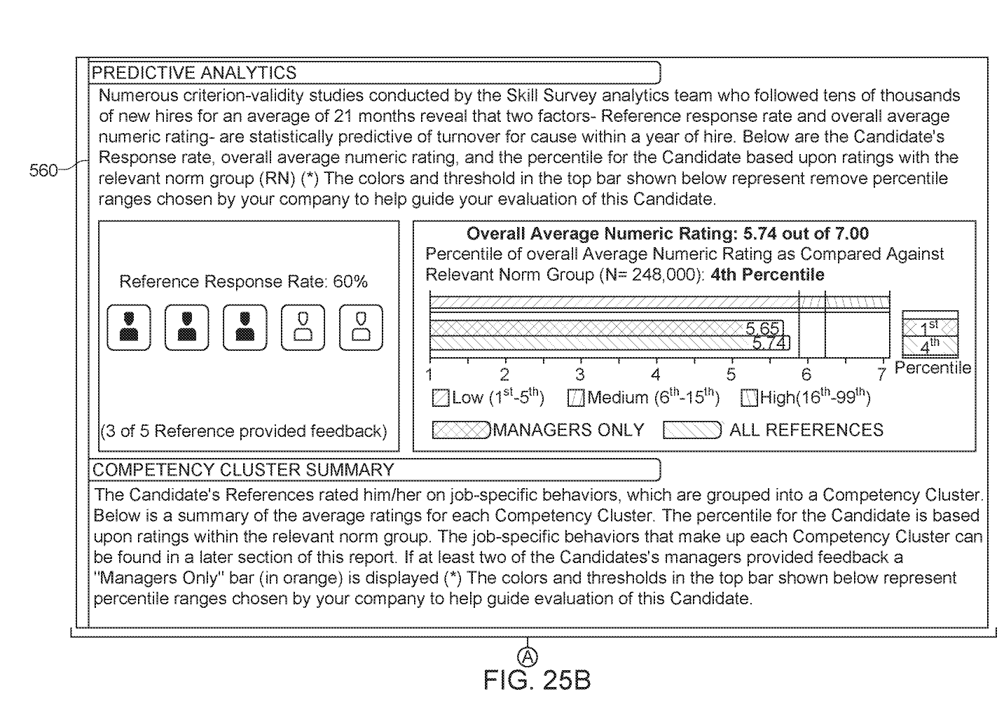

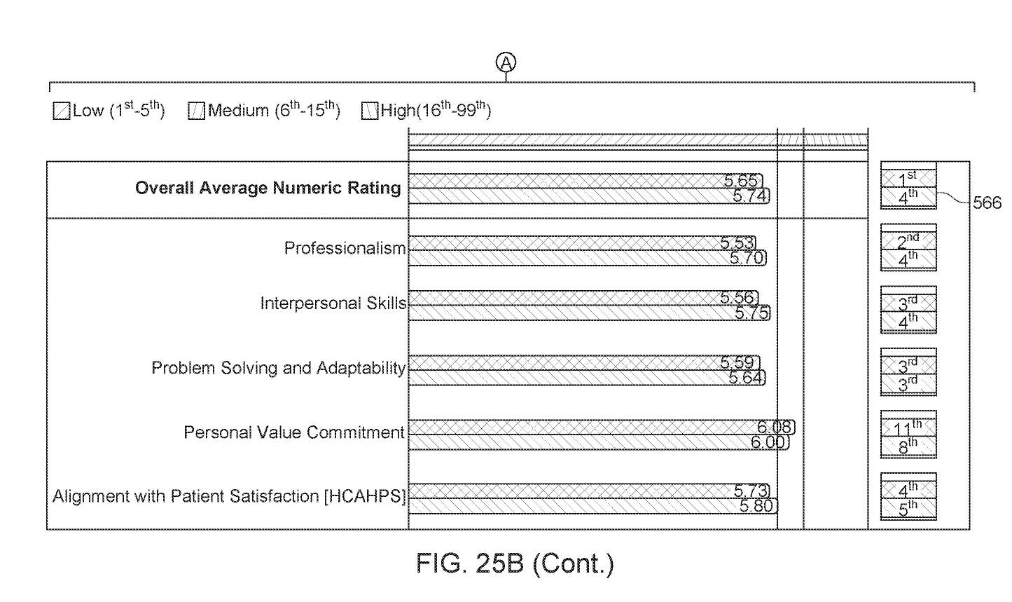

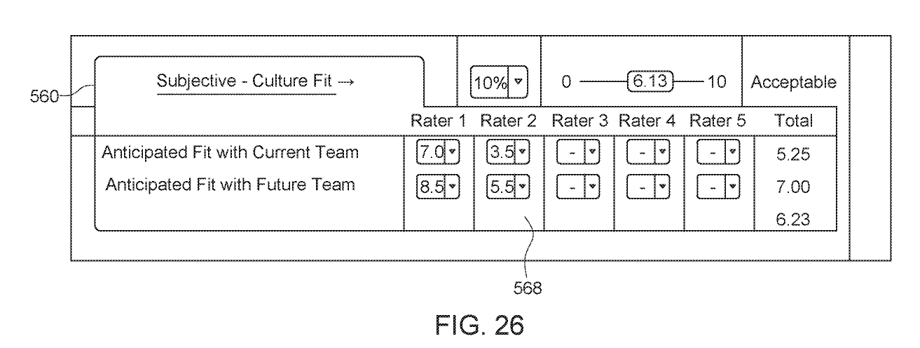

Using the Weighted Decision Algorithm (560) tool, Selection Committee members who have been invited to view the report can “drill in” to view the details of sources of data (564). As shown in FIGS. 22A and 22B, the Selection Committee can view for example Individual Interview scores (564B), assign unique weights to individual Raters, and even “drill in” further to view the scores and comments (566) made by that particular rater on any item. As shown in FIGS. 23A and 23B, the same functionality and customization are available for Panel Interview Scores (564C). As shown in FIG. 24, the same functionality and customization are available for Behavioral Observation Scores (564D). As shown in FIG. 25A and 25B, the same functionality is available for Reference Audit data (564E). Finally, as shown in FIG. 26, the Weighted Decision Algorithm (560) enables Selection Committee members to factor in their Subjective estimates (568) on how well a Candidate is anticipated to meet the needs of the current or future teams.

### Unique Algorithms of Aspire's Post-Employment/Leadership Alignment Functions

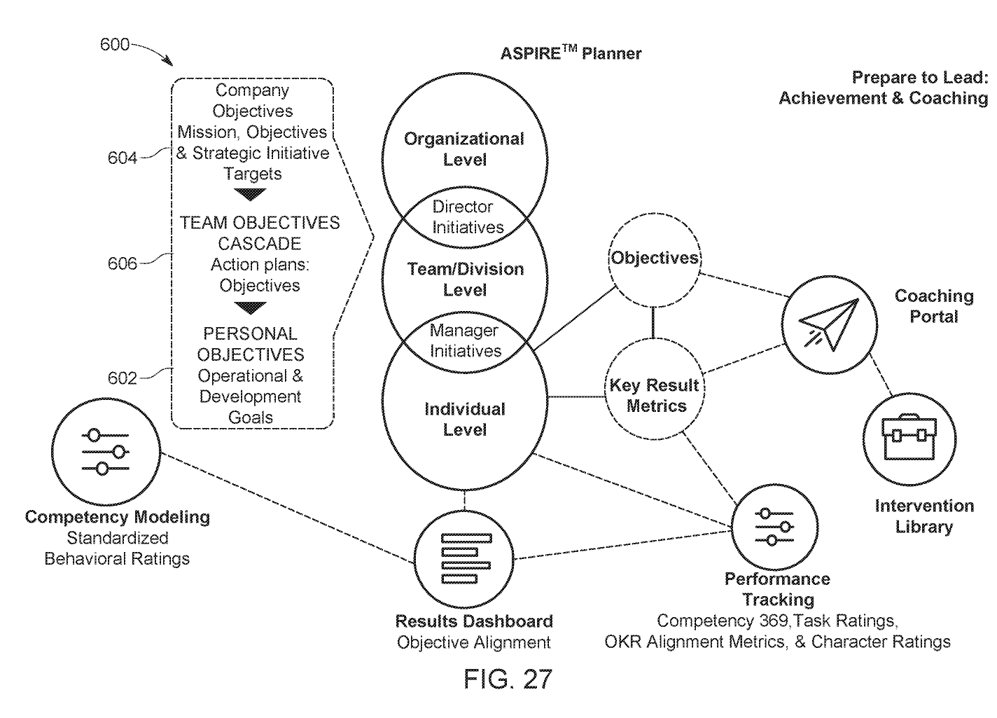

As shown in FIGS. 16 and 27, in the Organizational Post-employment arena, the Aspire Leader Alignment Platform (600), which may be part of certain embodiments of the system and method (10, 20), is a strength-based development platform where employees, managers, team members, and coaches may work with one another to achieve personal and professional objectives (602) that align well with their organization's mission, vision, and strategic plan (604). The Aspire Leadership Alignment Platform allows senior leaders, directors, unit managers, supervisors, individual contributors or line staff, and/or coaches or mentors to translate the organization's vision into meaningful and measurable goals, milestones, action items, and/or timelines. The Aspire Leadership Alignment Platform further allows everyone to be invited to participate and co-create attainable team objectives (606) and personal objectives (602), implement action plans, and/or leverage just-in-time feedback to achieve success, while also strengthening and developing individual character, capacities, and competencies.

C. Differentiating Concepts and Key ideas

An Approach Comparison table between the approach of the Aspire Leadership Alignment Platform (600) of certain embodiments of the system and method (10, 20), and traditional performance management may include the following information:

| Approach | Traditional Performance | Aspire Leadership |
|---|---|---|
| Comparison | Management | Alignment Platform |
| Focus | Leadership Behaviors | Leader |
| Rater Reporting | Periodic Performance Evaluations | Continuous Feedback |
| Methodology | (annual or semi-annual) | Unique sliding rating mechanism with |
| | Likert Rating Scales, often | percentile normal-curve graph display, |
| | resulting in severity, leniency, or | accompanied by descriptive Behaviorally |
| | central tendency bias | Anchored Rating Scales across various |
| | | score registry ranges |
| Identify | Skill deficits, weaknesses, | Strengths, potential, aspirational gaps |
| | short-comings | “What are we capable of?” |
| | “What's wrong with you?” | |
| Response | Reluctantly compliant workforce | Flourishing workforce (engaged, |
| | | resilient, accountable, creative flow |
| Goal | Delegated goal-setting with | Collaborative goal-setting |
| | performance management to | Leader alignment-Congruence |
| | achieve results | Leader identity-Capacity |
| Strategies | Crisis-driven | A proactive and intentional Key |
| | Reduce, eliminate, contain, or | Accountabilities Matrix |
| | control ineffectual/problematic | Alignment accountabilities |
| | leadership behaviors | Development accountabilities |
| | Create/build leadership skills | Competencies/Work Skills |
| | | Character Strengths |
| | | Workstyle patterns |
| Management | Top-Down | Bottom-up |
| Method | Supervisors exercise power or | Managers set objectives, share |
| | authority to deploy extrinsic | ownership of key results through |
| | motivators or punishments | resourcing, recognizing, and using |
| | limited communication | flexible intrinsic motivation |
| | | Transparency |

Traditional performance management approaches frequently focus on leadership behaviors, using periodic (often annual or semi-annual) performance evaluations to identify deficits. In contrast, the focus of the Aspire Leadership Alignment Platform (600) is on leader alignment, drawing on the continuity created when the same Competency Model (CM) is used to hire as well as to develop leaders. The Aspire Leadership Alignment Platform (600) is a tool that helps key leaders to shape an organization's culture, moving it from a chaotic culture toward differentiated integration, which may be characterized by the formation of flexible structures that promote cultures of growth. The Aspire Leadership Alignment Platform (600) invites alignment processes that involve dialectical movements within dynamic relational systems. Principles incorporated in the Aspire Leadership Alignment Platform (600) may include the relationship of parts to a whole, differentiation and integration, movement, evolution, gradation of intensity, balancing ambiguity with clarity, multi-perspectival understanding, moving from chaos to a discrete organization, ground versus figure, solid versus void, directional, fluid, growth, and transformation.

### B. User Environment

If an organization has subscribed to the Aspire Leader Alignment Platform (600) of an embodiment of the system and method (10, 20), when HR Leads or P2C Affiliates create a new User Profile for an organizational employee, the User may elect to invite that employee to participate. The employee will receive an electronic email invitation with a temporary password, forwarded to their company email address, providing access to the Aspire Leader Alignment Platform (600). When responding to the link the employee is taken to a Login page (608) (not shown). When the employee accesses the Aspire Leader Alignment Platform (600), he or she is greeted temporarily with an animated logo splash screen (610) (not shown).

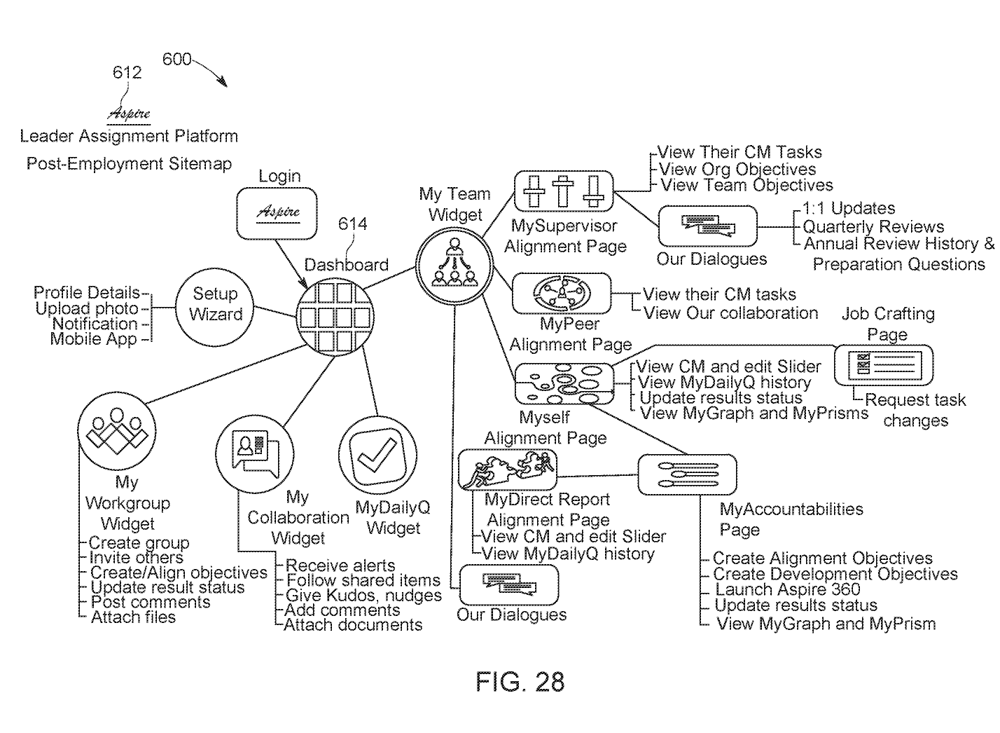

An embodiment of the Aspire Leader Alignment Platform (600) is shown in FIG. 28, in the form of a Post-Employment Sitemap (612). An Intuitive Dashboard (614) may incorporate a permission system within a Company and User Administration Control Panel to customize access permissions to various system users. In this way, an assigned Affiliate User can easily control functions available to Organizational or Individual Users. Organizational Super-Users and HR Leads may be given full access to many functions. Supervisor Users may be given access to screens and functions that enable supervision of multiple employees and Work Group Administration. Employee Users may be given access to the most limited functions and screens.

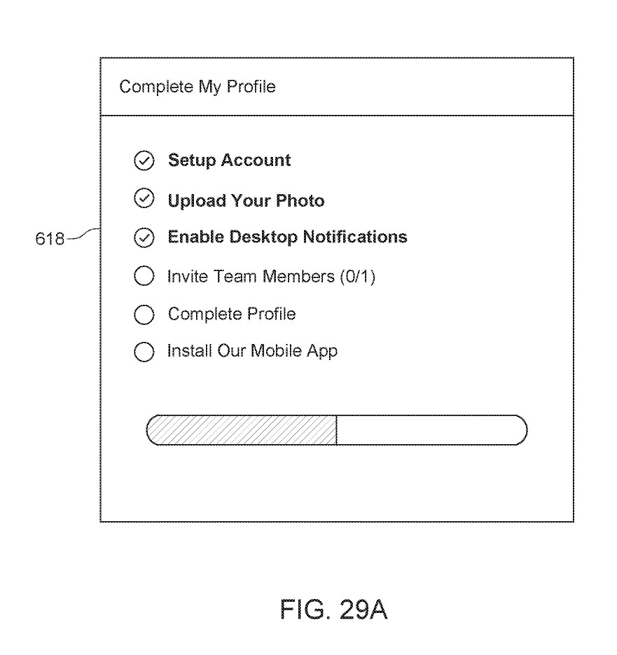

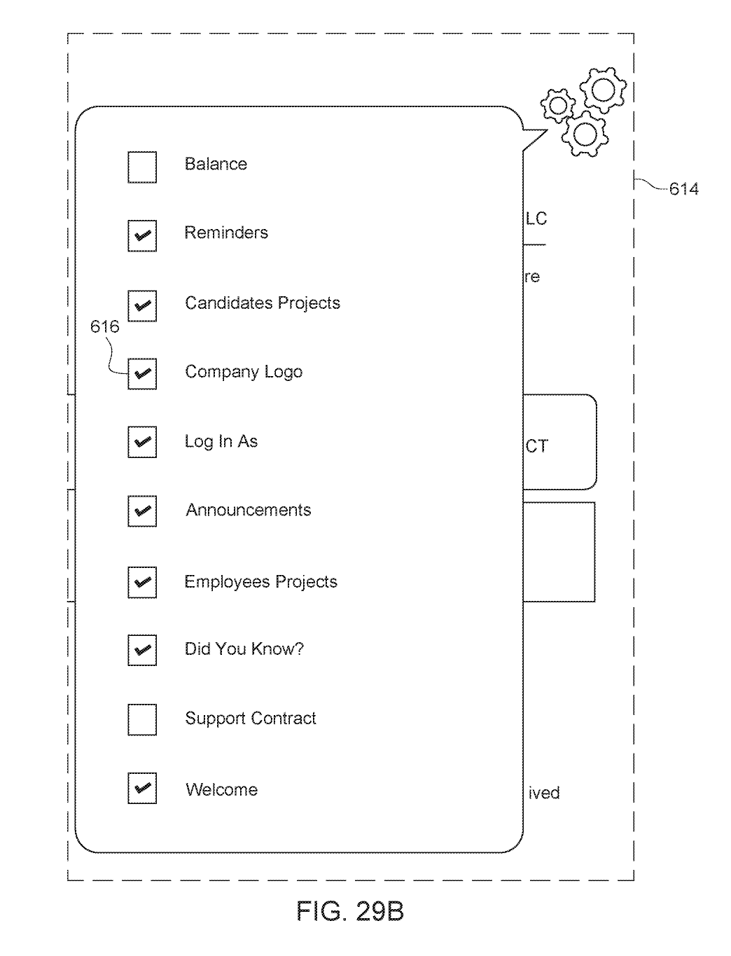

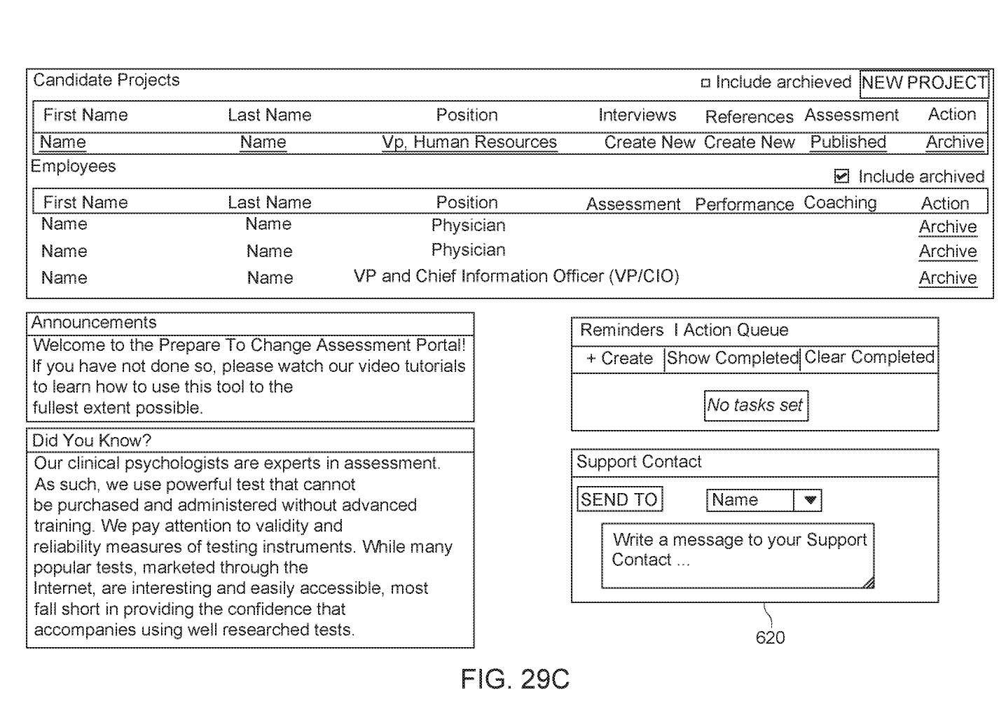

As shown in FIG. 29B, the Intuitive Dashboard (614) may display function boxes (616), called Widgets, which enable Users to gain quick access to frequently used information. Each User type can activate or deactivate Widgets through function boxes (616) displayed on their Intuitive Dashboard (614) through the Setup icon in the upper right-hand corner of the Dashboard display (not shown). As shown in FIG. 29A, a Complete My Profile widget (618) appears on the Intuitive Dashboard (614) of new Users to help them complete their profile. A Setup Account menu guides them through the process of setting up various team preferences. As shown in FIG. 29C, various Pre-Employment Aspire widgets (620) may be available to Super-Users and HR Leads. Various Post-employment widgets may be available to Supervisors and Employees when a company has subscribed to the Aspire Leader Alignment Platform (600). Individuals with access to Post-employment Aspire Leader Alignment Platform (600), therefore, may engage with system activities via intuitive point-and-click navigation.

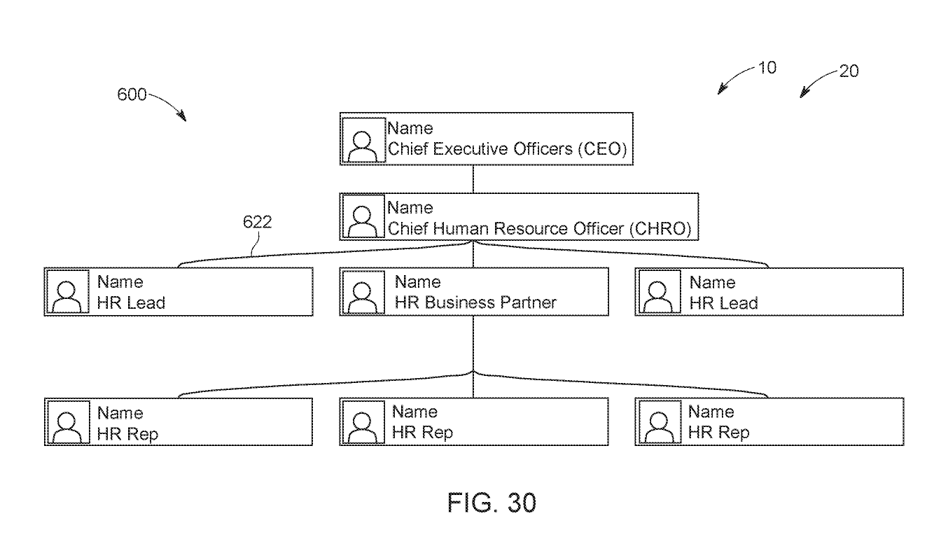

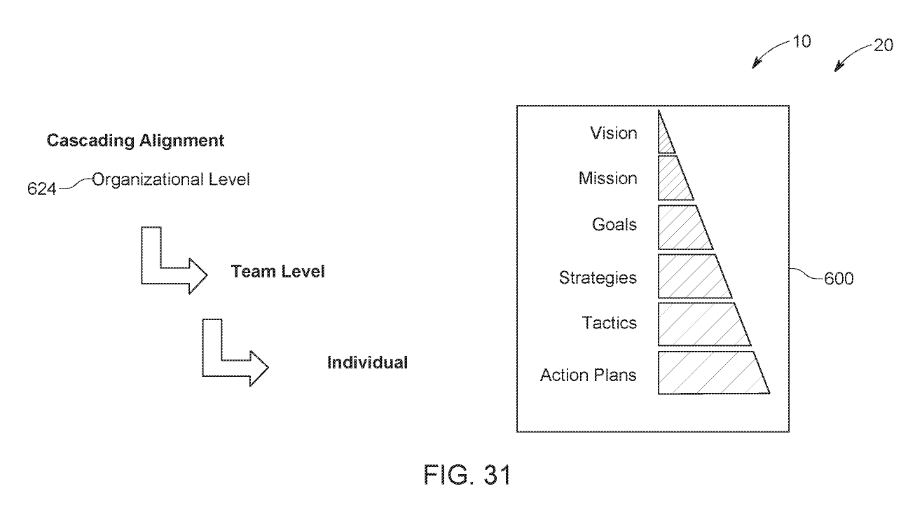

As shown in FIG. 30, embodiments of the Aspire Leader Alignment Platform (600) of the system and method (10, 20) may include a MyTeam Chart Widget (622) that will appear on the Intuitive Dashboard (614), enabling individuals to view themselves within the context of their reporting relationships. They can view their direct Supervisor, Peers, and Direct-Reports, along with all lower levels (if applicable). In the following non-limiting example, the HR Business Partner can drill down to view those who report to him. When the HR Business Partner selects one of the HR Leads' profile, he or she can view his or her peers' Essential Functions or Tasks. When the HR Business Partner selects the Chief Human Resources Officer's (CHRO) profile, he or she may access the My Supervisor Alignment page. The HR Business Partner may further view the CHRO's Essential Functions or Tasks, view Organizational Objectives identified by the CEO, view Team Objectives owned by his Supervisor, and/or view the Dialogues Page. The Dialogues Page may be a collaborative area for supervision and support that documents a history of Weekly Updates, Quarterly Reviews, and/or Annual Reviews relating to the HR Business Partner's own areas of responsibility, and may include dated action items, documentation, and/or answers to selected questions.

When the HR Business Partner selects any of the HR Representatives' profiles, he or she may be allowed to access the Align My Supervisee Page. The Align My Supervisee Page may allow the HR Business Partner to view a finalized Competency Model for each of the HR Representatives' positions, which may include Essential Functions, Position Competencies, Personality Traits, and/or Values, along with assigned weights. The Align My Supervisee Page may further allow the HR Business Partner to do Job Crafting, or request desired changes to their supervisee's position profiles. Job Crafting functionality provided by the Align My Supervisee Page may include a degree of decision-making discretion resulting in changes that reflect how people engage with their roles. The Job Crafting functionality increases autonomy, support, and participation in setting challenging yet personally meaningful boundaries and/or goals due to shifting priorities, workplace activities, and/or responsibilities. Job crafting requests may remain in pending status until approved by Human Resources, which updates the position's CM.

When the HR Business Partner selects any of the HR Representatives' profiles, he or she may further be allowed to view their supervisee's My Accountabilities pages (628) to create new Alignment Objectives, update the status of Alignment Objectives, and/or archive Alignment Objectives. Key Results (632) may be created by the Direct-report and approved by the Supervisor. The HR Business Partner may further view their supervisee's My Accountabilities pages (628) to co-create new Development Objectives with the Objectives Selector. Co-creating new Development Objectives may be accomplished using an Aspire 360 Collapsible Panel by way of which the HR Business Partner may click on the Launch Aspire 360 button and view the status of Aspire 360. Co-creating new Development Objectives may include assigning, editing, and updating Development Objectives based on suggested objectives from the Aspire 360 Objectives Library. Co-creating new Development Objectives may further include requesting coaching support for a specific topic or period, viewing the supervisee's My Graphical Analysis filtering and/or comparing Collapsible Panel, and/or viewing a My Daily Questions History. Co-creating new Development Objectives may further include viewing a Reporting Prism Toggle.

When the HR Business Partner selects his or her MySelf Alignment page, he or she may be able to view the CM and edit slider preferences, request Job Crafting, and/or access the My Accountabilities Action Planner. The My Accountabilities Action Planner may allow the HR Business Partner to view, update the status of, and/or collaborate or comment on Alignment Objectives. The My Accountabilities Action Planner may further allow the HR Business Partner to view, update the status of, and/or collaborate or comment on Leadership Development Objectives. Viewing the Leadership Development Objectives may include viewing My Graphical Analysis, or results from Aspire 360 Activity. The My Graphical Analysis may include Competency, Work Skills, Character Strengths, and/or WorkStyle. The Leadership Development Objectives may include Competency Objectives, Character Strength Objectives, and/or WorkStyle Objectives. The My Accountabilities Action Planner may further allow the HR Business Partner to create and update the status on Confidential Objectives, to view My Prism reporting results, and/or to view My DailyQ's history.

Embodiments of the Aspire Leader Alignment Platform (600) of the system and method (10, 20) may provide a My WorkGroups widget that enables supervisors to create and manage WorkGroups from their Intuitive Dashboard. Using the WorkGroup widget, a Supervisor may be allowed to create a WorkGroup, invite any employee in the company to a WorkGroup, create new objectives, align new objectives with Organizational Objectives, update the status of WorkGroup results, and/or send, receive, and/or view discussions and documents, agendas, or notes. Embodiments of the Aspire Leader Alignment Platform (600) may further provide a My Collaboration widget that enables Supervisors and Employees to view and respond to others who have shared their specific My Accountabilities objectives or My DailyQ's results. When others have requested feedback, a notification message may appear in a notification box on the MyCollaboration widget (706). The My DailyQ's widget (704) may enable any employee to interact with leader development action items that he or she created to achieve.

### C. Presentation of Core Functional Areas of the Aspire Leader Alignment Platform

### The Action Planner Customizable Key Accountability Matrix

Embodiments of the My Accountabilities Action Planner of the Aspire Leader Alignment Platform (600) of the system and method (10, 20) may translate the strategic and operational goals of an organization into alignment initiatives that are cascaded throughout the organization to teams, individuals, and work-groups. The My Accountabilities Action Planner may seamlessly combine collaborative goal-setting activities with performance tracking mechanisms to align leaders with desired outcomes. The My Accountabilities Action Planner may identify, define, and/or implement Objectives and Key Results (632) (OKRs), and/or may measure the degree that the organization accomplishes those goals through individual contributors, leaders, and/or teams, using objectively validated feedback sources. The objectively validated feedback sources may include Solicited Feedback, which may include Weighted, Behaviorally Anchored Rating 360's and/or Pulse Surveys, Unsolicited Feedback, which may include Documented Observations of Others, Document Review Metrics from outside reporting firms, and/or Direct Observations.

Embodiments of the My Accountabilities Action Planner of the Aspire Leader Alignment Platform (600) of the system and method (10, 20) may utilize objectives, or Action items that the organization launches, which are described with specific language. Embodiments of the My Accountabilities Action Planner of the Aspire Leader Alignment Platform (600) may further utilize Key Results (632), which may be used to measure goal achievement as well as alignment with intended goals. The Aspire Leader Alignment Platform (600) implements several best-practice recommendations relating to Key Results (632). For non-limiting example, the. Aspire. Leader Alignment Platform (600) may implement objectives having three to five Key Results (632). The three to five Key Results (632) may always be measurable. Quantifiable Key Results (632) may have specifically stated measurement metrics, such as numbers, dollars, or percentage, which may objectively be measured. Qualitative Key Results (632) may be measured in terms of Percentage Complete. For another non-limiting example, the Aspire Leader Alignment Platform (600) may implement objectives having Key Results (632) that may be created 30% top-down, or identified and/or recommended by an employee's Supervisor, and 70% bottom-up, or identified and/or recommended by the supervisor's Employee. The Aspire Leader Alignment Platform (600) may implement frequent, yet brief, one-on-one meetings throughout the quarter to facilitate course-corrections as the leader progresses toward his or her goals. The Aspire Leader Alignment Platform (600) may further implement objectives that refer to specific Key Results (632) outcomes and are results focused, rather than activity focused, using quarterly timelines. The Aspire Leader Alignment Platform (600) may further implement Key Results (632) that enable objectives to be measured in terms of range of alignment, such as Threshold, Target, and Stretch ranges.

Within the Aspire Leader Alignment Platform (600) of the system and method (10, 20), there may be two primary types of objectives: Leader Alignment Objectives (626) and Leader Development Objectives (634). Leader Alignment Objectives (626) may translate the strategic and operational goals of an organization into alignment Initiatives, which may then be cascaded to teams, individuals, and/or work-groups. Formally stated Leader Alignment Objectives (626) and their closely associated Key Results (632) may become the ways and means of advancing the organization's business agenda. Leader Alignment Objectives (626) may be derived from Organizational Goals or Strategic Initiatives set by the organization's executive leadership. Organizational Goals may normally be accomplished within the upcoming twelve-month period. Strategic initiatives may reflect multi-year strategies deployed to achieve the organization's long-term strategic plan. To maximize achievement of Leader Alignment Objectives (626), the Aspire Leader Alignment Platform (600) may implement no more than three to five Leader Alignment Objectives (626) to be targeted by a leader during any quarterly period.

As shown in FIG. 31, the Aspire Leader Alignment Platform (600) of the system and method (10, 20) may utilize a Cascading Alignment (624) across three levels to produce integrated alignment throughout the organization. Cascading Alignment (624) translates the organization's Mission and Vision into specific and attainable goals, tied to measurable results, outcomes, and/or time-lines. Leader Alignment Objectives (626) are created within the Aspire Leader Alignment Platform (600), First, using his or her assigned Login and Password, the. Supervisor enters the Aspire Leader Alignment Platform (600) and sees the welcome screen and the subsequent Intuitive Dashboard (614). As illustrated in FIG. 30, he or she will select the Direct-report for whom he or she wishes to create a Leader Alignment Objective (626).

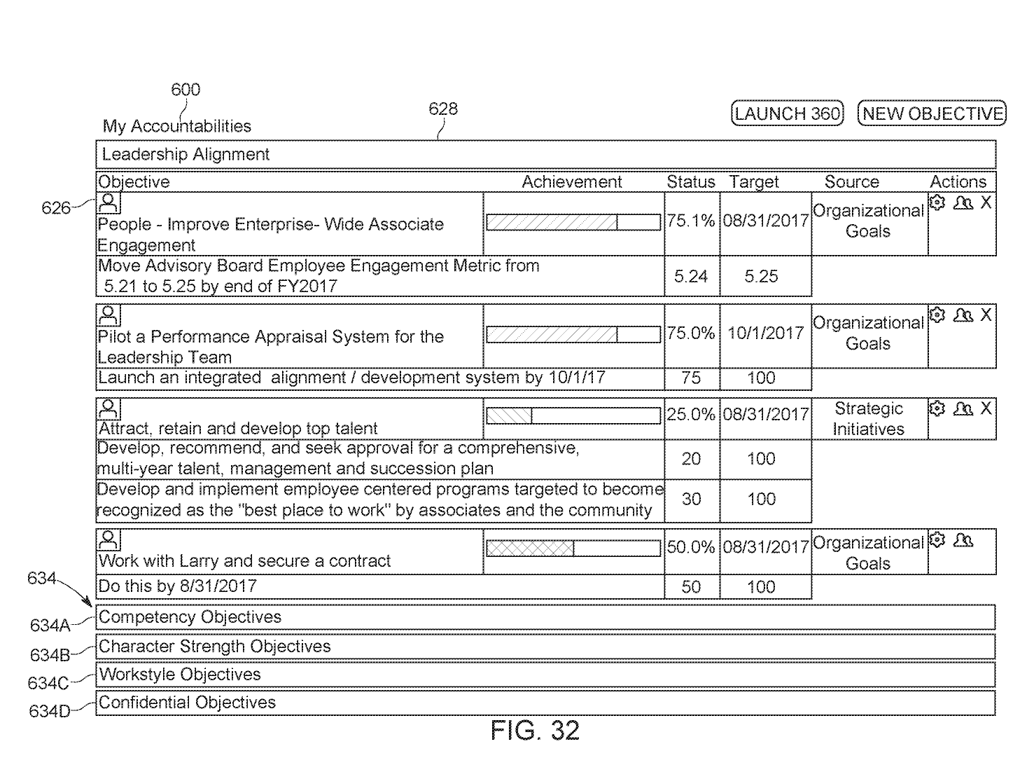

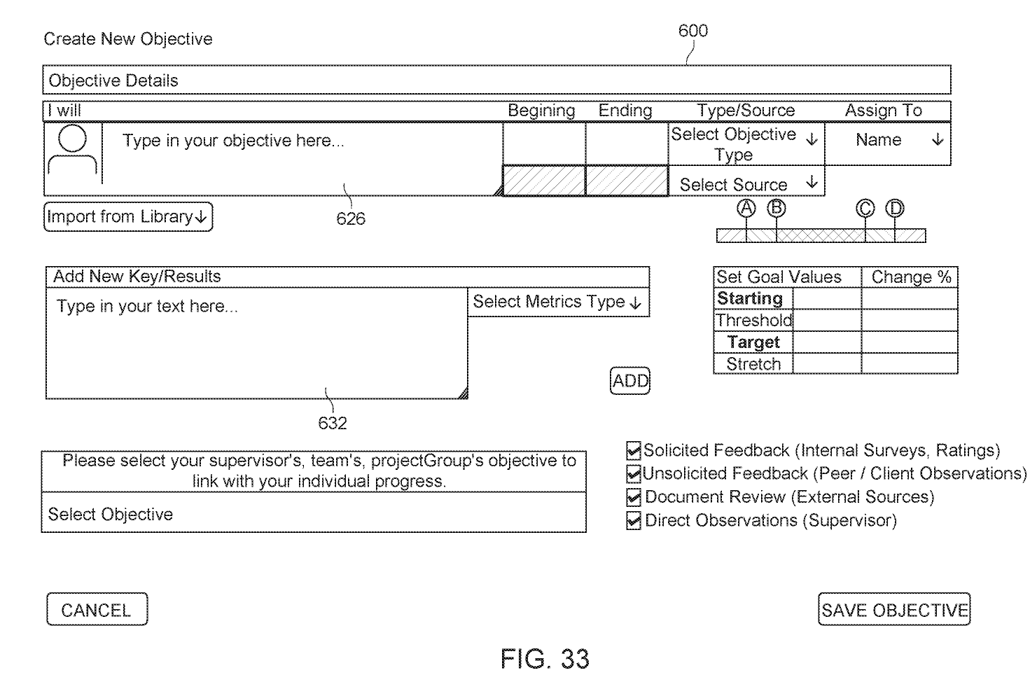

As shown in FIG. 32, the My Accountabilities page (628) appears, showing current Leader Alignment Objectives (626). If new Leader Alignment Objectives (626) need to be created, the Supervisor can create new Leader Alignment Objectives (626) or gather multi-rater feedback to create the Leader Development Objectives (634). Collapsible panels (630) allow the User to quickly view desired information, enter status updates, edit objectives or results criteria, or invite others to collaborate. As shown in FIG. 33, new Leader Alignment Objectives (626) and accompanying Key Results (632) are entered directly into the Aspire Leader Alignment Platform (600), allowing for precision. The Aspire Leader Alignment Platform (600) may include a library of commonly used Key Results (632) to help users build their Leader Alignment Objectives (626) quickly. Leader Alignment Objectives (626) may be linked to other objectives to allow Supervisors to view current status updates for Direct-reports.

Leader Development Objectives (634) within the Aspire Leader Alignment Platform (600) of the system and method (10, 20) may focus on Competencies, such as Behaviors, and/or Capacities, such as Traits and/or Values, of the leader. This focus produces greater leader alignment, rather than merely leadership skill, style, behaviors, or performance, in order to leverage shared and resonant values throughout the organization. These shared and resonant values fundamentally drive the organizational culture DNA and core identity. Leader Development Objectives (634) may be differentiated into three strength-based types, including Competency Objectives (634A), Character Strength Objectives (634B), and WorkStyle Objectives (634C). The Aspire Leader Alignment Platform (600) may measure progress toward these objectives using the Aspire 360 rating instrument, discussed hereinafter. The Aspire 360 rating instrument may measure a leader's baseline strengths and gaps, and then translate those findings into specific actionable Leader Development Objectives (634).

Therefore, in the same way that Leader Alignment Objectives (626) attach Key Results (632) to measure alignment, Aspire's Leader Development Objectives (634) may be collaboratively created with collaborative Key Results (632) to measure alignment of Competency, such as WorkSkill (640), Culture, such as Personality Traits, Values, and/or Character Strength, and/or Behavior Pattern, such as WorkStyle. As noted previously, the Aspire Leader Alignment Platform (600) may implement no more than three Leader Alignment Objectives (626).

### Aspire 360 Feedback Tools

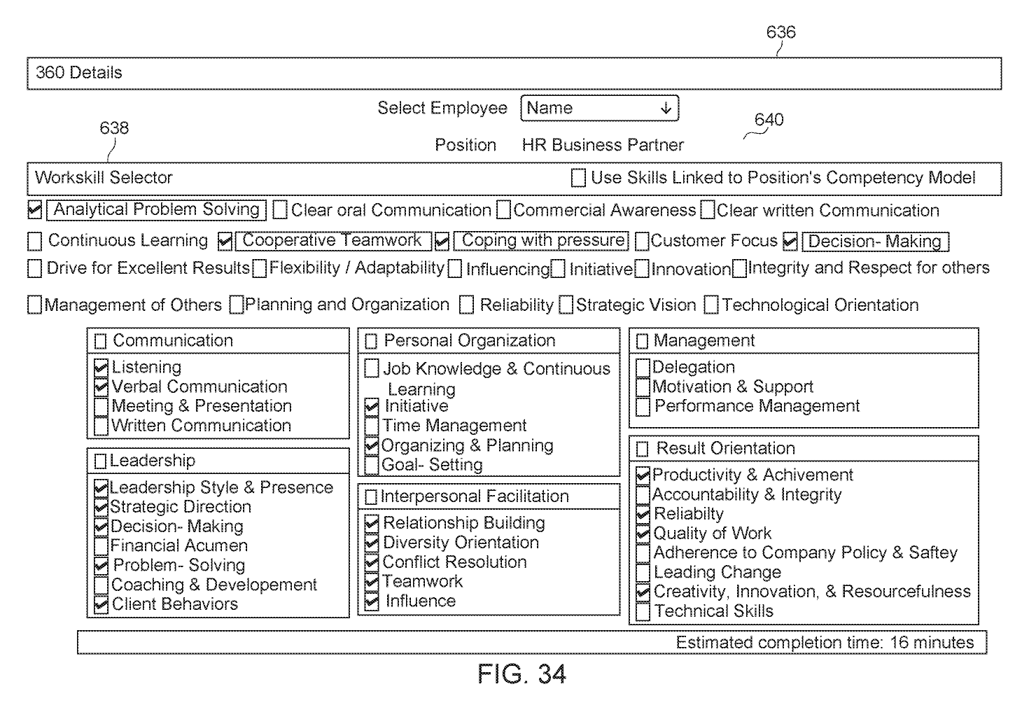

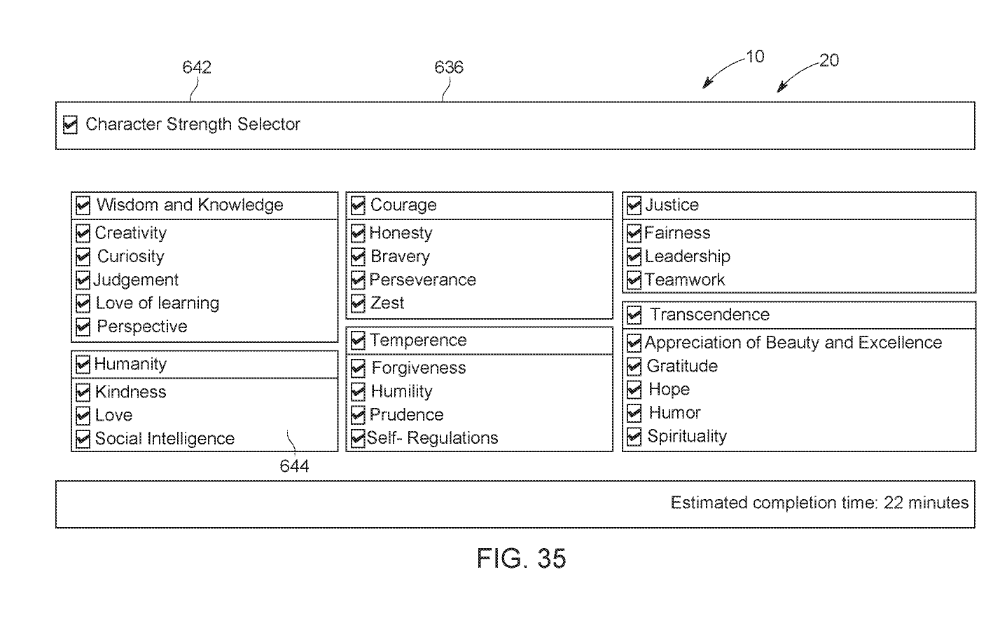

The Aspire 360 Feedback tools (636) of the system and method (10, 20) enable supervisors and employees to use the “wisdom of the crowd” to gather vital information about how other people experience the employee at work. This survey is a multi-rater instrument with several unique tools and features. As shown in FIG. 34, the Aspire 360 WorkSkill Selector tool (638) enables users to gather feedback with precision. A supervisor may choose to gather information about all WorkSkills (640), selected WorkSkills (640), and/or only those WorkSkills (640) that have been mapped to the specific competencies of their Direct-Report's position. As shown in FIG. 35, the Aspire 360 Character Strength Selector tool (642) enables users to gather feedback that enable them to draw inferences about an individual's virtues and values-drivers (644).

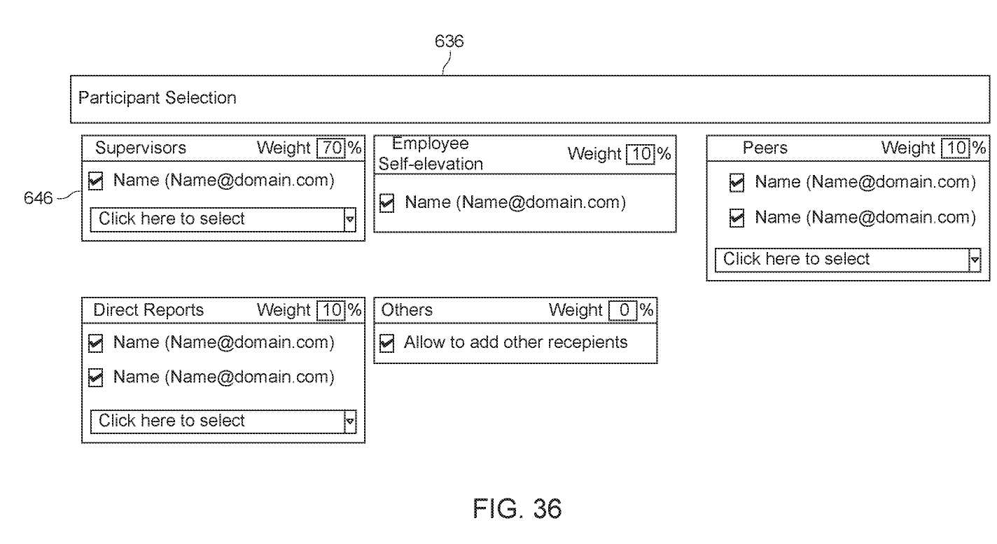

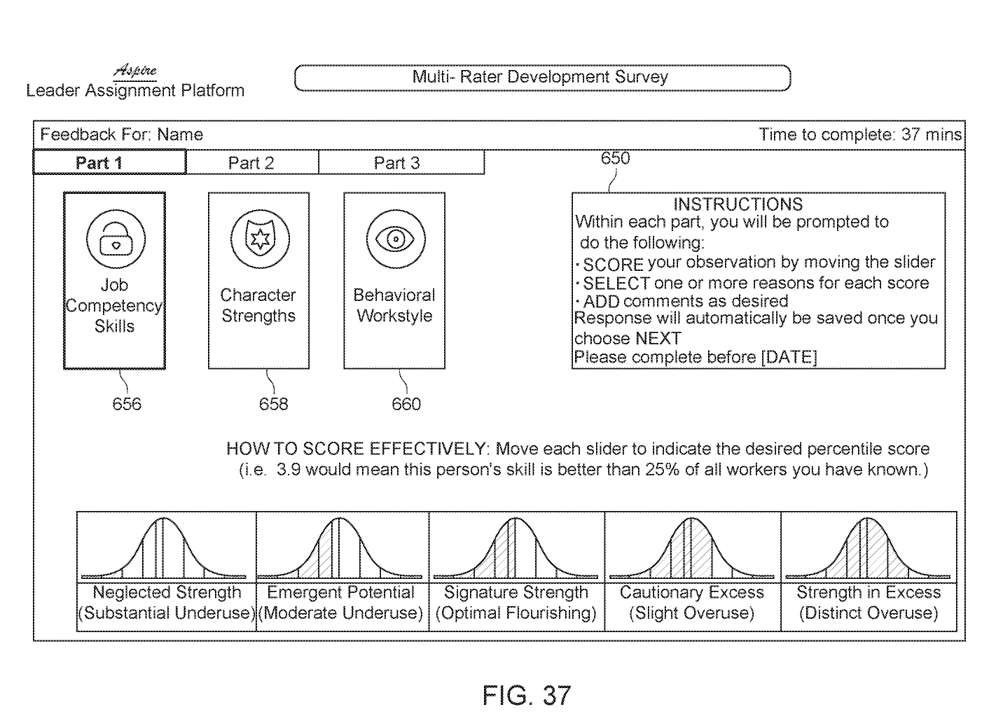

As shown in FIG. 36, the Aspire 360 Feedback tools (636) enable the user to specify individualized weighted scores for various rater categories (646). Additionally, individuals outside of the company, such as an executive coach and/or past supervisors, may be invited to provide feedback. Their perspectives may be factored into or excluded from reporting calculations. When a user launches the Aspire 360 survey, invitations (648) (not shown) are sent to each designated rater. An example email might appear as follows:

Hello, Name

Company has contracted with us to initiate a strength-based development program for Name.

Part of this process includes gathering perspectives from others about how this individual is experienced in the workplace. Accordingly, you are invited to participate in a multi-rater 360 survey. Your perceptions will be kept completely confidential. When combined with the opinions of others, your thoughts will help provide this individual with a comprehensive understanding of ways to become even more effective. Additionally, this information will become part Name's Performance Review process.

To complete the confidential questionnaire, please set aside a few minutes and select the link. below:

«link»

Thank you for your participation in this 360 degree evaluation.

If you have any questions about this process, please feel free to contact either the employee or myself.

Name

Name@domain.com

The invitation (648) may be accompanied by specifically tailored instructions (650), which might appear as follows:

Hello, Name

You have been invited to participate in a multi-rater feedback process. As a participant, you will register your perceptions and also receive information from those with whom you work on a wide range of specific competency skills, strengths, and workstyle characteristics related to your role at Company.

If this 360 was initiated by your supervisor, you will receive feedback based on observations from the following individuals

Yourself: Name

Supervisors: Name

Peers/Colleagues: Name

Direct Reports: Name

Data will be collected from others, electronically stored in a database, compiled and pooled to preserve confidentiality of Peers and Direct Reports, analyzed, and organized in an easy-to-understand format. The results will be made available for you to review and discuss together with your supervisor via the DIALOGUE tab. From there, you can select and prioritize specific objectives to incorporate into your ACTION PLAN. All Supervisors, Peers, Direct Reports, or selected Followers may provide additional feedback on these and other targeted objectives you elect to share with them through Observations or Just-In-Time Pulse Surveys initiated to recognize your progress.

You will need to set aside approximately 30-40 minutes to register your initial perceptions.

RESEARCH CONTENT

You are participating in a multi-rater feedback process through Company. In this process, you and your selected respondents will provide information about your skills, experiences, and other characteristics, and you will receive a report of your results. As a normal part of the process, Company, further analyzes all participant results in order to improve the feedback tool, validate pre-employment assessments, and increase the usefulness of the results for future participants through an on-going research process.

When data is analyzed for research purposes, all participants and their individual results remain completely anonymous and confidential at all times. This is a secured website, which means that any data transferred to or from this site is encrypted to ensure confidentiality. If you experience difficulties using the website, please contact Name at Company, at (xxx) xxx-xxxx or email questions to Name@domain.com.

□ I agree to allow Company to use my feedback results for research purposes as described above. I am aware that my confidentiality and anonymity will be protected at all times.

□ I do not agree to allow my feedback results to be used for research BEGIN

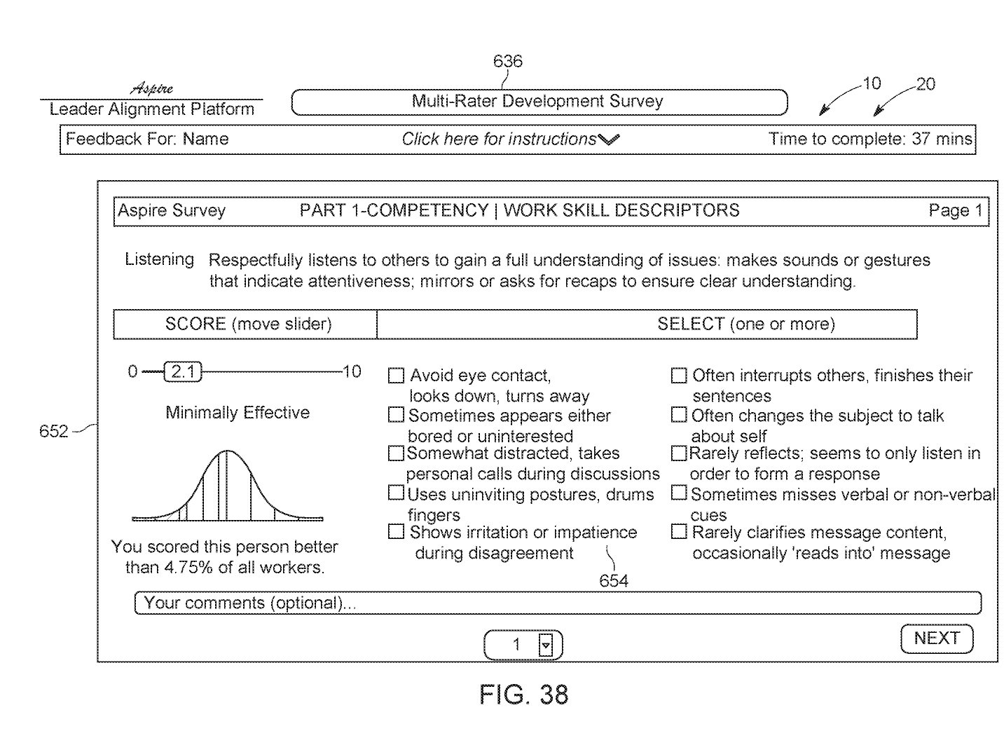

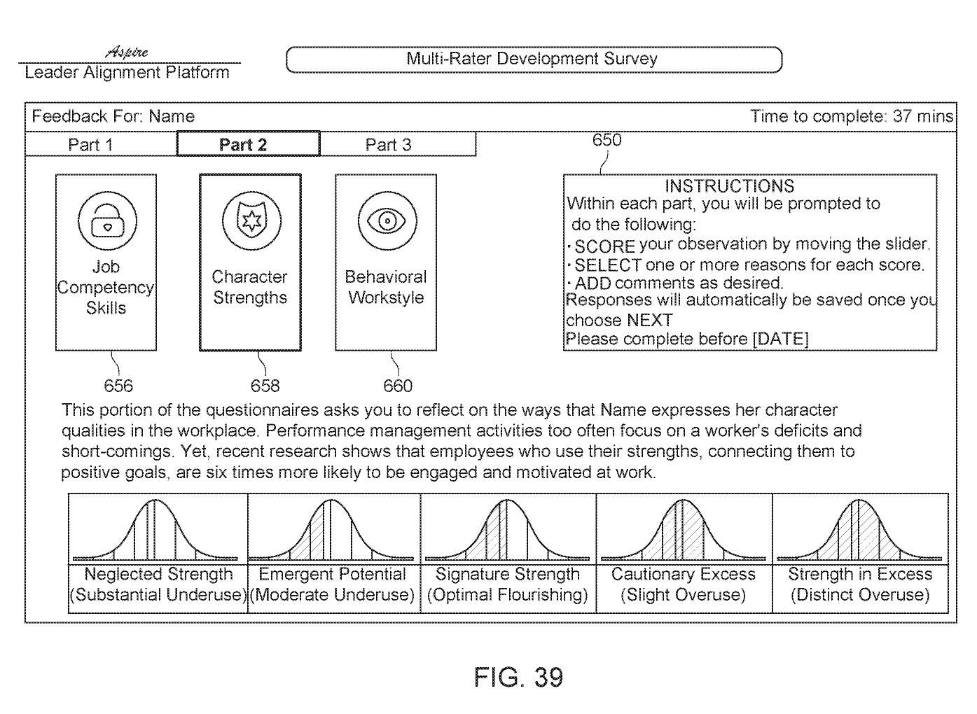

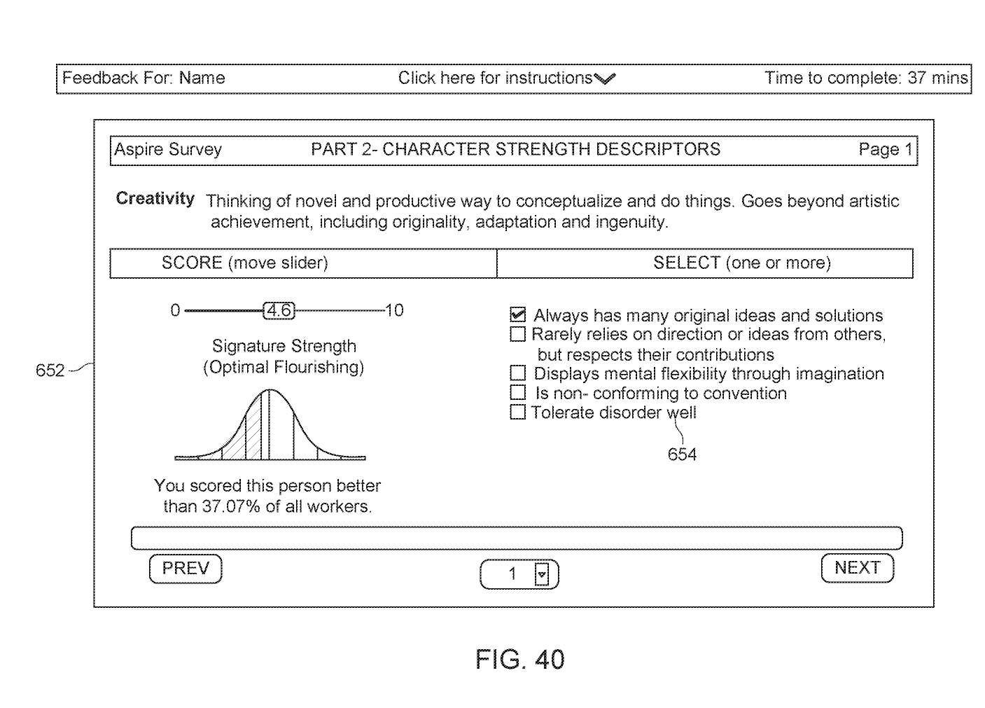

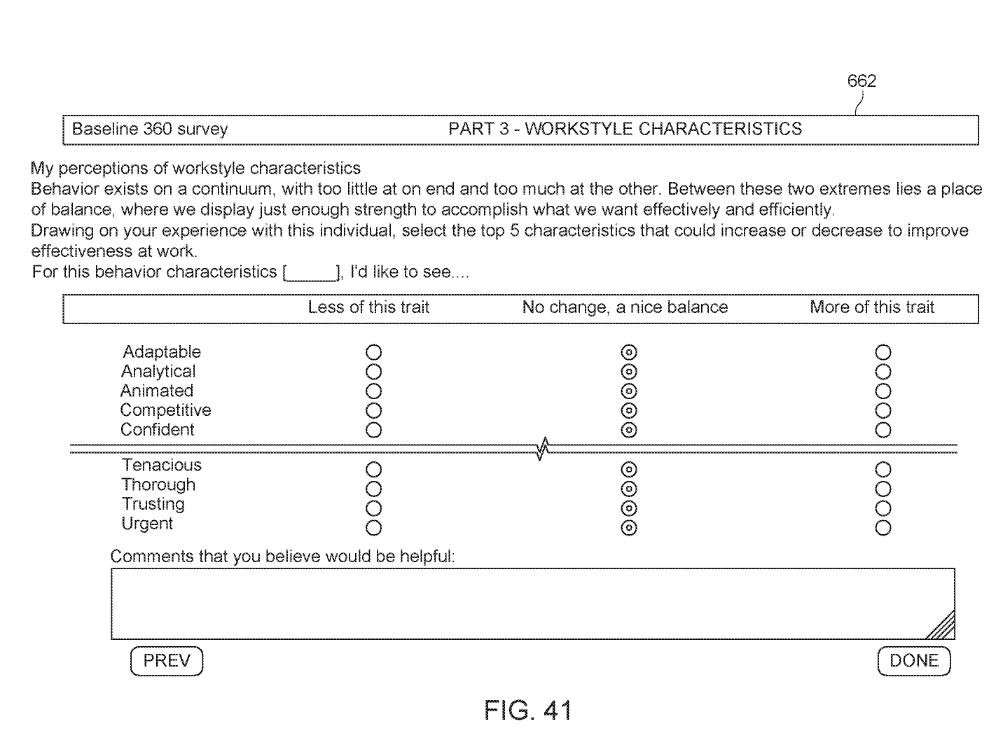

As shown in FIG. 38, the Aspire 360 Feedback tools (636) of the system and method (10, 20) may use a forming slider scoring mechanism (652) to reduce rater bias. As shown in FIG. 38, the Aspire 360 Feedback tools (636) use behaviorally anchored WorkSkill and Character Strength descriptors (654), rather than Likert scale descriptors, when Job Competency Skills (656) are selected, in order to more accurately measure perceptions and alignment, Character Strengths (658) are measured using a different slider scale, the Multi-Rater Development Survey using instead a Character Strength norming slider scoring mechanism (652), as shown in FIGS. 39 and 40. Behavioral WorkStyles (660) are measured by asking raters to select no more than five behaviors, using an Effectiveness Improvement tool (662), which could be increased or decreased to improve the employee's effectiveness in their role, as shown in FIG. 41. The behaviors may be chosen from, as a non-limiting example, adaptable, analytical, animated, competitive, confident, considerate, cooperative, detail-oriented, directing, economical, empathetic, enthusiastic, experimental, factual, flexible, forceful, helpful, idealistic, inspiring, loyal, methodical, modest, negotiating, persistent, persuasive, practical, quick to act, receptive, reserved, responsive, risk-taking, seek change, seek excellence, sociable, steadfast, tactful, tenacious, thorough, trusting, and/or urgent. Because precise parameters are enabled in the Selector tools (638, 642), users can easily administer brief Pulse Surveys to gather continuous and/or just-in-time performance feedback regarding the effectiveness of an individual's development, performance, and/or alignment.

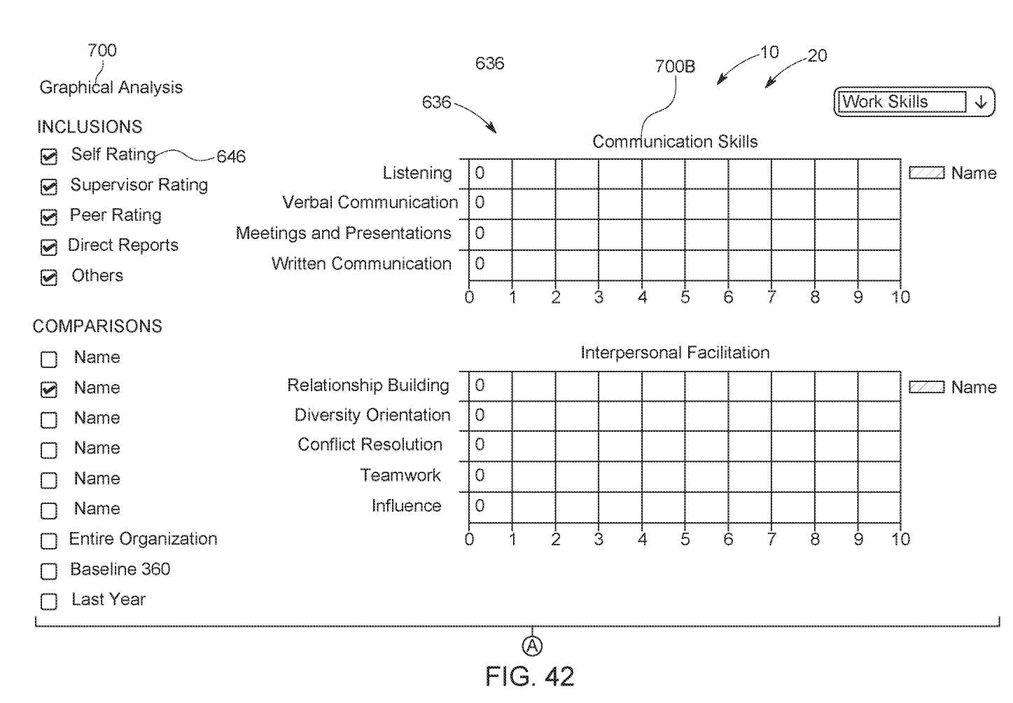

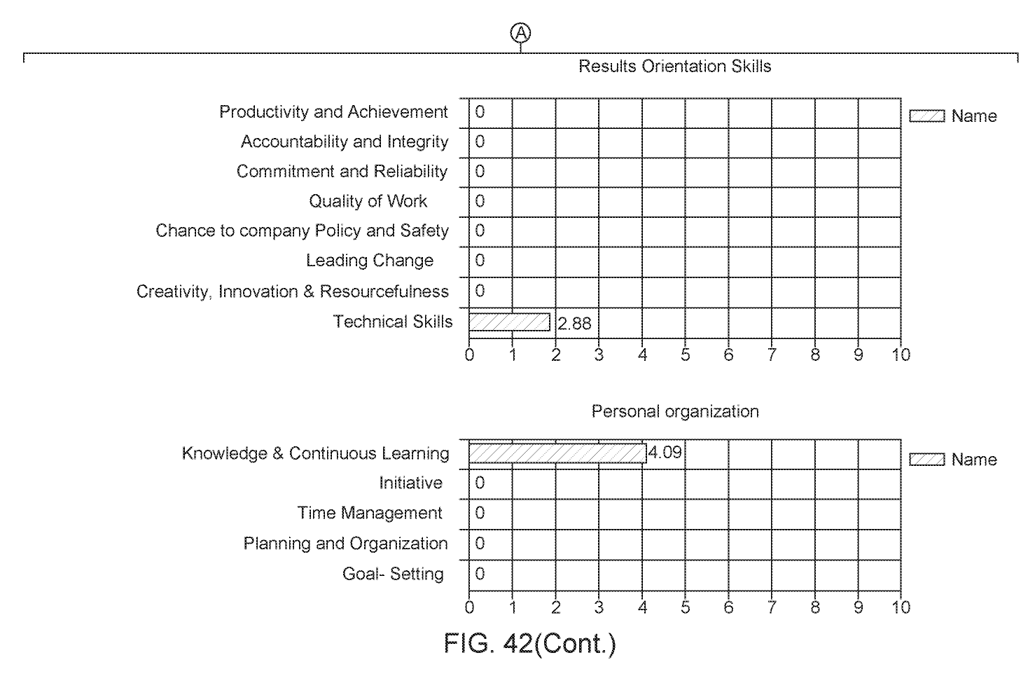

As shown in FIG. 42, the Aspire 360 Feedback tools (636) of the system and method (10, 20) may further include a Graphical Analysis Tool (700). The Graphical Analysis Tool (700) allows the Supervisor to include or excluded different rater categories (646) to isolate trends. The Graphical Analysis Tool (700) also allows the Supervisor to compare one individual with others on his or her team. As shown in FIG. 42, for continuous performance evaluation, the WorkSkill Analysis graphs (700B) allow the supervisor to identify specific skill strengths and deficits. In the example shown in FIG. 42, the communication skills graph includes listening, verbal communication, meetings and presentations, and written communications. The interpersonal facilitation graph includes relationship building, diversity orientation, conflict resolution, teamwork, and influence. The results orientation skills graph includes productivity and achievement, accountability and integrity, commitment and reliability, quality of work, company policy and safety, leading change, innovation and resourcefulness, and technical skills. The personal organization graph includes knowledge and continuous learning, initiative, time management, planning and organization, and goal-setting.

A similar Competency Skills analysis graph (700A) (not shown), having the same format, provides the Supervisor with snapshot of their employee's performance across the competencies related to their position. The competencies of the Competency Skills analysis graph (700A) include decision-making, drive for excellent results, flexibility/adaptability, influencing, initiative, innovation, integrity and respect for others, management of others, planning and organization, reliability, analytical problem solving, strategic vision, technological orientation, clear oral communication, clear written communication, commercial awareness, continuous learning, cooperative teamwork, coping with pressure, and customer focus. A similar Character Strengths graph (700C) (not shown), having the same format, enables the Supervisor to affirm and encourage desired character strengths. The Character Strengths graph includes Wisdom and Knowledge, or creativity, curiosity, judgment, love of learning, and perspective, Courage, or honesty, bravery, perseverance, and zest, Humanity, or kindness, love, and social intelligence, Justice, or fairness, leadership, and teamwork, Temperance, or forgiveness, humility, prudence, and self-regulation, and Transcendence, or appreciation of beauty and excellence, gratitude, hope, humor, and spirituality.

The Aspire 360 Feedback tools (636) of the system and method (10, 20) may further incorporate an Objective Selector (702) (not shown), which may appear as follows:

Objective Selector

| | | | | | | Suggested |
|---|---|---|---|---|---|---|
| | | | | | Behavioral | Competency |
| Select | Action | Arena | Descriptor | Freq | Description | Objectives |
| X | Recognized | Results | Commitment | 8 | Anticipates needs, is | Added to Review |
| | this Skill | Orientation | & Reliability | | attentive to potential | Items |
| | | | | | problems or | |
| | | | | | demands. | |
| X | Recognized | Results | Commitment | 8 | Is typically visible and | Added to Review |
| | this Skill | Orientation | & Reliability | | available when | Items |
| | | | | | needed to help | |
| X | Grow this | Communication | Listening | 8 | Rarely reflects; | Increased |
| | skill | | | | seems only to listen | frequency of |
| | | | | | in order to form a | paraphrasing and |
| | | | | | response | summarizing as |
| | | | | | | well as listening |
| | | | | | | for implied words |
| | Grow this | Communication | Listening | 5 | Frequently shows | |
| | skill | | | | closed body | |
| | | | | | language, drums | |
| | | | | | fingers | |
| | Grow this | Communication | Listening | 5 | Somewhat | |
| | skill | | | | distracted, takes | |
| | | | | | personal calls during | |
| | | | | | discussions | |
| | Grow this | Communication | Listening | 5 | Uses uninviting | |
| | skill | | | | posture and drums | |
| | | | | | fingers | |
| X | Grow this | Meetings and | Meetings and | 8 | Meetings stretch on, | Schedule regular |
| | skill | Presentations | Presentations | | unproductive and | meetings, timed |
| | | | | | lack of engagement | appropriately with |
| | | | | | | sufficient length |
| | | | | | | to cover topic |
| | Grow this | Meetings and | Meetings and | 6 | Inadequate summary | |
| | skill | Presentations | Presentations | | of key issues, without | |
| | | | | | direction | |

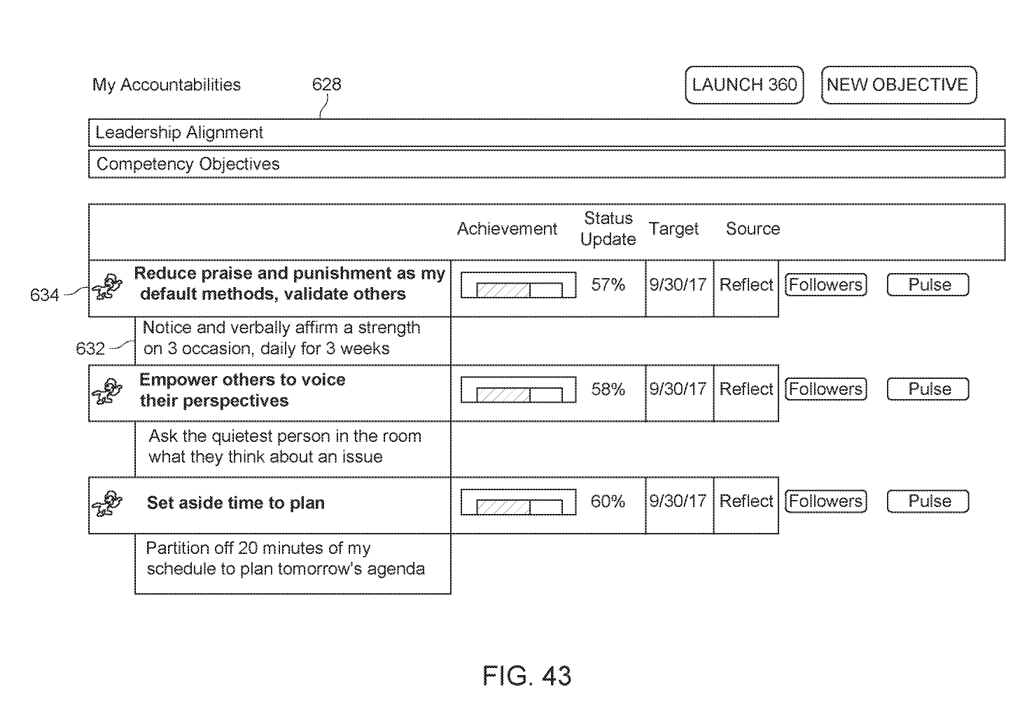

The Objective Selector (702) leverages findings from the. Aspire 360 Feedback tools (636) to facilitate recognition of strengths and precision targeting of excesses or challenges. In one on one meetings with a Direct-report, a Supervisor can use the Objective Selector (702) to review the results and select specific areas to target for development during the designated period. As shown in FIG. 43, when the Supervisor and the Direct-report have identified Leader Development Objectives (634) to target for the quarter, by selecting that target, the Leader Development Objective (634) appears on the Direct-reports My Accountabilities page (628), under the corresponding area. The Direct-report will identify specific Key Results (632), invite others to follow for support, and meet again to finalize their plan.

The Aspire 360 Feedback tools (636) of the system and method (10, 20) may further incorporate My DailyQ's (704) (not shown), which may appear as follows:

| Daily Question: Today I did my best . . . | | | | |
|---|---|---|---|---|
| To Be | After/When I | I will | By Doing This | Aug. 22, 2017 |

| | | | | |
|---|---|---|---|---|
| Character | Present | Meet a colleague | Eradicate the | Choose one |
| | | for lunch | tendency to listen | conversation to |
| | | | to respond | practice “ask don't |
| | | | | tell” throughout the |
| | | | | entire |
| | Modest | start a discussion | Resist showing off | Reducing boasting, |
| | | with my peer, Marv | accomplishments | embellishing or |
| | | | for a week, then | eventually talking |
| | | | notice the changes | about myself |
| | | | in my relationships | |
| Competency | Validating | Took my morning | Reduce praise and | Notice and verbally |
| | | walk-around | punishment as my | affirm a strength on |
| | | | default methods; | occasions |
| | | | validate others | |
| | Empowering | walked into the | Empower others to | Ask the quietest |
| | | work meeting | voice their | person in the room |
| | | | perspectives | what they think |
| | | | | about an Issue |
| | Pre-emptive | During my last hour | Set aside time to | Partition off 20 |
| | | at the office each | plan | minutes of my |
| | | day | | schedule to plan |
| | | | | tomorrow's agenda |
| Workstyle | Empathetic | When listening to a | Be more sensitive | listen for a key |
| | | direct-report's | to the feelings of | emotion or feeling |
| | | complaint | others; consider | behind the next |
| | | | multiple sides of an | complaint I hear |
| | | | argument | |
| | Competitive | In staff meeting; | Let go of the need | Outdo myself In |
| | | take somebody's | to win every battle; | championing |
| | | good idea and find | focus on self- | another's idea; |
| | | ways to support it | improvement and | advocate it with the |
| | | | work on my | group |
| | | | personal best | |
| Confidential | Healthy | Walk into the | Enhance my | Fill a glass of water |
| | | kitchen area | nutrition | |
| | Relational | Begin to eat dinner | Strengthen my | Say at least 1 thing I |
| | | | relationship with | appreciate about |
| | | | my spouse | him/her |

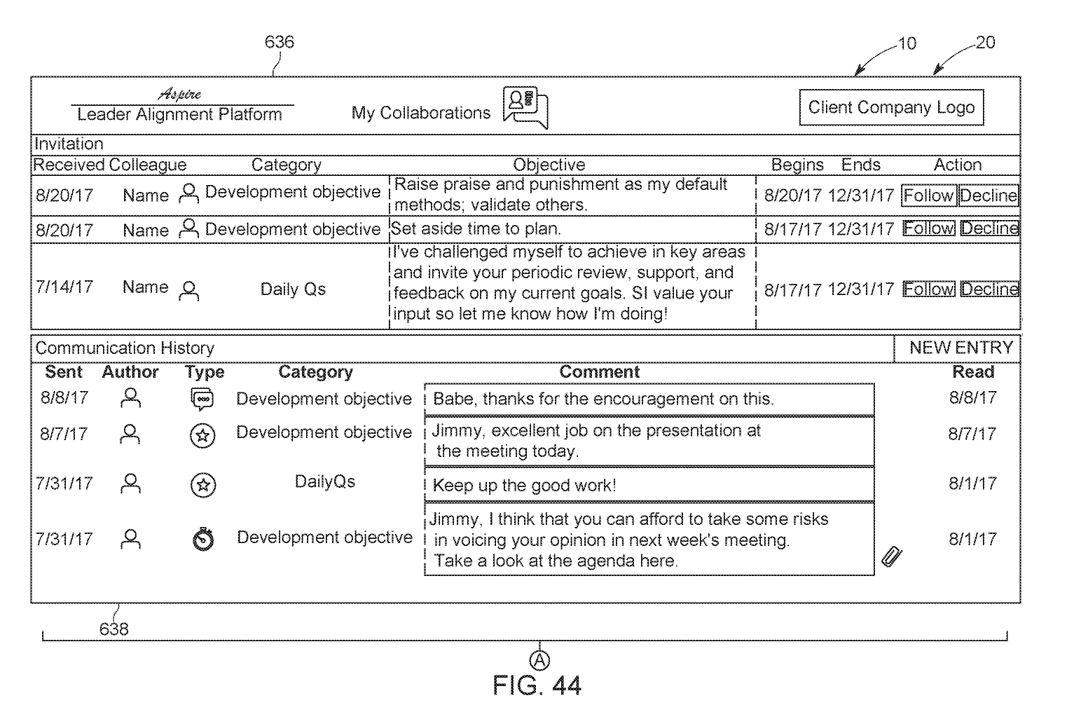

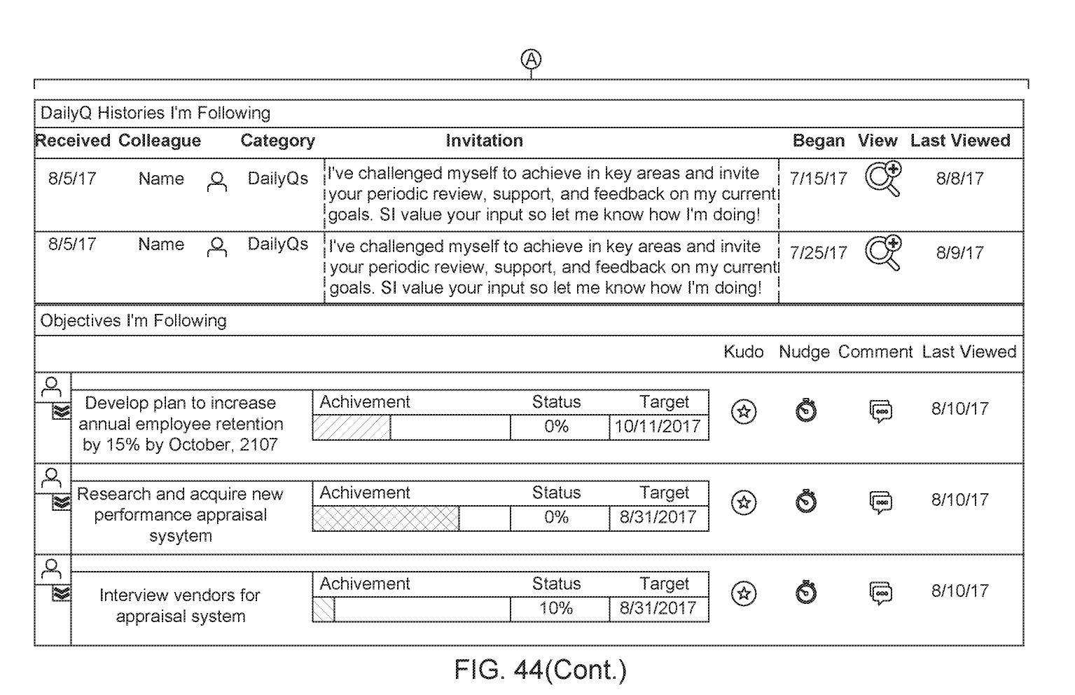

When the Leader Development Objective (634) is created, it will also appear on the Direct-report's Intuitive Dashboard (614), in a widget entitled My DailyQ's. Using the My DailyQ's (704), the employee can interact daily with their goals, rating themselves on the efforts they made that day to move toward the results they desired. When others are invited to provide feedback, they receive electronic invitations that appear on the MyCollaborations widget (706) on their Dashboard. As shown in FIG. 44, the MyCollaborations (706) widget promotes collaboration with others. A record of all collaboration (708) is kept for later viewing. The Aspire 360 Feedback tools (636) of the system and method (10, 20) may further incorporate a Reporting Prism (710) (not shown), which may appear as follows:

| Key | | Leadership Alignment | | Leadership Achievement/Development | | | |
|---|---|---|---|---|---|---|---|
| accountabilities | Wt. | Objectives/Initiatives | 70% | Competency | 25% | Character | 25% |

| | | |
|---|---|---|
| People/Culture | 30% | Guidelines |
| Customer Service | 10% | 1. Organization creates Strategic Initiatives 2020, using all 7 Key Accountabilities |
| Excellence (Quality/ | 20% | 2. Organization creates Current Year Organizational Focus Goals with no more than |
| Safety/Compliance) | | 5 Key Accountabilities |
| Financial Stewardship | 10% | 3. Aspire setup allows for customized Key Accountabilities each year. Individual |
| Growth | 10% | results with weightings and tags are viewed through Aspire Prism |
| Innovation | 10% | 4. When creating new objective, Supervisor introduces goal; employee identifies |
| Organizational | 10% | results, |
| Development | | a. Assigns appropriate metrics (Quality, Quantity, Time) |
| Process Improvement | | b. Assigns inputs (Document Review, Direct Observation, Solicited Feedback, |
| | | Unsolicited Feedback) |
| | | 5. Limit the range of the percentages given to any one accountability on |
| | | Executives between (10%-30%). On line level, can go to a range of (60-70%) |

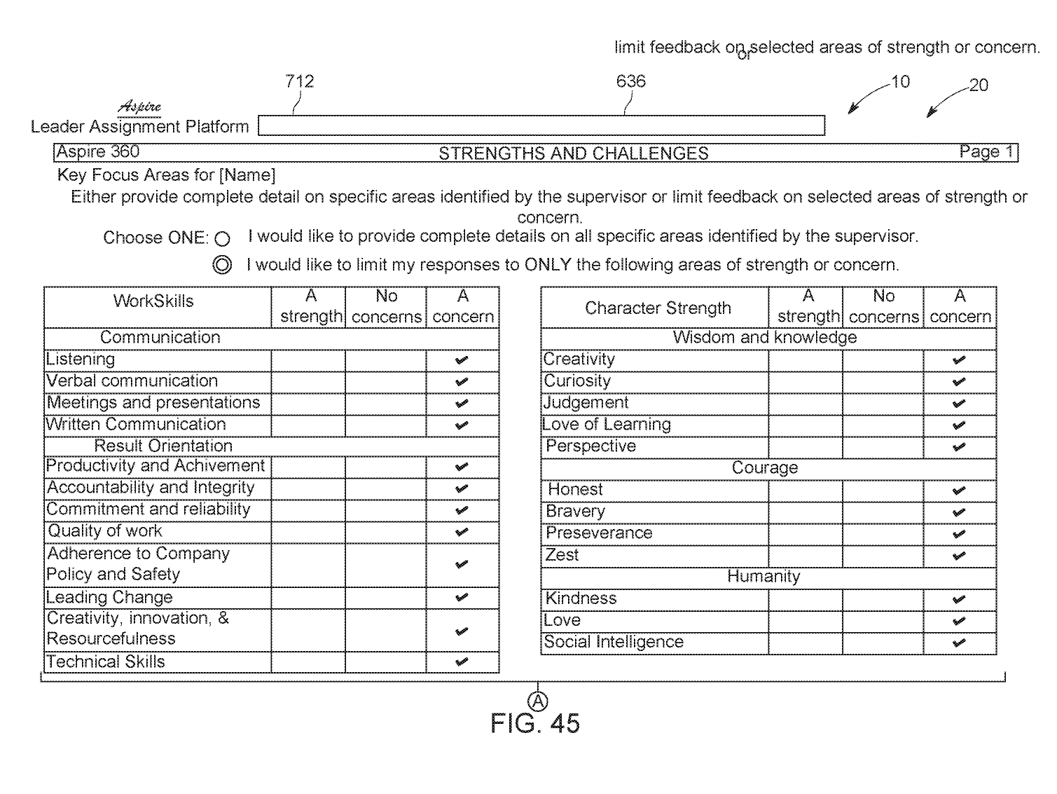

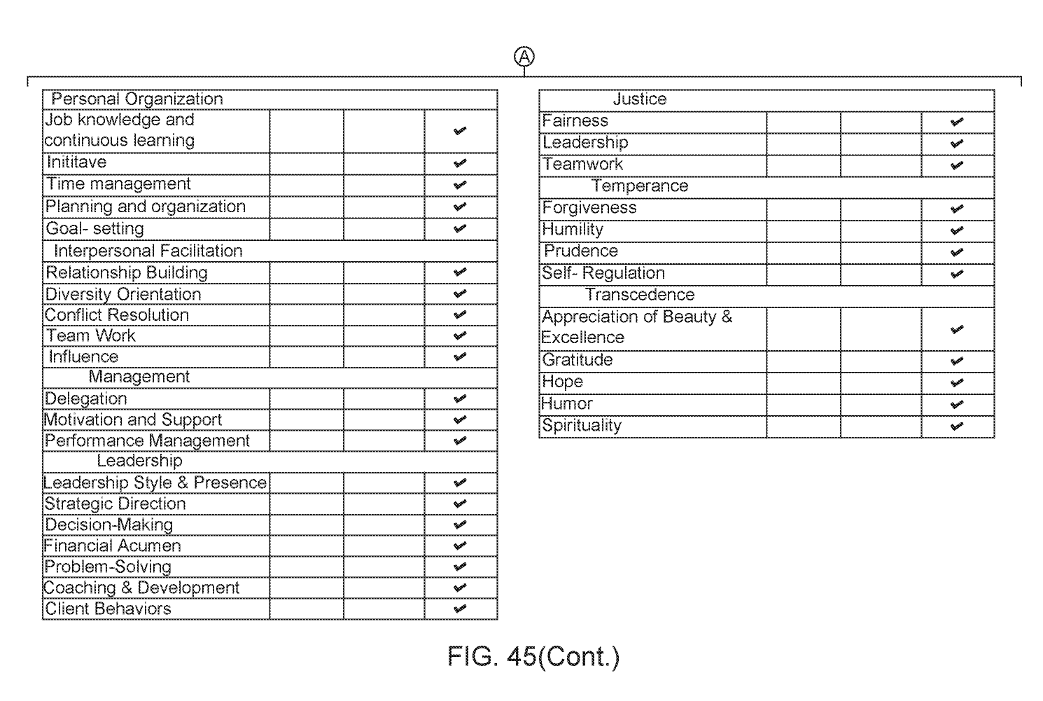

The Reporting Prism (710) provides continuous feedback to upper management using various pre-defined guidelines to track alignment and achievement results over time. Using the Reporting Prism (710), each organization can sort goals and results based on various internal tracking requirements that reflect the strategic and operational goals of an organization. Because a complete Aspire 360 administration may make the user's experience a lengthy process, including gathering strengths and/or identifying challenges, as well as incorporating neutral behavior descriptors, the Aspire 360 Feedback tools (636) may further incorporate an Aspire 360 Item Filter (712), as shown in FIG. 45. The Aspire 360 Item Filter may enable individual raters to target only those areas where he or she has strengths or concerns. This feature may be provided in order to shorten the entire process dramatically.

### J. The Aspire Coaching Activities Panels

The Aspire 360 Feedback tools (636) may further incorporate a Coaching App, which provides employees and supervisors with access to a network of P2C Affiliate coaches who can access the Aspire Leader Alignment Platform (600) and collaborate online using the Aspire Coaching App tool. The Aspire Coaching App tool may incorporate In-the-moment or scheduled meetings, Encrypted web-link or screen sharing, meeting summaries and homework experiments, and/or resourcing for targeted development objectives, and may expand beyond organizational goals to included personal development applications.

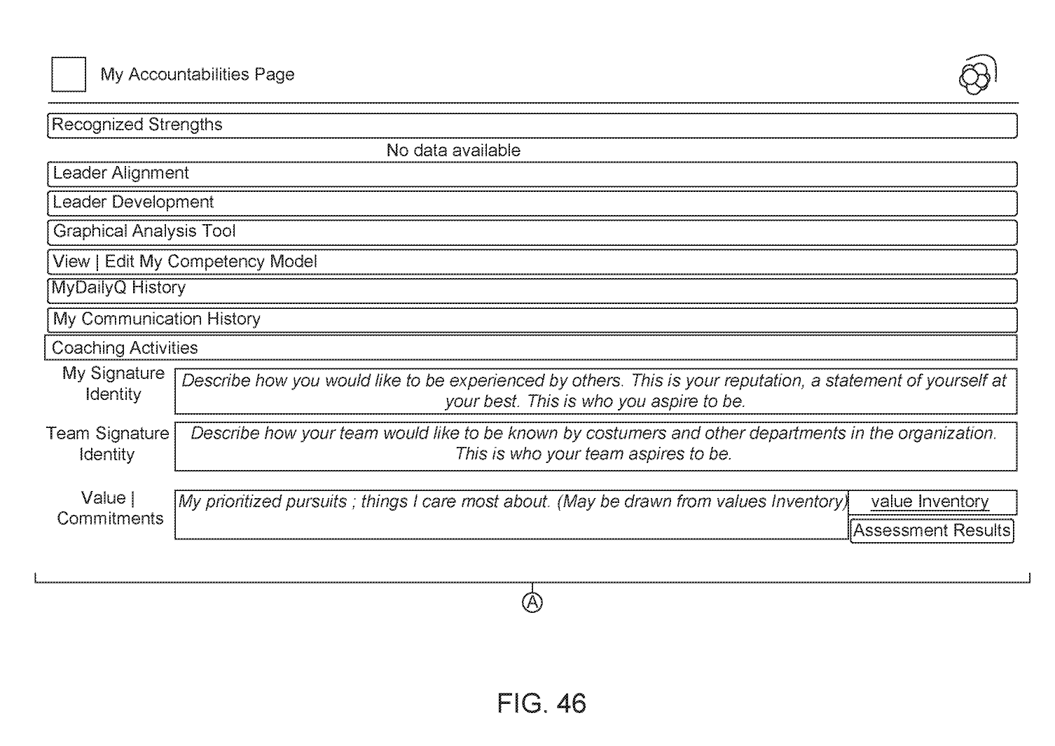

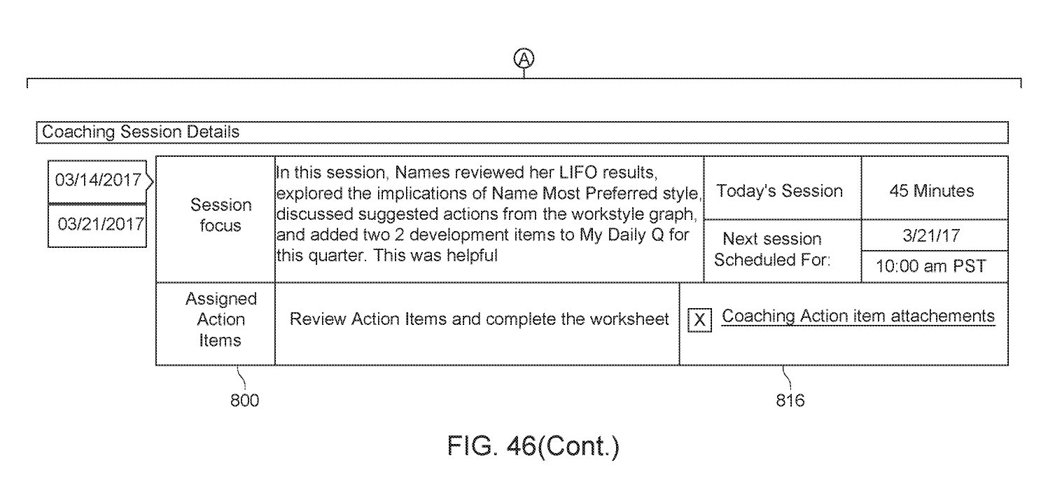

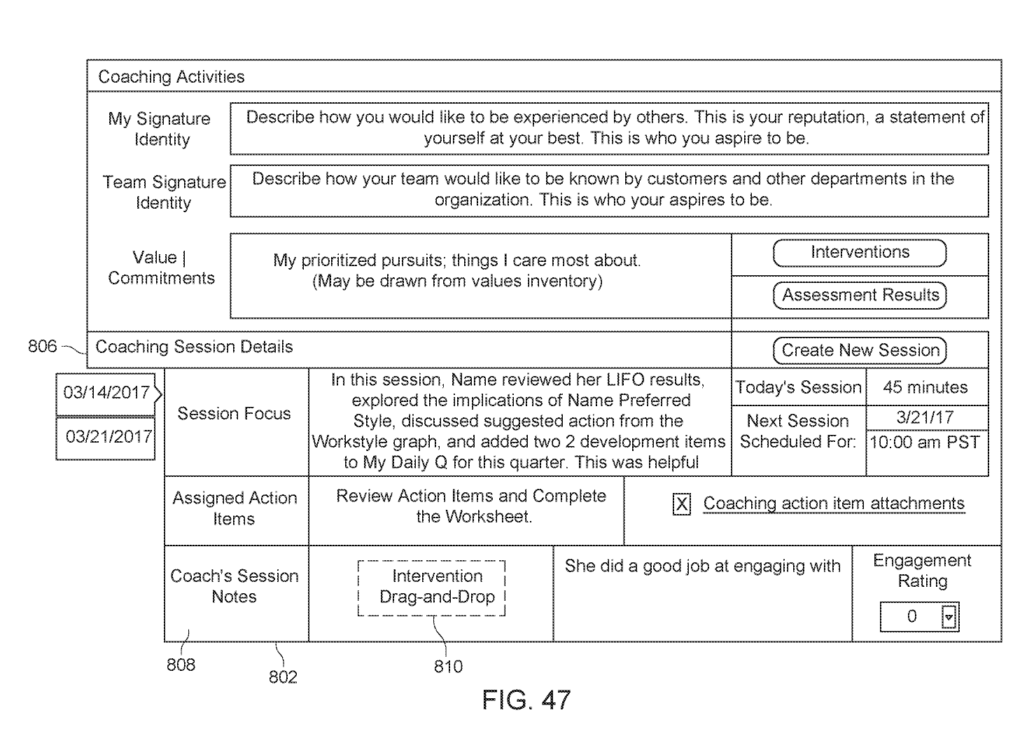

As shown in FIGS. 46 and 47, the My Coaching Panel (800) and Aspire Coaching Activities Panel (802) is a core tool of the Aspire Leader Alignment Platform (600) and is available to P2C Affiliates and Aspire subscribers to facilitate and document coaching activities. Each Aspire subscriber is designated as a ‘Coachee’ and is assigned to a P2C Affiliate, who in turn serves as an accountability/performance management ‘Coach’. Coaching sessions can take place either face-to-face, or by using a secured, HIPAA compliant online meeting tool built into the Aspire platform (600). Secure meeting room links may be provided for pre-arranged use by the Coach and Coachee. If the Aspire User is a P2C Affiliate, he or she may have appropriate permissions to access the Coach's Panel. All other users will see the My Coaching Panel (800).

When Aspire subscribers meet with their coach, both parties have access to relevant data that supports successful coaching outcomes. Coaches create session notes, which can be viewed by both parties retrospectively. The Coach can also assign homework (readings, worksheets, videos to watch, or surveys). The Coaching Action Item Attachments screen (804) (not shown) allows the Coachee to interact with assigned material and prepare for their next meeting. The Coaching Action Item Attachments screen (804) may contain the following information, wherein the Action Items link to a .pdf document, the “Browse” link allows the user to browse for Action Item files, the “Upload” link allows the user to upload Action Item files, and wherein the term “Delete” in the last column is a link that can be clicked to delete that Action Item:

Coaching Action Item Attachments

| Action Item | Category | Uploaded by | Date | Completed | |
|---|---|---|---|---|---|
| UFO Action Items.pdf | Uploaded | Coach's | Mar 14, 2017 | □ | Delete |
| | Document | Name | | | |
| Dealing with Shoulds.pdf | Sharable | Coach's | Mar 14, 2017 | □ | Delete |
| | Worksheet | Name | | | |
| Managers vs. Leaders.pdf | PDF | Coach's | Mar 14, 2017 | □ | Delete |
| | Reading | Name | | | |
| How to Make Stress Your Friend | Watch | Coach's | Mar 22, 2017 | □ | Delete |
| | Video | Name | | | |
| A Leader's Guide for Building | Book | Coach's | Mar 29, 2017 | □ | Delete |
| Inner Excellence | Suggestion | Name | | | |
| Coachee Name's Current | Uploaded | Coach's | Apr 5, 2017 | □ | Delete |
| Project List | Document | Name | | | |
| | | Coachee's | | | |
| Coaching Feedback Survey | Survey | Name | | | |

| | |
|---|---|
| Browse . . . No file selected | Upload |

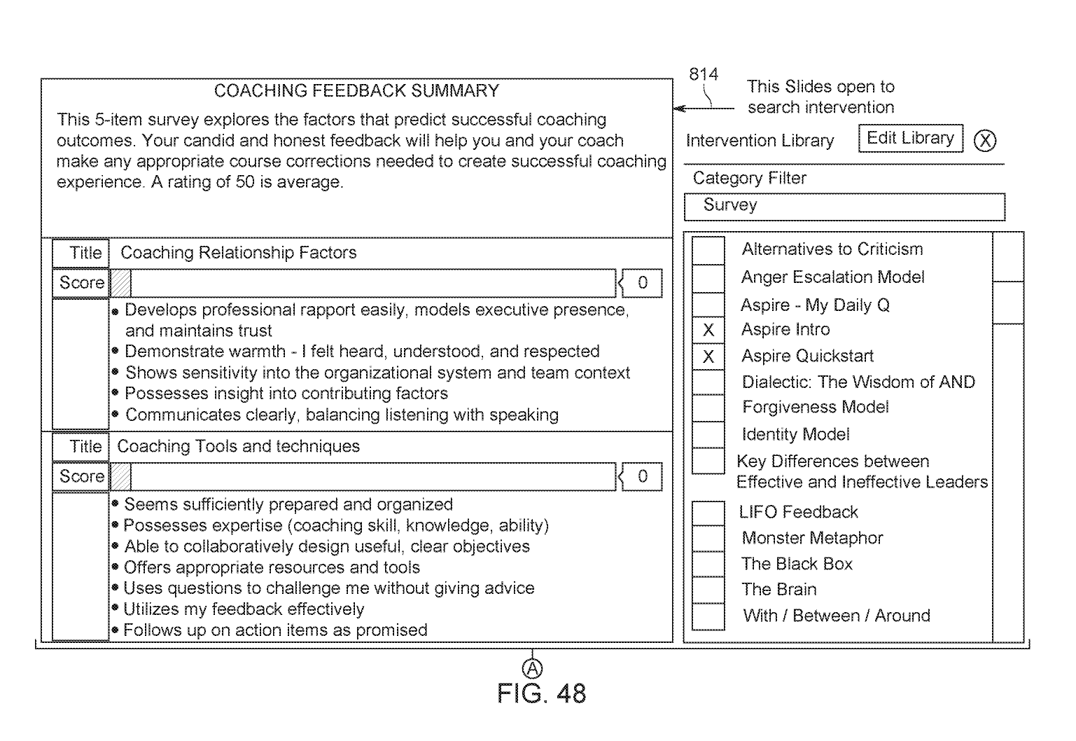

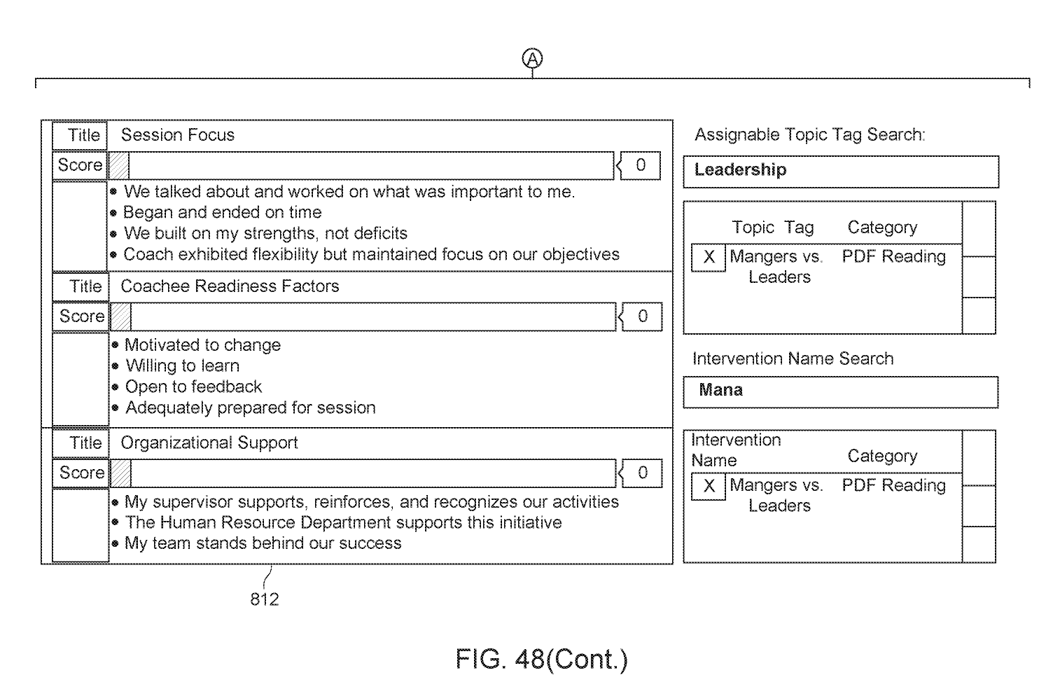

The Coaching Activities Panel (802) appears when the Coach chooses to interact with one of their assigned Coachees. Coaching Session Details (806) will be viewable by the Coachee. However, the Coach's Session Notes (808) remain private and are viewable only by the Coach. The Coach can quickly upload assignments to the Coachee by dragging documents to the Intervention Drag-and-Drop area (810). The Coach can also rate the Coachee's level of engagement for that session. Likewise, the Coachee can periodically provide feedback to the Coach, increasing the likelihood of course-corrections. As shown in FIG. 48, this feedback may be provided for in the form of a Coaching Feedback Summary (812).

When meeting online with the Coachee, the Coach can access the searchable Interventional Library (814) by selecting an Interventions button (not shown). A panel slides in from the right to display available interventions that have been made available to P2C Affiliates. The Coach can also upload his or her own favorite coaching interventions into the library for use with other Coachees. This feature enables the Coach to quickly filter and view interventions by Category, Topic Tag, or Intervention Name. Selecting the intervention will launch the Searchable Interventional Library (814) so that it can be viewed on the screen and shared with the Coachee. Marking the intervention allows the Coach to remember if that intervention has been used. If the Coach wants to enable the Coachee to access that intervention after the session is complete, he or she can drag the intervention to an Intervention Drag-and-Drop area (810), which creates a link in the Coachee's Coaching Action Item Attachments area (816).

### K. Aspire Identity Tool

This tool is a vital part of the Aspire Coaching Platform that facilitates leader identity formation. Drawing on various input sources in Aspire (a leader's selected values, targeted work skills, and character strengths) the Identity Tool's created output is a series of carefully worded, editable, narrative sentences. These sentences paint an aspirational word portrait of integrated self-identity, using nouns and descriptive adjectives to articulate the leader's vision, helping the leader to focus, commit, and align intentions and engage in actions that move him or her closer toward this vision. For example, a leader may have identified:

| | |
|---|---|
| Values: | Curiosity, Affiliation, Recognition, Creativity |
| Skills to Be: | Affirming, Accepting, Planful |
| Character Strengths to Be: | Appreciative, intentional, Self-aware, Relational |

The suggested Signature Identity might be produced by the tool in this way: “I am a self aware affiliator and planner who seeks ways to intentionally accept, recognize, appreciate, and affirm creative potential in others.” The user could ask for different suggestions, prompting the tool to randomly generate different statements using the given syntax inputs.

### L. The Mentoring Activities Panel

The Aspire Leader Alignment Platform (600) may use a similar architecture to facilitate mentoring between Mentors and Mentees, who can connect online in a similar fashion as has been discussed herein. If an intervention has been shared with a Coachee, that individual will have access to use that same intervention with individuals they select to mentor. No interventions may be used with Mentees that have not been introduced to the Coachee by the Coach.

### M. The Aspire Application

The Aspire Leader Alignment Platform (600) may alternately be embodied as an application for mobile devices, and may provide individuals with access to Aspire tools using a mobile device. In this embodiment there may be several types of Aspire Subscribers. Corporate Subscribers may be associated with companies, which may pay for subscriptions on annual or multi-year contracted basis. Such Corporate Subscribers may be secured through contracting with the HR departments within the companies' organizations, with billing taking place through the financial departments of the companies.

Individual Subscribers may be individuals who may not be associated with companies. Such Individual Subscribers may access an embodiment of the Aspire Leader Alignment Platform (600) referred to as an Aspire Leader Lite or Free Version. Thereafter, the Individual Subscribers may make in-app purchases. Aspire Leader Lite users may, for non-limiting example:
find out about the application through commercial applications stores, such as iTunes® or Google® Play Store or social media;
have access to limited features that invite them into make in-app purchases of Assessments, the Aspire 360, and Online Coaching or Mentoring Support, each requiring them to upgrade to the paid version of the Aspire Leader Alignment App; or
immediately become paid subscribers, when directed to download the app by their Coach (P2C Affiliate), Mentor, or Therapist.
   Mentor Subscribers may be individuals that have elected to upgrade in order to use the Aspire Leader Alignment Platform (600) as a tool in their mentoring activities. Coach Subscribers may be individuals that are contracted P2C Affiliates who have been granted access to use the Aspire Leader Alignment Platform (600) as a tool in their executive coaching or therapy activities.

The Aspire Leader Alignment App may include the features and functions such as, for non-limiting example, Coaching Access to in-the-moment or scheduled meetings via an encrypted web-link. This link may, for example, provides two-way video communication and screen sharing between one or multiple participants. Coaching or Mentoring meeting session notes may be viewable by both parties, along with assigned homework experiments and resources for targeted development objectives. The Aspire Leader Alignment App may further expand beyond organizational goals to personal development applications. Paid subscribers to the Aspire Leader Alignment App will have full access to Coaching/Mentoring Functionality, which may include (those items marked with an asterisk being part of the Aspire Lite embodiment):
An Intuitive Dashboard—My Team View
A My Accountabilities Page
   Recognized Strengths
   Leader Alignment
   Leader Development*
   MyDailyQ*
   MyDailyQ History*
   Graphical Analysis Tool
   View Edit My Competency Model
   My Communication History
   Coaching Activities—Interaction
      Coaching Session Details (notes from created sessions)
      Coaching Action Item Attachments—view pdfs, videos, surveys
      View Testing Results
   Mentoring Activities
      Mentoring Session Details
      Mentoring Action Item Attachments
   Zoom Launch to meet with Coach or Mentor
   In-App Purchases—Assessment Store (For Individual Pays)*
      Become Aspire Subscriber to:
      Select my coach from a list of available coaches
      Aspire 360
      Purchase Individual Assessments—16PF, LIFO, HDS, etc.

While the system and method for pre-hiring and post-hiring leadership development that provides human resource professionals, hiring managers, supervisors, and employees access to pre-employment assessment, post-employment assessment, leadership development, and executive coaching products and services has been described with respect to at least one embodiment, the system and method for pre-hiring and post-hiring leadership development can be further modified within the spirit and scope of this disclosure. This application is therefore intended to cover any variations, uses, or adaptations of the system and method for pre-hiring and post-hiring leadership development using its general principles. Further, this application is intended to cover such departures from the present disclosure as come within known or customary practice in the art to which the disclosure pertains and which fall within the limits of the appended claims.

REFERENCE NUMBER LISTING

| | |
|---|---|
| 10 | System |
| 20 | Method |
| 30 | Step-by-step process |
| 100 | Online portal system/Aspire Platform |
| 102 | Pre-employment arena |
| 104 | Post-employment arena |
| 110 | Assessment and leadership development activities |
| 112 | Assessment and coaching deliverables |
| 114 | Permission assignments/levels |
| 116 | Login types |
| 118 | Super-users |
| 120 | Leads |
| 122 | Supervisors |
| 124 | Employees |
| 126 | Affiliates/P2C Affiliates |
| 128 | Candidate and/or Employee profiles |
| 130 | List of positions |
| 132 | Position competency models |
| 132A | Job Essential Functions |
| 132B | Knowledge |
| 132C | Skills |
| 132D | Abilities |
| 132E | Work Activities |
| 134 | Interviews/references |
| 136 | Interview/reference results |
| 138 | Pre-employment/post-employment tests |
| 140 | Testing results |
| 142 | Test reports |
| 144 | Hiring managers/selection committees |
| 146 | Employment statuses |
| 148 | Leadership development system/Aspire |
| 150 | Coaching engagements |
| 152 | Performance management tracking |
| 154 | Reporting to management |
| 200 | Candidate analysis reports |
| 202 | Action Plans |
| 204 | Personal accountabilities |
| 206 | Shared objectives |
| 208 | Alignment/leadership accountabilities |
| 210 | Direct-reports |
| 212 | Alignment/leadership objectives |
| 214 | Aspire App/Aspire Portal |
| 216 | Aspire 360/Aspire Pulse |
| 216A | Free version |
| 216B | Paid version |
| 218 | Continuous performance/observational |
| | feedback/online surveys/responses |
| 220 | Online survey/Aspire 360/Aspire Pulse survey invitations |
| 222 | Coaching support/resources |
| 224 | Performance management activities |
| 226 | One-on-one check-ins |
| 250 | Assessment batteries |
| 252 | Assessment reports |
| 254 | Interactive report feedback |
| 256 | Encrypted tele-meeting technologies |
| 300 | Coaching assessment reports |
| 302 | Coaching requests |
| 304 | Online coaching meetings |
| 306 | Developmental objectives |
| 308 | Coaching interventions |
| 350 | Subject Matter Experts (SMEs) |
| 352 | Therapists/Clinicians/P2C Affiliate Therapists |
| 354 | Individual Users/subscribing individuals |
| 356 | Aspire Free Subscribers |
| 358 | Aspire Paid Subscribers |
| 360 | Clinical account logins |
| 362 | Therapy Clients |
| 364 | Self-development activities |
| 366 | Clinical assessments |
| 368 | Confidential, encrypted tele-therapy connection |
| 370 | Session summaries |
| 372 | Online psycho-educational resources |
| 374 | Homework assignments |
| 376 | Status updates |
| 378 | Personalized self-improvement goals |
| 380 | Followers |
| 400 | algorithm |
| 402 | Position creation window |
| 404 | List of positions |
| 406 | Position profile |
| 408 | Step 1 of creating a position |
| 410 | Step 2 of creating a position |
| 412 | Step 3 of creating a position |
| 414 | Step 4 of creating a position |
| 416 | Step 5 of creating a position |
| 418 | Numerical user preferences |
| 420 | Slider mechanisms |
| 422 | Job specifications |
| 424 | Domain tabs |
| 424A | Task domain tab |
| 424B | Knowledge domain tab |
| 424C | Competency domain tab |
| 424D | Skill domain tab |
| 424E | Ability domain tab |
| 424F | Culture fit domain tab |
| 426 | Task descriptions |
| 428 | Parent task levels |
| 430 | Performance Expectations task levels |
| 432 | Specific personality characteristics |
| 434 | Value drivers |
| 436 | Numerical SME preferences |
| 438 | Competency model |
| 438A | Job Details Competency |
| 438B | Essential Functions Competency |
| 438C | Knowledge Competency |
| 438D | General Competency |
| 438E | Skills Competency |
| 438F | Traits Competency |
| 438G | Values Competency |
| 440 | Individual interview guide |
| 442 | Panel interview guide |
| 444 | Manual interview |
| 446 | Interviewer name |
| 448 | Interviewer email address |
| 450 | Custom Questions |
| 452 | Create Interview |
| 454 | Interview status |
| 456 | Interview Rating Form |
| 458 | Interview Rating Form slider mechanism |
| 460 | Interactive dynamic normal bell-shaped curve |
| 462 | Interview Rating Form narrative |
| 464 | Interview Rating Form note field |
| 466 | Embed field |
| 468 | Candidate |
| 470 | Pre-employment battery builder |
| 472 | Report options |
| 474 | Featured and/or Recommended tests |
| 476 | Anticipated testing date |
| 478 | Desired report date |
| 480 | Price |
| 482 | Informed Consent to Testing |
| 484 | Password protected login |
| 486 | Login menu |
| 488 | Production tab |
| 490 | Report options |
| 492 | Report type |
| 494 | Headings |
| 496 | Comparative Graphs |
| 498 | Drag-and-drop upload field |
| 500 | Report preview |
| 502 | Quick view |
| 504 | Interpretive narrative |
| 506 | Integrated Summary |
| 508 | Integrated Summary slider mechanism |
| 510 | Position Criteria |
| 512 | Culture Criteria |
| 514 | Congruence |
| 516 | Candidate Analysis Report |
| 518 | Alignment Analysis section |
| 520 | Personality scales |
| 522 | Target scores |
| 524 | Actual scores |
| 526 | Value scales |
| 528 | Target scores |
| 530 | Actual scores |
| 532 | Candidate competency scores |
| 534 | Competency weights |
| 536 | Competency |
| 538 | 16PF scores |
| 540 | HDS scores |
| 542 | MVPI scores |
| 544 | PPM-Numerical Reasoning score |
| 546 | Hogan Business Reasoning Index |
| 548 | Watson-Gasser Critical Thinking Appraisal |
| 550 | Overall Leadership Competency score |
| 552 | Overall Culture (Team Organization) alignment score |
| 554 | Overall Job Functions/Essential Functions alignment score |
| 556 | Alignment summary |
| 558 | Assessment Battery Score |
| 560 | Weighted Decision Algorithm |
| 562 | Weight |
| 564 | Sources of data |
| 564A | Assessment results |
| 564B | Individual interview scores |
| 564C | Panel interview scores |
| 564D | Behavioral observations |
| 564E | Reference audit |
| 564F | Subjective culture fit |
| 566 | Scores and Comments |
| 568 | Subjective Estimates |
| 600 | Aspire Leader Alignment Platform |
| 602 | Personal and professional objectives |
| 604 | Company objectives |
| 606 | Team objectives |
| 608 | Login page |
| 610 | Animated logo splash screen |
| 612 | Post-Employment Sitemap |
| 614 | Intuitive Dashboard |
| 616 | Function boxes |
| 618 | My Profile widget |
| 620 | Pre-employment Aspire widgets |
| 622 | MyTeam Chart Widget |
| 624 | Cascading Alignment |
| 626 | Leader Alignment Objectives |
| 628 | My Accountabilities page |
| 630 | Collapsible panels |
| 632 | Key Results |
| 634 | Leader Development Objectives |
| 634A | Competency Objectives |
| 634B | Character Strength Objectives |
| 634C | WorkStyle Objectives |
| 634D | Confidential Objectives |
| 636 | Aspire 360 Feedback tools |
| 638 | Aspire 360 WorkSkill Selector tool |
| 640 | WorkSkills |
| 642 | Aspire 360 Character Strength Selector tool |
| 644 | Virtues and value-drivers |
| 646 | Rater categories |
| 648 | invitation |
| 650 | Instructions |
| 652 | Norming slider scoring mechanism |
| 654 | WorkSkill and Character Strength descriptors |
| 656 | Job Competency Skills |
| 658 | Character Strengths |
| 660 | Behavioral WorkStyle |
| 662 | Effectiveness improvement tool |
| 700 | Graphical Analysis tool |
| 700A | Competencies Skills Analysis graph |
| 700B | WorkSkill Analysis graphs |
| 700C | Character Strengths graph |
| 702 | Objective Selector |
| 704 | My DailyQ's widget |
| 706 | MyCollaboration widget |
| 708 | Record of collaboration |
| 710 | Reporting prism |
| 712 | Aspire 360 Item Filter |
| 800 | My Coaching Panel |
| 802 | Aspire Coaching Activities Panel |
| 804 | Coaching Action Item Attachments Screen |
| 806 | Coaching Session Details |
| 808 | Coaching Session Notes |
| 810 | Intervention Drag-and-Drop Area |
| 812 | Coaching Feedback Summary |
| 814 | Searchable Interventional Library |
| 816 | Coachee's Coaching Action Item Attachments Area |

What is claimed is:

1. A method for pre-hiring and post-hiring leadership development performed by one or more computing devices, comprising the steps of:
providing a Software as a Service (SaaS) delivery model in which software is licensed on a subscription basis and is centrally hosted at least one of in the Internet Cloud and on a server;
controlling access to at least one free or fee-based deliverable;
assigning at least one organizational account login type corresponding to function, comprising at least one permission assignment, wherein the at least one organizational account login type comprises Super-users or Leads, Supervisors, Employees, and Affiliates;
the software guiding the at least one organizational account login type, according to function and permission assignment, through a process of pre-hiring and post-hiring leadership development activities, comprising:
creating, maintaining, storing, and viewing, in a computer-readable medium, data that comprises positions;
assessing the positions using numerical weighting preferences to create, maintain, store, and view in the computer-readable medium data that comprises corresponding Competency Models and/or Culture Fit Models; and
assessing candidates using evaluative criteria derived from the Competency Models and/or Culture Fit Models.

2. The method of claim 1, wherein:
the Competency Model comprises at least one of Job Details Competency, Essential Functions Competency, Knowledge Competency, General Competency, Skills Competency, Traits Competency, and Values Competency.

3. The method of claim 1, wherein:
the numerical weighting preferences being entered using at least one slider mechanism.

4. The method of claim 1, wherein:
the permission assignment providing the Super-users or Leads the ability, guided by the software and using the one or more computing devices, to:
create, maintain, store, and view, in the computer-readable medium, data that comprises candidate and/or Employee profiles, job positions, and/or position competency models;
administer interviews and/or references, and create, maintain, store, and view, in the computer-readable medium, data that comprises interview and/or reference results;
order pre-employment and/or post-employment tests, create, maintain, store, and view, in the computer-readable medium, data that comprises testing results, and forward test reports;
participate with hiring managers and/or selection committees in making hiring decisions, and then create, maintain, store, and view, in the computer-readable medium, data that comprises updated employment statuses and assignment of employees to supervisors and teams;
create and maintain supervisor and/or employee access to the software and to the data; and
assign coaching engagements, and oversee performance management tracking and/or reporting to management.

5. The method of claim 4, wherein:
the permission assignment providing the Supervisors the ability, guided by the software and using the one or more computing devices, to:
collaborate to create, maintain, store, and view, in the computer-readable medium, data that comprises a competency model;
view data stored in the computer-readable medium that comprises Candidate analysis reports;
collaborate with their Supervisors to create, maintain, store, and view, in the computer-readable medium, data that comprises Action Plans with alignment and/or leadership accountabilities;
provide status updates on personal accountabilities;
collaborate with team members to create, maintain, store, and view, in the computer-readable medium, data that comprises shared objectives;
delegate alignment and/or leadership accountabilities with direct-reports;
administer performance management of direct-reports;
request surveys to gather continuous performance feedback;
schedule and/or facilitate periodic one-on-one check-ins with direct-reports;
collaborate with direct-reports to create, maintain, store, and view, in the computer-readable medium, data that comprises alignment and/or leadership objectives; and
provide observational feedback to direct-reports via online surveys and/or responses, request coaching support, and/or document performance management activities.

6. The method of claim 5, wherein:
the permission assignment providing the Employees the ability, guided by the software and using the one or more computing devices, to:
collaborate with their Supervisor or Supervisors to create, maintain, store, and view, in the computer-readable medium, data that comprises Action Plans with alignment and/or leadership accountabilities;
provide status updates on personal accountabilities;
collaborate with team members to create, maintain, store, and view, in the computer-readable medium, data that comprises shared objectives;
respond to survey invitations;
participate in periodic one-on-one check-ins with their supervisor or supervisors; and
utilize coaching resources through an application or through a portal.

7. The method of claim 6, wherein:
the permission assignment providing the Affiliates the ability, guided by the software and using the one or more computing devices, to:
collaborate with Super-users, Leads, and/or Supervisors to create, maintain, store, and view, in the computer-readable medium, data that comprises Employee and/or Candidate profiles and position competency models;
create, maintain, store, and view, in the computer-readable medium, data that comprises build assessment batteries;
set pricing, administer testing, integrate test results, and/or analyze and write assessment reports;
provide interactive report feedback to Super-users, Supervisors, and/or selection committees using encrypted tele-meeting technologies embedded in the software;
create, maintain, store, and view, in a computer-readable medium, data that comprises Coaching assessment reports;
schedule and/or host online coaching meetings with Employees in response to requests for leadership coaching using the encrypted tele-meeting technologies embedded in the software;
interact with Supervisors and Employees to review feedback, set developmental objectives, deliver coaching interventions via remote connection or the application; and
provide feedback to Super-users and/or Supervisors about Employee performance.

8. The method of claim 7, wherein:
the permission assignment providing Affiliates who are also Therapists the ability, guided by the software and using the one or more computing devices, to:
remotely administer clinical assessments;
interact with Clients during sessions via an encrypted tele-therapy connection embedded in the software;
create, maintain, store, and view, in a computer-readable medium, data that comprises session summaries, collaboratively created treatment goals, and Action Plans; and
provide psycho-educational resources, monitor symptom improvement, and/or track progress of Clients who elect to use the application.

9. The method of claim 8, wherein:
the permission assignment providing Therapy Clients the ability, guided by the software and using the one or more computing devices, to:
use online psycho-educational resources;
remotely connect with a Therapist by way of the encrypted tele-therapy connection embedded in the software or in the application; and
view session summaries, complete homework assignments, track symptom improvement, and/or provide status updates.

10. The method of claim 9, wherein:
the permission assignment providing individual free subscribers the ability, guided by the software and using the one or more computing devices, to:
create, maintain, store, and view, in the computer-readable medium, data that comprises candidate and/or employee profiles;
set basic self-improvement goals; and
invite others to provide support and feedback regarding their efforts; and
the permission assignment providing individual paid subscribers the ability, guided by the software and using the one or more computing devices, to:
create, maintain, store, and view, in the computer-readable medium, data that comprises candidate and/or employee profiles;
invite others to provide perceptions regarding their efforts;
create, maintain, store, and view, in the computer-readable medium, data that comprises Action Plans with personalized self-improvement goals;
to invite Followers to provide real-time accountability and/or support feedback; and
engage with Affiliates to receive online coaching around their selected developmental objectives.

11. One or more non-transitory computer-readable media storing instructions which, when executed on one or more computing devices, cause the one or more computing devices to perform:
access control to at least one free or fee-based deliverable;
assignment of at least one organizational account login type corresponding to function, comprising at least one permission assignment, wherein the at least one organizational account login type comprises Super-users or Leads, Supervisors, Employees, and Affiliates;
guidance of the at least one organizational account login type, according to function and permission assignment, through a process of pre-hiring and post-hiring leadership development activities, comprising:
creating, maintaining, storing, and viewing, in a computer-readable medium, data that comprises positions;
assessing the positions using numerical weighting preferences to create, maintain, store, and view in the computer-readable medium data that comprises corresponding Competency Models and/or Culture Fit Models; and
assessing candidates using evaluative criteria derived from the Competency Models and/or Culture Fit Models.

12. The one or more non-transitory computer-readable media storing instructions of claim 11, wherein:
the Competency Model comprises at least one of Job Details Competency, Essential Functions Competency, Knowledge Competency, General Competency, Skills Competency, Traits Competency, and Values Competency.

13. The one or more non-transitory computer-readable media storing instructions of claim 11, wherein:
the numerical weighting preferences being entered using at least one slider mechanism.

14. The one or more non-transitory computer-readable media storing instructions of claim 11, wherein:
the permission assignment providing the Super-users or Leads the ability, as guided by the software and using the one or more computing devices, to:
create, maintain, store, and view, in the computer-readable medium, data that comprises candidate and/or Employee profiles, job positions, and/or position competency models;
administer interviews and/or references, and create, maintain, store, and view, in the computer-readable medium, data that comprises interview and/or reference results;
order pre-employment and/or post-employment tests, create, maintain, store, and view, in the computer-readable medium, data that comprises testing results, and forward test reports;
participate with hiring managers and/or selection committees in making hiring decisions, and then create, maintain, store, and view, in the computer-readable medium, data that comprises updated employment statuses and assignment of employees to supervisors and teams;
create and maintain supervisor and/or employee access to the software and to the data; and
assign coaching engagements, and oversee performance management tracking and/or reporting to management.

15. The one or more non-transitory computer-readable media storing instructions of claim 14, wherein:
the permission assignment providing the Supervisors the ability, as guided by the software and using the one or more computing devices, to:
collaborate to create, maintain, store, and view, in the computer-readable medium, data that comprises a competency model;
view data stored in the computer-readable medium that comprises Candidate analysis reports;
collaborate with their Supervisors to create, maintain, store, and view, in the computer-readable medium, data that comprises Action Plans with alignment and/or leadership accountabilities;
provide status updates on personal accountabilities;
collaborate with team members o create, maintain, store, and view, in the computer-readable medium, data that comprises shared objectives;
delegate alignment and/or leadership accountabilities with direct-reports;
administer performance management of direct-reports;
request surveys to gather continuous performance feedback;
schedule and/or facilitate periodic one-on-one check-ins with direct-reports;
collaborate with direct-reports to create, maintain, store, and view, in the computer-readable medium, data that comprises alignment and/or leadership objectives; and
provide observational feedback to direct-reports via online surveys and/or responses, request coaching support, and/or document performance management activities.

16. The one or more non-transitory computer-readable media storing instructions of claim 15, wherein:
the permission assignment providing the Employees the ability, as guided by the software and using the one or more computing devices, to:
collaborate with their Supervisor or Supervisors to create, maintain, store, and view, in the computer-readable medium, data that comprises Action Plans with alignment and/or leadership accountabilities;
provide status updates on personal accountabilities;
collaborate with team members to create, maintain, store, and view, in the computer-readable medium, data that comprises shared objectives;
respond to survey invitations;
participate in periodic one-on-one check-ins with their supervisor or supervisors; and
utilize coaching resources through an application or through a portal.

17. The one or more non-transitory computer-readable media storing instructions of claim 16, wherein:
the permission assignment providing the Affiliates the ability, as guided by the software and using the one or more computing devices, to:
collaborate with Super-users, Leads, and/or Supervisors to create, maintain, store, and view, in the computer-readable medium, data that comprises Employee and/or Candidate profiles and position competency models;
create, maintain, store, and view, in the computer-readable medium, data that comprises build assessment batteries;
set pricing, administer testing, integrate test results, and/or analyze and write assessment reports;
provide interactive report feedback to Super-users, Supervisors, and/or selection committees using encrypted tele-meeting technologies embedded in the software;
create, maintain, store, and view, in a computer-readable medium, data that comprises Coaching assessment reports;
schedule and/or host online coaching meetings with Employees in response to requests for leadership coaching using the encrypted tele-meeting technologies embedded in the software;
interact with Supervisors and Employees to review feedback, set developmental objectives, deliver coaching interventions via remote connection or the application; and
provide feedback to Super-users and/or Supervisors about Employee performance.

18. The one or more non-transitory computer-readable media storing instructions of claim 17, wherein:
the permission assignment providing Affiliates who are also Therapists the ability, as guided by the software and using the one or more computing devices, to:
remotely administer clinical assessments;
interact with Clients during sessions via an encrypted tele-therapy connection embedded in the software;
create, maintain, store, and view, in a computer-readable medium, data that comprises session summaries, collaboratively created treatment goals, and Action Plans; and
provide psycho-educational resources, monitor symptom improvement, and/or track progress of Clients who elect to use the application.

19. The one or more non-transitory computer-readable media storing instructions of claim 18, wherein:
the permission assignment providing Therapy Clients the ability, as guided by the software and using the one or more computing devices, to:
use online psycho-educational resources;
remotely connect with a Therapist by way of the encrypted tele-therapy connection embedded in the software or in the application; and
view session summaries, complete homework assignments, track symptom improvement, and/or provide status updates.

20. The one or more non-transitory computer-readable media storing instructions of claim 19, wherein:
the permission assignment providing individual free subscribers the ability, as guided by the software and using the one or more computing devices, to:
create, maintain, store, and view, in the computer-readable medium, data that comprises candidate and/or employee profiles;
set basic self-improvement goals; and
invite others to provide support and feedback regarding their efforts; and
the permission assignment providing individual paid subscribers the ability, as guided by the software and using the one or more computing devices, to:
create, maintain, store, and view, in the computer-readable medium, data that comprises candidate and/or employee profiles;
invite others to provide perceptions regarding their efforts;
create, maintain, store, and view, in the computer-readable medium, data that comprises Action Plans with personalized self-improvement goals;
to invite Followers to provide real-time accountability and/or support feedback; and
engage with Affiliates to receive online coaching around their selected developmental objectives.
